(19) United States
(12) Patent Application Publication
(10) Pub. No.: US 2012/0215574 A1
(43) Pub. Date: Aug. 23, 2012

(54) SYSTEM, METHOD AND COMPUTER PROGRAM PRODUCT FOR ENHANCED PERFORMANCE MANAGEMENT

(75) Inventors: John D. Driessnack, Lovettsville, VA (US); Wendy L. Juchnevics-Freeman, New Ipswich, NH (US); Patrick Barker, Reston, VA (US); Raymond Covert, McLean, VA (US)

(73) Assignee: Management Consulting & Research, LLC, McLean, VA (US)

(21) Appl. No.: 13/008,617

(22) Filed: Jan. 18, 2011

Related U.S. Application Data
(60) Provisional application No. 61/295,691, filed on Jan. 16, 2010.

(51) Int. Cl. G06Q 10/06

(52) U.S. Cl. 705/7.12

(57) ABSTRACT

A method for performance management including receiving performance data for a project, receiving risk data for the project, developing an estimate to complete (ETC) based on the performance data, adjusting the ETC based on the risk data, and developing an estimate at completion (EAC) based on the adjusted ETC.

### CROSS-REFERENCE TO RELATED APPLICATIONS

This application claims priority to U.S. Provisional Application No. 61,295,691 filed Jan. 16, 2010, the entire contents of which are hereby incorporated by reference.

### BACKGROUND OF THE INVENTION

1. Field of the Invention

The present invention relates generally to software and business methods and more particularly to systems and methods of providing enhanced performance management.

2. Related Art

Various Program Management techniques have been known for some time. Earned value management (EVM) is a project management technique for measuring project progress in an objective manner. EVM has the ability to combine measurements of scope, schedule, and cost in a single integrated system. When properly applied, EVM provides an early warning of performance problems. Additionally, EVM promises to improve the definition of project scope, prevent scope creep, communicate objective progress to stakeholders, and keep the project team focused on achieving progress.

Example features of any EVM implementation include, 1) a project plan that identifies work to be accomplished, 2) a valuation of planned work, called Planned Value (PV) or Budgeted Cost of Work Scheduled (BCWS), and 3) pre-defined “earning rules” (also called metrics) to quantify the accomplishment of work, called Earned Value (EV) or Budgeted Cost of Work Performed (BCWP).

EVM implementations for large or complex projects include many more features, such as indicators and forecasts of cost performance (over budget or under budget) and schedule performance (behind schedule or ahead of schedule). However, the most basic requirement of an EVM system is that it quantifies progress using PV and EV.

EVM emerged as a financial analysis specialty in United States Government programs in the 1960s, but it has since become a significant branch of project management and cost engineering. Project management research investigating the contribution of EVM to project success suggests a moderately strong positive relationship. Implementations of EVM can be scaled to fit projects of all sizes and complexity.

The genesis of EVM was in industrial manufacturing at the turn of the 20th century, based largely on the principle of “earned time” popularized by Frank and Lillian Gilbreth but the concept took root in the United States Department of Defense in the 1960s. The original concept was called PERT/COST, but it was considered overly burdensome (not very adaptable) by contractors who were mandated to use it, and many variations of it began to proliferate among various procurement programs. In 1967, the DoD established a criterion-based approach, using a set of 35 criteria, called the Cost/Schedule Control Systems Criteria (C/SCSC). In 1970s and early 1980s, a subculture of C/SCSC analysis grew, but the technique was often ignored or even actively resisted by project managers in both government and industry. C/SCSC was often considered a financial control tool that could be delegated to analytical specialists.

In the late 1980s and early 1990s, EVM emerged as a project management methodology to be understood and used by managers and executives, not just EVM specialists. In 1989, EVM leadership was elevated to the Undersecretary of Defense for Acquisition, thus making EVM an essential element of program management and procurement. In 1991, Secretary of Defense Dick Cheney canceled the Navy A-12 Avenger II Program due to performance problems detected by EVM. This demonstrated conclusively that EVM mattered to secretary-level leadership. In the 1990s, many U.S. Government regulations were eliminated or streamlined. However, EVM not only survived the acquisition reform movement, but became strongly associated with the acquisition reform movement itself. Most notably, from 1995 to 1998, ownership of EVM criteria (reduced to 32) were transferred to industry by adoption of ANSI EIA 748-A standard.

The use of EVM quickly expanded beyond the U.S. Department of Defense. It was quickly adopted by the National Aeronautics and Space Administration, United States Department of Energy and other technology-related agencies. Many industrialized nations also began to utilize EVM in their own procurement programs. An overview of EVM was included in first PMBOK Guide First Edition in 1987 and expanded in subsequent editions. The construction industry was an early commercial adopter of EVM. Closer integration of EVM with the practice of project management accelerated in the 1990s. In 1999, the Performance Management Association merged with the Project Management Institute (PMI) in 1999 to become PMI's first college, the College of Performance Management. The United States Office of Management and Budget began to mandate the use of EVM across all government agencies, and for the first time, for certain internally-managed projects (not just for contractors). EVM also received greater attention by publicly traded companies in response to the Sarbanes-Oxley Act of 2002.

Conventional performance management has various shortcomings. For example, EVM has no provision to measure project quality, so it is possible for EVM to indicate a project is under budget, ahead of schedule and scope fully executed, but still have unhappy clients and ultimately unsuccessful results. What is needed is an enhanced method of performance management that overcomes shortcomings of conventional solutions.

### SUMMARY OF THE INVENTION

An exemplary embodiment of the present invention is directed to a performance management system, method and computer program product.

The method may include receiving performance data for a project, receiving risk data for the project, developing an estimate to complete (ETC) based on the performance data, adjusting the ETC based on the risk data, and developing an estimate at completion (EAC) based on the adjusted ETC.

According to another embodiment, a computer program product embodied on a computer accessible storage medium, which when executed on a computer processor performs a method for enhanced performance management may be provided. The method may include receiving risk data for the project, developing an estimate to complete (ETC) based on the performance data, adjusting the ETC based on the risk data, and developing an estimate at completion (EAC) based on the adjusted ETC.

According to another embodiment, a system for performance management may be provided. The system may include at least one device including at least one computer processor adapted to receive performance data and risk data for a project. The processor may be adapted to develop an estimate to complete (ETC) based on the performance data, adjust the ETC based on the risk data, and develop an estimate at completion (EAC) based on the adjusted ETC.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment illustrating an exemplary linked cost, risk, earned value, schedule and technical (CREST) analysis and assessment (LCAA) process according to exemplary embodiment of the present invention;

FIG. 2 depicts an exemplary embodiment of exemplary additions and/or modifications to the criteria/guidelines to add a linking notion to control account (CA) analysis in a manner in which the estimate of completion (EAC) is more robust than conventionally available;

FIG. 3A depicts an exemplary embodiment of an exemplary LCAA quantitative data process relationships flow diagram, according to an exemplary embodiment of the present invention;

FIG. 3B depicts an exemplary embodiment of an exemplary observe, orient, decide and act loop, according to an exemplary embodiment of the present invention;

FIG. 4 depicts an exemplary embodiment of a computer system which may be a component, or an exemplary but non-limiting computing platform for executing a system, method and computer program product for providing enhanced performance management according to the exemplary embodiment of the present invention;

FIG. 5 depicts an exemplary system of exemplary user devices including, a project manager device, program manager device, project lead(s) device, integrated product team (IPT) lead(s) devices, quality assurance engineer(s) (QAEs) devices, subject matter expert (SMEs) devices, and program analyst devices coupled to one another via one or more networks;

FIG. 6 depicts an exemplary embodiment of an example comparative tool according one exemplary embodiment;

FIG. 7 illustrates an example embodiment of flow diagram of an example process cycle for performance management (PM) analysis according to one exemplary embodiment;

FIG. 8 illustrates an example embodiment of flow diagram of an example trigger threshold flow diagram of an exemplary LENS notebook application according to an exemplary embodiment;

FIG. 9 illustrates an example embodiment of flow diagram of an example issue resolution management and escalation flow diagram of an exemplary application according to an exemplary embodiment;

FIG. 10 illustrates an example embodiment of exemplary EVM system description according to an exemplary embodiment;

FIG. 11 illustrates an example embodiment of exemplary system including a reporting system, dashboard, scheduling system, earned value engine, and accounting system and exemplary data flow description according to an exemplary embodiment;

FIG. 12 illustrates an example embodiment of an exemplary overall baseline management process flow diagram according to an exemplary embodiment;

FIG. 13 illustrates an example embodiment of an exemplary re-baseline decision process flow diagram according to an exemplary embodiment;

FIG. 14 illustrates an example embodiment of an exemplary baseline project re-program process flow diagram according to an exemplary embodiment;

FIG. 15 illustrates an example embodiment of an exemplary composite data transparency trend analysis 1500 according to an exemplary embodiment.

FIG. 16 illustrates an example embodiment of an exemplary three dimensional graph of an exemplary joint probability density function according to an exemplary embodiment;

FIG. 17A illustrates an example embodiment of an exemplary two dimensional graph of an exemplary system program estimate to complete (ETC) according to an exemplary embodiment;

FIG. 17B illustrates an example embodiment of an exemplary two dimensional graph of an exemplary system program estimate at complete (EAC) according to an exemplary embodiment;

FIG. 18 illustrates an example embodiment of an exemplary two dimensional graph of an exemplary LCAA Trend Analysis according to an exemplary embodiment;

FIG. 19 illustrates an example embodiment of an exemplary two dimensional graph of an exemplary cost exposure index over time according to an exemplary embodiment;

FIG. 20 illustrates an exemplary flowchart of the LCAA process according to an exemplary embodiment;

FIG. 21 illustrates an exemplary flowchart for linking risk data with performance data according to an exemplary embodiment;

FIG. 22 illustrates an exemplary diagram of generating a radar a signal according to an exemplary embodiment;

FIG. 23 illustrates an exemplary diagram of the reflection of a radar signal according to an exemplary embodiment;

FIG. 24 illustrates an exemplary diagram of the capture of a reflection of a radar signal according to an exemplary embodiment;

FIG. 25 illustrates an exemplary representation of a program architecture according to an exemplary embodiment;

FIG. 26 illustrates an exemplary Recognition-Primed Decision Model according to an exemplary embodiment;

FIG. 27 illustrates an exemplary flowchart for resolving issues according to an exemplary embodiment; and

FIG. 28 illustrates a chart of speed vs. openness according to an exemplary embodiment.

### DETAILED DESCRIPTION OF VARIOUS EXEMPLARY EMBODIMENTS OF THE PRESENT INVENTION

A preferred embodiment of the invention is discussed in detail below. While specific exemplary embodiments are discussed, it should be understood that this is done for illustration purposes only. A person skilled in the relevant art will recognize that other components and/or configurations can be used without parting from the spirit and scope of the invention.

An exemplary embodiment of the present invention is generally directed to an enhanced performance management system.

### ACRONYMS AND SYMBOLS

ACAT ID Acquisition Category 1D
ACE Automated Cost Estimator
ACWP Actual Cost of Work Performed
AFSC Air Force Systems Command
ANSI American National Standards Institute
AR&A Acquisition Resources and Analysis
AT&L Acquisition, Technology and Logistics
BAC Budget at Competition
BCWP Budgeted Cost for Work Performed
BCWR Budgeted Cost for Work Remaining
BCWS Budgeted Cost for Work Scheduled
CA Control Account
CAIG Cost Analysis Improvement Group
CAM Control Account Manager
CARD Cost Analysis Requirements Description
CCDR Contractor Cost Data Report
CEI Cost Exposure Index
CFSR Contract Funds Status Report
CJR Cobra Judy Replacement
CPD Cumulative Probability Distribution
CPI Cost Performance Index
CPR Contract Performance Report
CREST Cost, Risk, Earned Value, Schedule and Technical
C/SCSC Cost/Schedule and Control System Criteria
CSDR Cost and Software Data Report
CV Cost Variance
CWBS Contract Work Breakdown Structure
DAU Defense Acquisition University
DAWIA Defense Acquisition Workforce Improvement Act
DID Data Item Description
DoD Department of Defense
EAC Estimate at Completion
EI Exposure Index
EIA Electronic Industries Alliance
ETC Estimate to Complete
EV Earned Value
EVM Earned Value Management
EVMS Earned Value Management System
FRISK Formal Risk Assessment of System Cost Estimates
GAO Government Accountability Office
IBR Integrated Baseline Review
IC Intelligence Community
IEACl Independent Estimate at Completion
IMP Integrated Master Plan
IMS Integrated Master Schedule
IPM Integrated Program Management
IPT Integrated Product Team
IRAD Internal Research and Development
JCL Joint Confidence Level
KPP Key Performance Parameter
LCAA Linked CREST Analysis and Assessment
LCCE Life-Cycle Cost Estimate
LENS Linked Enhanced Notebook System
LOE Level of Effort
LRE Latest Revised Estimate
MOE Measures of Effectiveness
MOP Measures of Performance
MR Management Reserve
MS Microsoft
MTBF Mean Time Between Failures
NDIA National Defense Industrial Association
OBS Organizational Breakdown Structure
OMB Office of Management and Budget
OODA Observe-Orient-Decide-Act
OSD Office of the Secretary of Defense
PDR Preliminary Design Review
PE Point Estimate
PLCCE Program Life-Cycle Cost Estimate
PM Program or Project Manager
PMB Performance Measurement Baseline
PMBoK® Project Management Body of Knowledge
PMI Program Management Institute
PMO Program Management Office
PMR Program Management Review
PMSC Program Management Systems Committee
POC Point of Contact
PSMC Parts Standardization and Management Committee
PWBS Program Work Breakdown Structure
RAM Responsibility Assignment Matrix
RL Risk Liability
RMP Risk Management Plan
ROAR Risk, Opportunity and Issues Assessment Register
SE Systems Engineering
SEMP Systems Engineering Management Plan
SEP Systems Engineering Plan
SI Susceptibility Index
SLOC Source Line(s) of Code
SME Subject Matter Expert
SPA Single Point Adjustment
SPI Schedule Performance Index
SPO System Program Office
SRA Schedule Risk Assessment or Schedule Risk Analysis
SRDR Software Resources Data Report
SV Schedule Variance
TCPI To Complete Performance Index
TDP Technology Development Plan
TPM Technical Performance Measures
TRA Technology Readiness Assessment
T-Score Transparency Score™
TRL Technology Readiness Level
USD Under Secretary of Defense
VAR Variance Analysis Report
WBS Work Breakdown Structure
XML Extensible Markup Language

### Symbols

a Dollar value of a risk
b Dollar value of an opportunity
H High triangular distribution parameter
L Low triangular distribution parameter
M Most likely triangular distribution parameter
μ Mean of probability distribution
Weight of the Earned value-based probability distribution
P_{ADJ} Weight of the risk-adjusted probability distribution
P_{CPR} Weight of the probability distribution developed from the cost performance report
P_{ETC} Weight of the probability distribution developed from the estimate to complete
P_{SRA} Weight of the probability distribution developed from an independent schedule
P_{Tech} Weight of the probability distribution developed from an independent technical risk assessment
P_{PLCCE} Weight of the probability distribution developed from an independent program life cycle cost estimate risk assessment
PEₖ Point Estimate of WBS Element k
\dot{q} Weight of the risk distribution
r Weight of the opportunity distribution
ρᵢⱼ Pearson correlation coefficient between WBS elements i and j
σ Standard deviation
Tp Dollar value of a WBS element at the pth percentile

### Introduction

Linked Cost, Risk, Earned Value, Schedule and Technical (CREST) Analysis and Assessment™ (LCAA), according to an exemplary embodiment, improves Integrated Program Management (IPM) using quantitative analysis. Linking quantitative program management and analysis techniques and data was a concept initiated by John Driessnack while at Defense Acquisition University (DAU) and evolved through his work on the National Defense Industrial Association (NDIA) Risk and Earned Value (EV) Integration working group. The linked process flow that has become known as the LCAA process flow and its instantiation in the linked notebook were developed by several members of the MCR staff on several projects, including MCR's internal research and development (IRAD) project.

A Linked Enhanced Notebook System (LENS), according to an exemplary embodiment, is provided. Following the overall philosophy that the LCAA process should keep evolving with the evolution of the various CREST disciplines, LENS provides a more sophisticated, inclusive, and automated interface compared with typical business practices of using exemplary, but non-limiting Excel spreadsheets, and the like, analysis tools.

Various exemplary differences and improvements of the LCAA method, according to an exemplary embodiment, over traditional EV and IPM techniques may include and be demonstrated by the following:

1. Data Validity Check—data or information from each discipline may be reviewed and their reliability evaluated, according to an exemplary embodiment. For example, if the contractor's Latest Revised Estimate (LRE) for a WBS element is less than the costs already incurred, the validity of the contractor's LRE, according to an exemplary embodiment, may be discounted as a data point for that WBS element.
2. Management System Check—the T-Scorer™, according to an exemplary embodiment, may consider the maturity of program management disciplines (cost, risk, EV, scheduling, system engineering). T-Scores may directly relate to a program's ability to identify and handle risks. For example, does the contract WBS map to the program WBS, and is the same WBS used by the cost estimators and system engineers? Do Control Account Managers (CAMs) consider the schedule when they write a VAR? Is performance, Budgeted Cost of Work Performed (BCWP), really done when the cost and schedule data indicates, or when the engineers say so?

3. Statistical Summation—method of moments approach, triangular probability distributions for the lowest level WBS or OBS elements may be statistically summed to the next highest level. Correlation coefficients may be developed based on the relationship of one element to another, according to an exemplary embodiment; additionally, a lognormal probability distribution may be created for each level of WBS summation.
4. Risk Metrics—Exposure and Susceptibility Indices, according to an exemplary embodiment, for schedule and cost that incorporate potential risks or opportunities to indicate for the PM his exposure and susceptibility to uncertainty in the future may be calculated. The indices, according to an exemplary embodiment, may come from the results of LCAA and may be tracked and plotted over time to give the PM prediction on whether the program management teams' actions are improving the program's chances of achieving cost and schedule.

LCAA, according to an exemplary embodiment, is a sophisticated process. LCAA does not replace IPM processes, nor does it contradict conventional EV or risk analyses. LCAA enhances and expands the linkage of related disciplines and their qualitative and quantitative products with statistical methods to create a probability distribution around the program's ETC, which provides actionable information to the PM and their team at each level of the WBS. An exemplary difference of LCAA, according to an exemplary embodiment, is the incorporation of statistical methods to enhance the integration part of IPM.

There is also an inherent flexibility built into in the methodology, according to an exemplary embodiment. For example, LCAA may assume lognormal distributions for summed WBS elements. However, this assumption may or could be replaced by normal or fat-tailed distributions if the analyst can justify the change.

While various exemplary embodiments may include all aspects in an integrated system, in other alternative embodiments, aspects may be outsourced to other entities that may receive particular input from the process, may perform exemplary processing and may then provide as output back the intermediate processed data, that may be further processed and used as described in the various illustrative exemplary embodiments.

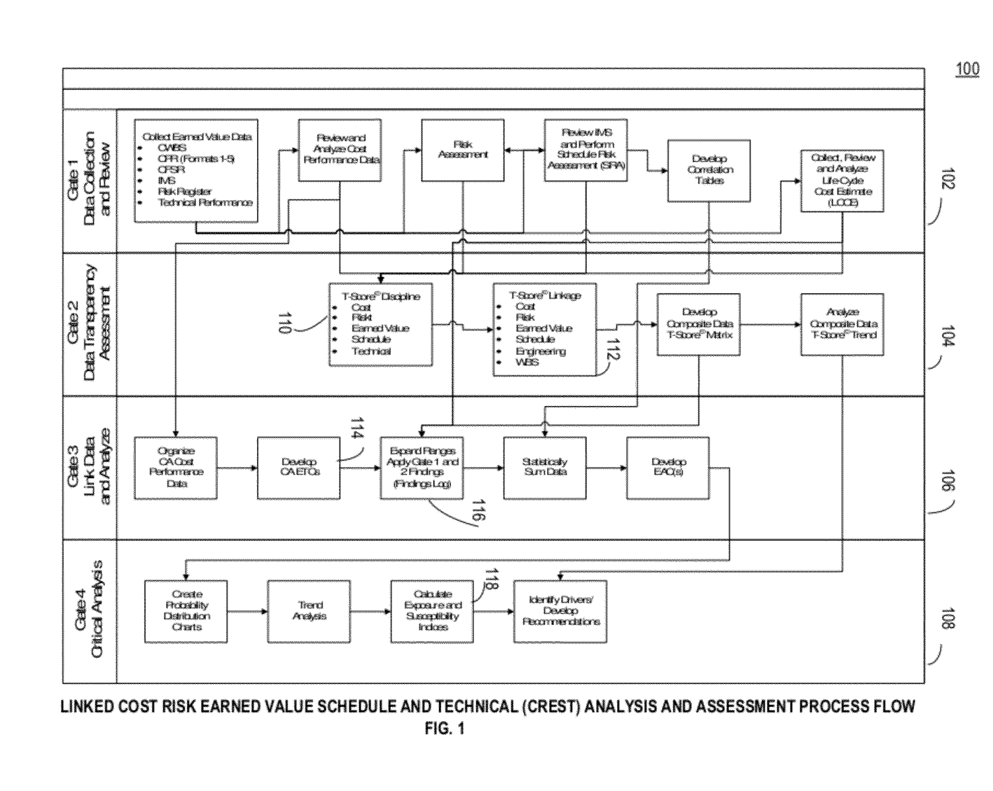

FIG. 1 depicts an exemplary embodiment illustrating an exemplary linked cost, risk, earned value, schedule and technical (CREST) analysis and assessment (LCAA) process 100 according to exemplary embodiment of the present invention.

The exemplary process 100 may include in an exemplary embodiment, four exemplary, but non-limiting sub processes and/or systems, methods and computer program product modules, which may include, data collection and review 102, data transparency assessments 104, link data and analyze 106, and Critical Analysis 108.

The need to accurately account for risk in program cost and schedule estimates has been a basic issue for both commercial industry and the federal government. The growing size and complexity of Federal, Civil and Department of Defense (DoD) acquisition programs, combined with a higher level of awareness for the impact of uncertainty in estimates, has led to an increased demand to provide the program management team with more relevant and reliable information to make the critical decisions that influence the final results on their program.

Multiple studies have concluded that DoD (and by extension all federal) PMs lack the key skills associated with interpreting quantitative performance information and in utilizing disciplines, such as Earned Value Management (EVM). Given this deficit of skills, it is unreasonable to assume that program management teams can derive risk-adjusted budgets or calculate risk-based estimated costs at completion (EAC). An alarming number of Contract Performance Reports (CPRs)—a crucial artifact in performance reporting and forecasting—routinely predict “best case” and “worst case” EACs that are close, if not identical to, the “most likely” EAC (i.e., little or no uncertainty is associated with these estimates). At a minimum, it is clear that there is much room for improvement in how risk-based estimates are executed and in how the results are communicated and used for decision-making. The GAO echoes this in the March 2009 GAO Guide to Estimating and Managing Costs. “The bottom line is that management needs a risk-adjusted point estimate based on an estimate of the level of confidence to make informed decisions. Using information from an S curve based on a realistic probability distribution, management can quantify the level of confidence in achieving a program within a certain funding level.”[GAO 158]

Exemplary Assumptions
An actionable risk-based EAC is an assessment of future program conditions that a PM comprehends and can immediately utilize to address the root causes of the risks directly threatening the cost, schedule and technical objectives of the program.
An actionable risk-based EAC can be derived only from an integrated, quantitative assessment of cost, schedule and technical risk to a program stemming from the lowest levels of management control, by definition the CA. Deriving such an EAC is considered best practice.
EACs that do not reflect integrated, quantitative assessment of cost, schedule and technical risk at the lowest levels of management control (i.e., the CA) are less actionable and thus inhibit the PM team from taking action to influence the final results on their program.

Because it is derived from an integrated, quantitative assessment of Cost, Risk, Earned value (EV), Schedule, and Technical measures or CREST and is derived from the lowest levels of management control (i.e., the CA), the Linked CREST Assessment and Analysis™ (LCAA™) process, according to an exemplary embodiment, is an example of best practice.

LCAA Execution Summary

LCAA reflects an ever-increasing emphasis on the linkage among quantitative disciplines. While government agencies and industry have consistently described what a risk-based EAC is and why it is important, there has been considerable inconsistency in the description of how to develop a coherent meaningful, actionable, risk-based EAC. LCAA, according to an exemplary embodiment, may address this shortfall and is the first known comprehensive analysis process description of its kind. LCAA 100, according to an exemplary embodiment, is a disciplined, gated process that produces the robust, quantifiable cost and schedule analyses that will maintain MCR as a thought leader in developing and enhancing IPM processes. One crucial element, according to an exemplary embodiment, is the incorporation of the separate CREST discipline best practices into the linked approach.

Linked Cost, Risk, Earned Value, Schedule and Technical (CREST) Analysis and Assessment™ (LCAA) improves Integrated Program Management (IPM) decision making using both qualitative assessment and quantitative analysis. The LCAA process and methodology integrates or links quantitative program management disciplines (Cost, Risk, Earned Value, Schedule and Technical) at the lowest management control points (e.g., CAs) to produce quantifiable risk-based forecasts of cost and schedule. The associated workflow, given standard observations with criteria, enables managers and analysts alike to quickly sift through the relevant planning information and performance data to produce tangible results in a relatively short time period.

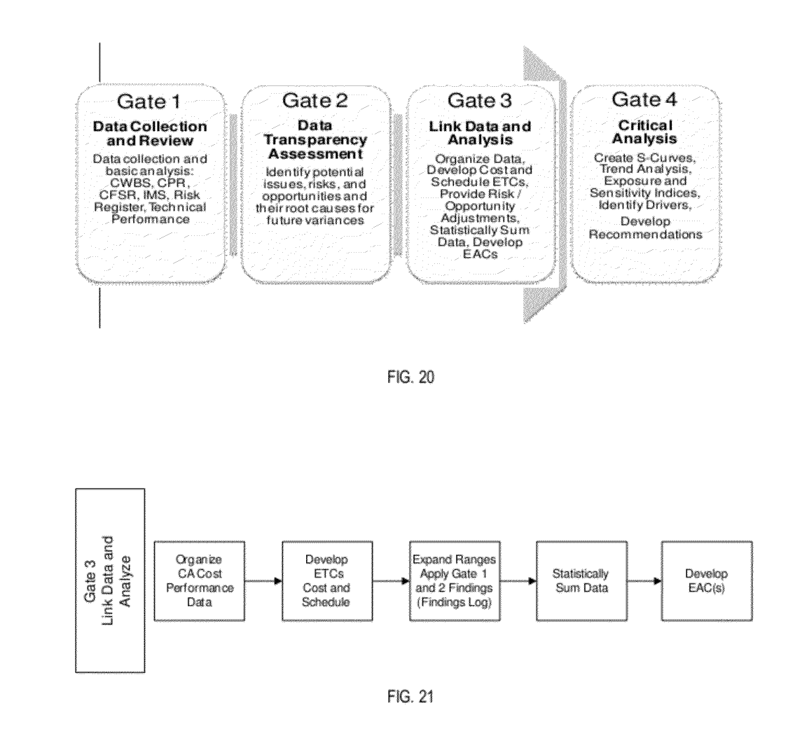

The LCAA process is a progressive system employing four gates as depicted in FIG. 20. In Gate 1, data is collected and perform a preliminary review of program artifacts is performed. Gate 2 is an assessment of the transparency of the data collected in Gate 1. This assessment identifies potential issues, risks, and opportunities and their root causes for future variances. Gate 3 organizes and links the data and generates an estimate to complete (ETC) and an estimate at completion (EAC) of the program. Gate 4 is a critical analysis process that presents the statistical results regarding the ETC and EAC, prepares a trend analysis of historical data, and provides a high-level assessment and recommendations to the program manager.

The LCAA process 100 may include, in an exemplary embodiment, an illustrative, but non-limiting four (4) gates 102, 104, 106, and 108, or exemplary key process steps/decision points (or processes, methods, systems, computer program product modules), as illustrated in FIG. 1. Gate 1 102 assesses the quality of key artifacts in a holistic fashion in terms of compliance, content and level of detail. Gate 2 104 assesses the linkage among risk, EV, scheduling, cost and system engineering, using the same artifacts from Gate 1 102. These first two gates establish the analytical framework used for risk-based ETC generation, and form the basis for generating a unique risk assessment called Transparency scoring (T-scoring™). The T-score™ may serve dual purposes. In addition to providing a tailored analytical framework for quantitative cost and schedule risk analysis, T-scores™ may also help PMs understand the responsiveness of their management systems and their ability to anticipate and mitigate risks.

While Gates 1 102 and 2 104, according to an exemplary embodiment, may assess the quality of the data and the program transparency environment, Gates 3 106 and 4 108, according to an exemplary embodiment, may produce quantitative analyses of cost and schedule risk. A key tenet of LCAA is that every analytical result is developed and viewed within the context of management action; thus actionable is a critical consideration and shaper of the LCAA methodology. Therefore, these gates derive what are called actionable, risk-based estimates of total program cost and duration, because the estimates are mated with root causes for the key program risks at the CA level. In other words, the PM can see how critical elements of the program and the managers responsible for those elements are influencing the current evolutionary path of the program. When such data are not available, the PM is informed of the lack of insight via the transparency assessment process. Finally, the method, according to an exemplary embodiment, may allow for creating Exposure and Susceptibility Indices. These indices, according to an exemplary embodiment, can be tracked over time to provide forward looking indicators of cost or schedule.

This approach provides more in-depth information and analysis to allow the decision-makers expanded vision and the ability to make timely and accurate decisions to keep the program on track by identifying the risks at their earliest stages. Currently, MCR, LLC of McLean, Va., USA, is drafting an appendix to the GAO Guide to Estimating and Managing Costs, on this approach to incorporate into their best practices.

At its core, LCAA 100, according to an exemplary embodiment, is the integration of multiple, long-standing program management disciplines. The power of the LCAA process lies in its ability to exploit the synergy generated from the integration of risk, EV, scheduling, cost estimating and system engineering and provide useful decision-making information to the PM.

LCAA is an extension of the EV performance measurement management methodology that includes unique specific processes (i.e., steps) and techniques (e.g., utilization of Subject Matter Expert [SME] knowledge) that result in an evolution of the EVM concept. LCAA evolves the unique nature of EV as a management system, which is its criteria—based approach, by adding the specific linking criteria among the existing EV criteria. This linking evolves the methodology in a way that expands the key management process, the CAMs, the technical analysts, and the resulting key output, (i.e., the ETC), by the use of statistical summation.

Ideally, LCAA starts with the fundamental building block in EV, which is the control account (CA), and the emphasis on periodic analysis by the control account manager (CAM) to “develop reliable Estimate Costs at Completion” [AFSC October 1976, page 101]. The NDIA Intent Guide (latest version) states in Guideline 27 that “ . . . on a monthly basis, the CAM should review the status of the expended effort and the achievability of the forecast and significant changes briefed to the PM.” The guide further states that “EACs should consider all emerging risks and opportunities within the project's risk register.” The NDIA EVMS Application Guide (latest version) also discusses the use of risks in the EAC process. The application guide states that “quantified risks and opportunities are to be taken into account in the ETC for each CA and the overall baseline best, worst, and most likely EACs.” The guide further states that “variance analysis provides CAMs the ability to communicate deviations from the plan in terms of schedule, cost and at completion variances. The analysis should summarize significant schedule and cost problems and their causes, actions needed to achieve the projected outcomes, and major challenges to achieving project performance objectives. As CA trends become evident, any risk or opportunities identified should be incorporated into the project risk management process.”

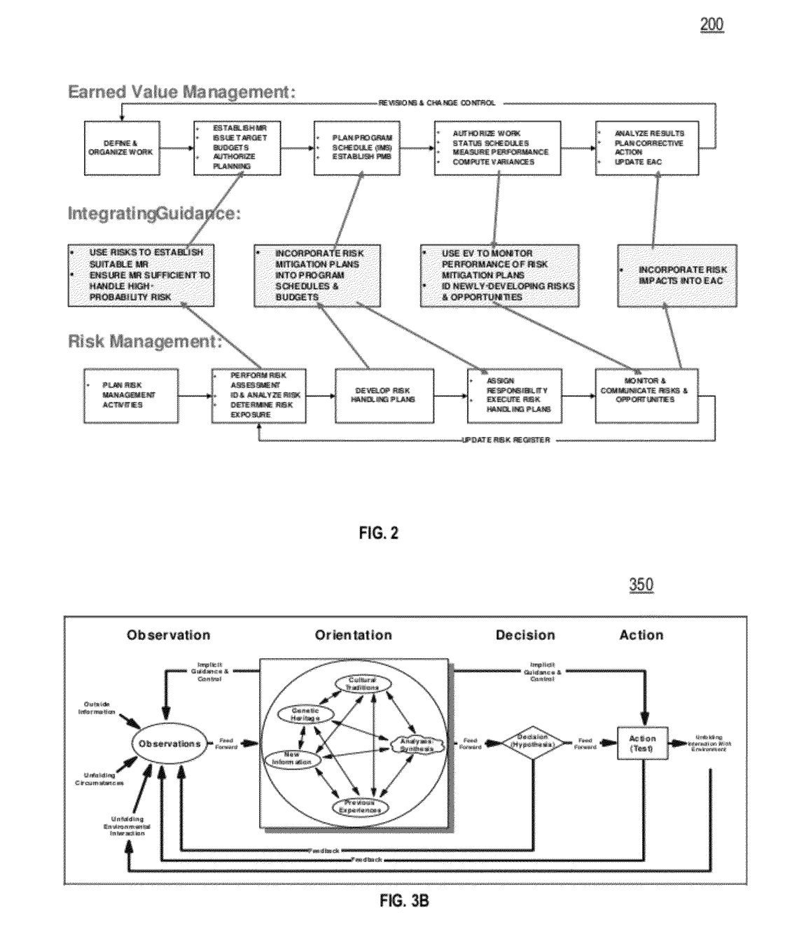

FIG. 2, according to an exemplary embodiment, illustrates an exemplary embodiment of exemplary additions and/or modifications to the criteria/guidelines to add a linking notion to control account (CA) analysis in a manner in which the estimate of completion (EAC) is more robust.

As outlined herein, there are not specific criteria or guidelines for neither how the uncertainties (i.e., potential risks and opportunities) in the baseline will be captured or measured. The LCAA process addresses these shortfalls in the current methodologies and provides for an expanded analysis that results in the ability to link “all available information” and, thus, meet the original intent as outlined in the early discussions on the criteria. The LCAA linking concept takes the “quantified” risks and opportunities, no matter what the cause or how identified, and links them through statistical methods from the CA level up to the program level. As illustrated in FIG. 2, this concept, according to an exemplary embodiment, adds/modifies the criteria/guidelines to add a linking notion to the CA analysis in a manner in which the EAC is more robust and useful to the management team.

Under current EVM guidance, the LCAA methodology, according to an exemplary embodiment, provides enhance capability. Current guidelines state the following:

Guideline 2.5(f) reads today, “Develop revised estimates of cost at completion based on performance to date, commitment values for material, and estimates of future conditions. Compare this information with the performance measurement baseline to identify variances at completion important to company management and any applicable customer reporting requirements, including statements of funding requirements.”

LCAA methodology, according to an exemplary embodiment, allows for expansion of what is accomplished with this guideline so that it can read, “Develop initial and revise monthly estimates of schedule and cost at completion for each CA based on performance to date, commitment values for material, and estimates of future conditions. To the extent it is practicable, identify and link the uncertainties and their potential impacts in the future work relative to the performance measure identified for planned work (ref 2.2(b)) and any undistributed budget in a manner to determine an estimated range of cost and schedule possibilities. Statistically summarize the ranges through the program organization and/or WBS. Compare this information with the performance measurement baseline to identify variances at completion important to management and any applicable customer reporting requirements including statements of funding requirements.”

Guideline 2.5(e) reads today, “Implement managerial actions taken as the result of earned value information.”

LCAA methodology, according to an exemplary embodiment, may allow for an expansion of this guideline so that it can read, “Implement managerial actions that reduce potential future negative variances and capture future positive variances as the result of earned value information.”

In the last few years, other activities in the Federal Acquisition community that identify the advantage and need to integrate management disciplines further justify the need to move toward the LCAA methodology:
NDIA commissioned an EV and risk integration subgroup to investigate those advantages and incorporated the general need in the NDIA Application Guide.
The IC CAIG completed a research project on the utilization of EV data after the-Preliminary Design Review (PDR) and found that the community lacked research below level one of the WBS. Additionally, the research found that current EAC formulas were estimating too low and failed to produce a confidence interval around those estimates. The programs were overrun by more than what the classic EAC formulas were estimating since existing EV formulas produce point estimates.
The OMB Circular A-11, Part 7 Capital Planning Guide outlines the requirement for risk-adjusted budgets and Management Reserve (MR) accounts but stops short of identifying an approach.
A USD AT&L memo, dated 25 Aug. 2006, announced an initiative to improve acquisition execution situation awareness for ACAT 1D program by tying cost, schedule and risk data to EV data for analysis to provide enhanced insight into potential program cost growth.
Finally, the GAO has incorporated the concept of linking in the latest GAO Cost Estimating and Assessment Guide, GAO-09-3SP, as a guide on best practices. MCR, LLC was invited to brief the LCAA methodology to the industry working group (10 Sep. 2009) that supports the GAO in selecting best practices.

Traditional EV analysis looks to the past and is often accomplished at level one or two of the work breakdown structure (WBS). By the time lower WBS level issues or problems surface at the program level, the ability to change a program's outcome will have expired. Reporting at WBS level 1 tends to encourage, through the roll-up process, the canceling out of bad performance by good performance at the lower levels of the WBS. For example, a nearly finished, under-run Level of Effort (LOE) Systems Engineering (SE) CA that provides a Cost Performance Index (CPI) and Schedule Performance Index (SPI) above 1.0 would tend to cancel out the slow, poor start of the follow-on software coding CA.

Referring back to FIG. 1, the LCAA process and methodology 100, according to an exemplary embodiment, integrates or links the quantitative program management disciplines (Cost, Risk, Earned value, Schedule and Technical, or CREST) at the lowest management control points (e.g., CAs) to produce quantifiable forecasts of cost and schedule risk. These results are then translated into actionable intelligence for the program management team to enable root cause analysis and proactive corrective actions to be identified.

Data Collection Summary

The LCAA methodology 100 begins with the normal EVM data submitted monthly on a contract, typically the Contract Performance Report (CPR) and Integrated Master Schedule (IMS). LCAA also incorporates the risk/opportunity data, program and contract cost estimating and BoE data, and the technical performance data. The data are gathered in an electronic format to facilitate analysis in the LENS to include interfaces to EV XML or Deltek wInsight™ databases, schedules in tool formats, (e.g., Microsoft (MS) Project, Open Plan, or Primavera), and cost data in the government Automated Cost Estimator (ACE) program.

The LCAA methodology 100 is now overviewed in greater detail, discussing the Gate 1 102 process of data collection and review; the Gate 2 104 process of data transparency assessment; the Gate 3 106 process of linking and analyzing the data; and the Gate 4 108 process of critical analysis. An exemplary embodiment may also include an exemplary Linked Notebook and an exemplary LENS tool that fully automates the LCAA process 100.

In Gate 1 102, the system receives as input various data, collects the data, may store the data, provide for review and access the data. Earned value data is collected, cost and performance data may be analyzed and provided for review, risk may be assessed, IMS may be provided for review, schedule risk assessment may be performed or interactively managed and facilitated, correlation tables may be created, developed and/or facilitated, life cycle cost estimates (LCCE) may be collected, provided for review, and/or analyzed.

In Gate 2 104, the quality of the CREST process may be assessed by the system, and such assessment may be facilitated, scored and analyzed via exemplary interactive processing. Data transparency may be analyzed or assessed and may be assessed by linkage and discipline to arrive at a transparency score (T-Score™ by Discipline and Linkage. A composite data T-Score Matrix may be developed. Composite data T-Score Trend may be analyzed and provided.

Gates 1 102 and 2 104 provide a data transparency assessment and help identify the potential root causes for future variances. The frame of reference for these gates was built from published guidelines, such as American National Standards Institute (ANSI), and best known practices from sources, such as the GAO, DAU, and PMI. The insight afforded by the results of the processes defined in Gates 1 102 and 2 104 answer the following questions for a program management team:
What is the intensity of linkage across the quantitative program management knowledge areas?
What is the degree of discipline in implementing those knowledge areas?
At what level of detail is the information available?

The results from Gate 1 102 and 2 104 may provide an assessment of the quality of LCAA inputs and, therefore, the confidence level associated with the LCAA outputs. Probability distribution curves that represent a snapshot in time of the program's potential cost are developed from these processes. Actionable intelligence is revealed so the snapshot can be characterized as the cost of the program if no corrective action is taken.

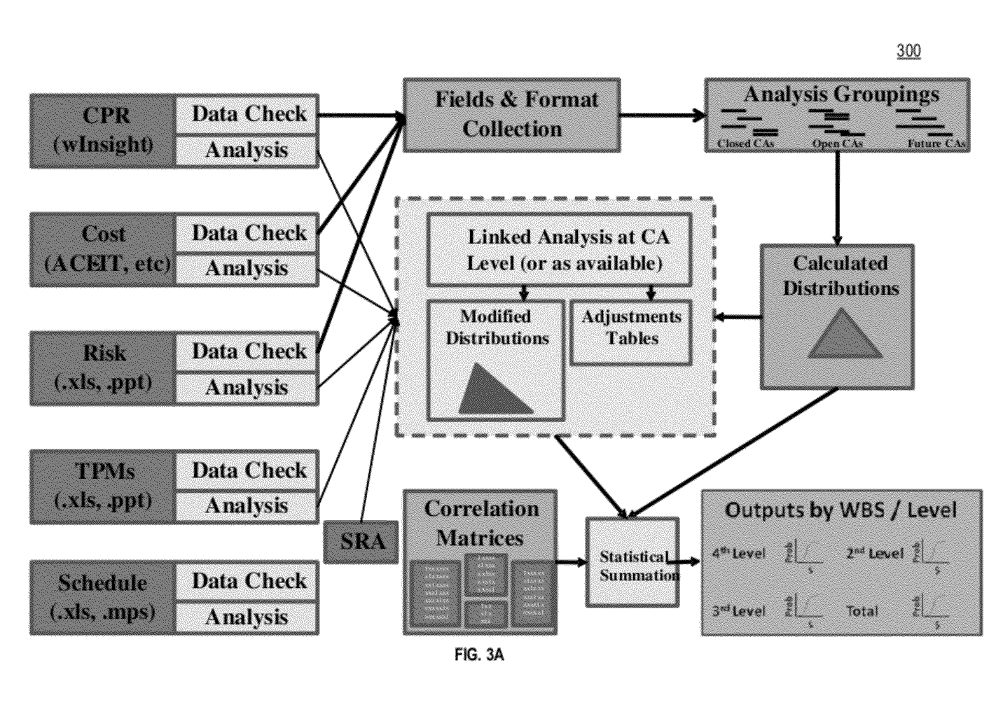

Gates 3 106 and 4 108 may provide the ETC probability distribution with trending analysis and MCR Exposure and Susceptibility Indices. Once the detailed ETC analysis is complete (FIG. 3A), the analysis may be translated into MCR Risk Indexes™ for a high level assessment of program execution. Plotting by the system(s) these indices monthly may generate a trend analysis that indicates the momentum of the program. The capacity to perform multiple analyses at this lower level provides decision-makers the ability to assess many options and select the ones that minimize the risk impact while keeping the program on target.

1.1 Introduction to Data Collection and Review

As illustrated in Gate 1 102 of FIG. 1, according to an exemplary embodiment, the initial step in the LCAA process may include the collection of specific key data and application of consistent reviews, which may result in developing matrices for summation of WBS elements.

1.2 Data Collection—Obtaining the Data to be Linked—CREST

The following is a list of the documentation used to accomplish a complete LCAA:
Overall
   Periodic Program Management Review (PMR) Charts
Cost
   Program Life-Cycle Cost Estimate (PLCCE)
   Contract Fund Status Report (CFSR)
Risk
   Risk Management Plan (RMP)
   Program and Contractor Risk, Opportunity and Issues Assessment

Registers (ROARs)
Earned Value
   Contract Performance Report (CPR)
   CWBS Dictionary
Schedule
   Integrated Master Plan (IMP)
   Integrated Master Schedule (IMS)
Technical
   Technical Performance Measures (TPMs)
   Technology Readiness Assessment (TRA)
   Technology Development Plan (TDP)
   Technology Readiness Levels (TRLs)
   Systems Engineering Management Plan (SEMP)

The implications of the absence of the above documentation are addressed in Gate 2 104 in the Data Transparency Assessment.

1.2.1 Program Life-Cycle Cost Estimate (PLCCE)

The PLCCE is developed using the Program WBS and appropriate cost estimating relationships based on the technical definition available. The PLCCE is an evolving management tool, providing the PM insight into total program costs and risks.

If the PLCCE relies too heavily on contractor proposal(s) rather than taking an independent view of the technical requirements, the PM is missing a significant management tool component.

It is important to understand that the contract costs represent a subset of the total program costs reflected in the PLCCE. Because of this, it is critical that a mapping of the Program WBS and CWBS be maintained. Such a mapping will allow for an integrated program assessment of cost, schedule, technical performance, and associated risks that incorporates the PLCCE findings into the LCAA.

1.2.2 Contract Performance Data

1.2.2.1 Contract Funds Status Report (CFSR)

The CFSR is designed to provide funding data to PMs for:

1. updating and forecasting contract funds requirements,

2. planning and decision making on funding changes to contracts,

3. developing funds requirements and budget estimates in support of approved programs,

4. determining funds in excess of contract needs and available for de-obligation, and

5. obtaining rough estimates of termination costs.

In LCAA, the CFSR is reviewed in the context of LCAA to compare the contract budget and the program's funding profile.

1.2.2.2 Program/Contractor Risk Register (ROAR)

The objectives of the risk management process are: 1) identify risks and opportunities; 2) develop risk mitigation plans and allocate appropriate program resources; and 3) manage them effectively to minimize cost, schedule, and performance impacts to the program. The integration of risk management with EVM is important to IPM, which is critical to program success.

The identified risks and opportunities are documented in the program and/or contractor risk and opportunity registers by WBS element. Those data should be summarized by CWBS, as shown in Table 1.

TABLE 1
Mapping Risks/Opportunities to CWBS
Risk/Opportunities Summary by Level 3 WBS

| | | | | Risk Register | | | | | | | | | | |
|---|---|---|---|---|---|---|---|---|---|---|---|---|---|---|
| | | | | Risk | | | | | | Opportunities | | | | |
| WBS | Description | Risk | Opportunity | WBS ID | Item ID | Level | Prob | KS Impact | Factored KS Impact | WBS ID | Item ID | KS Impact | Factored KS Impact | Prob |
| 1.1.1 | Requirements | | | 1.3.6.2 | R1 | High | 1 | 1200 | 1200 | 1.4.1 | O1 | 1500 | 375 | 0.25 |
| 1.1.11 | Intra-Payload Interface Requirements | | | 1.3.10 | R2 | Low | 0.35 | 112 | 39.2 | 1.2.2 | O2 | 13 | 3.9 | 0.3 |
| 1.1.12 | XYZ Company UAV #2 Suite | 75.0 | | 1.3.12 | R3 | Low | 0.3 | 74 | 22.2 | 1.2.2 | O3 | 500 | 150 | 0.3 |
| 1.1.2 | Airframe | | | 1.3.6 | R4 | | 0.42 | 631 | 265.02 | 1.2.2 | O4 | 3800 | 1520 | 0.4 |
| 1.1.3 | Propulsion | | | 1.3.2 | R5 | Low | 0.1 | 328 | 32.6 | 1.2.2 | O5 | 2100 | 420 | 0.2 |
| 1.1.4 | On-board Communications/Navigation | 187.1 | | 1.3.2 | R6 | Low | 0.1 | 99.3 | 9.93 | 1.2.3 | O6 | 131.3 | 32.825 | 0.25 |
| 1.1.5 | Auxillary Equipment | | | 1.3.11 | R7 | Low | 0.4 | 317 | 126.6 | 1.2.6 | O7 | 129 | 12.9 | 0.1 |
| 1.1.6 | Survivability Modules | | | 1.3.17 | R8 | Low | 0.4 | 188 | 75.2 | 1.2.6 | O8 | 218 | 43.6 | 0.2 |
| 1.1.7 | Electronic Warfare Module | | | 1.3.7 | R9 | Low | 0.4 | 181 | 72.4 | 1.2.4 | O9 | 40 | 8 | 0.2 |
| 1.1.8 | On Board Application & System SW | | | 1.3.13 | R10 | Low | 0.4 | 3837 | 1534.8 | 1.9 | O10 | 400 | 80 | 0.2 |
| 1.1.9 | Payload Configuration Mgt | | | 1.3.17 | R11 | Low | 0.4 | 565 | 226 | Total | | | 2646.225 | |
| 1.2.1 | Requirements | | | 1.4.1.3 | R12 | Low | 0.09 | 500 | 45 | | | | | |
| 1.2.10 | UAV #1 IPT FE EMC | | | 1.4.1.3 | R13 | Mod | 0.4 | 1000 | 400 | | | | | |
| 1.2.11 | UAV #1 IPT Lead | 12.4 | | 1.7.5.2 | R14 | Low | 0.35 | 200 | 70 | | | | | |
| 1.2.12 | UAV #2 Parts Engineering | | | 1.7.6.7 | R15 | Low | 0.4 | 585 | 234.4 | | | | | |
| 1.2.2 | Airframe | 1548.0 | 2093.9 | 1.7.6.7 | R16 | Low | 0.4 | 388 | 155.2 | | | | | |
| 1.2.3 | Propulsion | 387.6 | 32.8 | 1.7.5 | R17 | Low | 0.4 | 310 | 124 | | | | | |
| 1.2.4 | On-board Communications/Navigation | 625.3 | 8.0 | 1.7.7.2.2 | R18 | Low | 0.3 | 247 | 74.1 | | | | | |
| 1.2.5 | UAV#1 Auxillary Equipment | 302.6 | | 1.8.2.7.1 | R19 | Mod | 0.21 | 1200 | 252 | | | | | |
| 1.2.6 | Survivability Modules | 249.5 | 56.5 | 1.8.2 | R20 | Low | 0.4 | 43 | 17.2 | | | | | |
| 1.2.7 | Electronic Warfare Module | | | 1.8.1.1 | R21 | Low | 0.4 | 600 | 240 | | | | | |
| 1.2.8 | Integrated EW Package | | | 1.1.12 | R22 | Low | 0.2 | 250 | 50 | | | | | |
| 1.2.9 | Onboard Application & System SW | | | 1.1.12 | R23 | Low | 0.1 | 250 | 25 | | | | | |
| 1.3.1 | Control Station Specifications | | | 1.2.2 | R24 | Low | 0.3 | 2990 | 897 | | | | | |
| 1.3.10 | Suite Software Integration | 39.2 | | 1.2.2 | R25 | Low | 0.4 | 450 | 180 | | | | | |
| 1.3.11 | IPT Lead | 126.8 | | 1.2.2.7 | R26 | Low | 0.4 | 167 | 66.8 | | | | | |
| 1.3.12 | Task A Support Activities | 22.2 | | 1.2.2 | R27 | Low | 0.4 | 950 | 380 | | | | | |
| 1.3.13 | Task B Support Activities | 1534.8 | | 1.2.2.B | R28 | Low | 0.2 | 60 | 12 | | | | | |
| 1.3.15 | Build Configuration Management | | | 1.2.2.E | R29 | Low | 0.1 | 122 | 12.2 | | | | | |
| 1.3.16 | EMI Mitigation SW | | | 1.2.3 | R30 | Low | 0.3 | 629 | 188.7 | | | | | |
| 1.3.17 | Software Management | 301.2 | | 1.2.3 | R31 | Low | 0.4 | 95 | 38 | | | | | |
| 1.3.2 | Signal Processing SW (SPSW) | 42.7 | | 1.2.3.7 | R32 | Low | 0.4 | 261 | 104.4 | | | | | |
| 1.3.3 | Station Display and Configuration SW (DCSW) | | | 1.2.3 | R33 | Low | 0.4 | 77 | 30.8 | | | | | |
| 1.3.4 | Operating System SW (OSSW) | | | 1.2.3 | R34 | Low | 0.25 | 54 | 13.5 | | | | | |
| 1.3.5 | ROE Simulations SW (RSSW) | | | 1.2.3.8 | R35 | Low | 0.1 | 122 | 12.2 | | | | | |
| 1.3.6 | Mission Attack Commands SW (MACSW) | 1465.0 | | 1.2.6 | R36 | Low | 0.3 | 443 | 132.9 | | | | | |
| 1.3.7 | Qual Tests | 72.4 | | 1.2.6 | R37 | Low | 0.4 | 67 | 26.8 | | | | | |
| 1.3.8 | Performance Planning SW (PPSW) | | | 1.2.6 | R38 | Low | 0.4 | 101 | 40.4 | | | | | |
| 1.3.9 | External Coordination SW (ECSW) | | | 1.2.6.7.1 | R39 | Low | 0.3 | 80 | 24 | | | | | |
| 1.4.1 | Integration | 445.0 | 375.0 | 1.2.6.6 | R40 | Low | 0.2 | 127 | 25.4 | | | | | |
| 1.4.2 | Test | | | 1.2.11 | R41 | Low | 0.1 | 124 | 12.4 | | | | | |
| 1.5.4 | Test and Measurement Equipment | | | 1.2.4 | R42 | Low | 0.3 | 1411 | 423.3 | | | | | |
| 1.5.5 | Support and Handling Equipment | | | 1.2.4 | R43 | Low | 0.4 | 213 | 85.2 | | | | | |
| 1.7 | ILS | 657.7 | | 1.2.4 | R44 | Low | 0.4 | 62 | 24.8 | | | | | |
| 1.8.1 | Program Management | 240.0 | | 1.2.4 | R45 | Low | 0.4 | 210 | 84 | | | | | |
| 1.8.2 | System Engineering | 269.2 | | 1.1.4 | R46 | Low | 0.2 | 900 | 180 | | | | | |
| 1.9 | Multi-Airframe Multi-Payload Integration | | 80.0 | 1.1.4 | R47 | Low | 0.1 | 71 | 7.1 | | | | | |
| 1.10 | Proposal Effort | | | 1.2.4 | R48 | Low | 0.1 | 80 | 8 | | | | | |
| 1.11 | Subcontract COM | | | 1.2.5 | R49 | Low | 0.3 | 528 | 158.4 | | | | | |
| Total | | 8603.8 | 2646.2 | 1.2.5 | R50 | Mod | 1 | 80 | 80 | | | | | |
| | | | | 1.2.5 | R51 | Low | 0.4 | 130 | 52 | | | | | |
| | | | | 1.2.5.6 | R52 | Low | 0.1 | 122 | 12.2 | | | | | |
| | | | | Total | | | | | 8603.75 | | | | | |

As the contract is executed, EVM metrics provide insight into the success of contractor risk mitigation and opportunity exploitation plans. During the planning phase, the contractor PM decides, given the risks and opportunities identified for the project, the amount of budget to allocate and the amount to allocate to Management Reserve (MR). Budgets for risk handling are allocated to the CA based on the risk's significance and where it exists in the WBS. Schedule risk assessments are performed to identify schedule risks.

MR is issued or returned to re-plan future work as needed to address realized risk or take advantage of captured opportunities. Quantified risks and opportunities are to be taken into account in the ETC for each CA and the overall baseline best, worst, and most likely EAC.

1.2.2.3 Contract Performance Report (CPR)

The CPR consists of five formats containing data for measuring contractors' cost and schedule performance on acquisition contracts.
Format 1 provides data to measure cost and schedule performance by WBS elements
Format 2 provides the same data by the contractor's organization (functional or IPT structure)
Format 3 provides the budget baseline plan against which performance is measured
Format 4 provides staffing forecasts for correlation with the budget plan and cost estimates
Format 5 is a narrative report used to explain significant cost and schedule variances and other identified contract problems and topics

Note: MCR advocates consistency among the IMS, ROAR, PMR and the CPR to include standardized formats and delivery of the information provided by these contract performance documents.

All of the available data from each CPR format should be collected and reviewed for accuracy and consistency. A wInsight™ database created by the contractor will contain this information as well and will provide all EV data in an integrated fashion to complete LCAA.

1.2.2.4 Integrated Master Schedule (IMS)

The IMS is an integrated schedule network of detailed program activities and includes key program and contractual requirement dates. It enables the project team to predict when milestones, events, and program decision points are expected to occur. Lower-tier schedules for the CAs contain specific CA start and finish dates that are based on physical accomplishment and are clearly consistent with program time constraints. These lower-tier schedules are fully integrated into the Program IMS.

Program activities are scheduled within work packages and planning packages and form the basis of the IMS. Resources are time-phased against the work and planning packages and form the Performance Measurement Baseline (PMB), against which performance is measured.

1.2.2.5 Technical Performance Measures (TPMs)

LCAA takes direct advantage of the system engineering (SE) discipline by exploring how

SE is linked to the program management system, and by exploiting technical performance measurement and measurement of technology maturity.

User/customer performance needs are typically explained in Measures of Effectiveness (MOE), Measures of Performance (MOP) and Key Performance Parameters (KPP). While these are critical factors in shaping program management approaches for a given program, they do not translate very well to the process of design, development and building. That is accomplished through the use of TPMs.

TPMs are measurable technical parameters that can be directly related to KPPs. TPMs also have the distinction of representing the areas where risks are likely to exist within a program. Examples include weight, source lines of code (SLOG) and mean time between failures (MTBF).

TPMs are likely the parameters a program cost estimator would use in the development of the LCCE. Likewise, it is expected the contractor based the PMB on these same parameters. Engineers and PMs use metrics to track TPMs throughout the development phase to obtain insight into the productivity of the contractor and the quality of the product being developed.

By linking TPMs with the contractor's EV performance, schedule performance and risk management, an analyst has the ability to further identify cost and schedule impacts and can incorporate those impacts into the program's ETC analysis. Inconsistencies between the recorded EV and the TPM performance measurement should be tracked as an issue and included in the Findings Log, as discussed below. The degree to which TPMs are directly integrated into CA performance measurement indicates the degree to which the performance data truly reflects technical performance.

1.2.2.6 Technology Readiness Levels (TRLs)

Technology Readiness Level (TRL) is another measurable parameter that applies to the maturity of the technology being developed. (Refer to DoD Defense Acquisition Guidebook, dated 2006, for standard definitions for TRLs.) Like TPMs, the TRL of a system or subsystem has a direct impact on the cost, schedule and risk of the program. It is important to note that Dr. Roy Smoker of MCR has spent significant time and effort researching the role of TRLs in acquisition management, to include its relationship to cost estimating [Smoker].

The TRL concept, which measures relative maturity in nine levels, has also been successfully applied to software and to manufacturing processes. As an example, a piece of software or hardware at TRL 1 reflects something written “on the back of an envelope or napkin” whereas a TRL 9 level represents the fully mature product in an operational environment. The levels between (e.g. TRL 2-8) are distinct evolutionary steps that reflect development from one extreme to the other.

Some CAs—especially those governing development of critical technology—may be able to measure progress based on achieved TRL. Many CAs, however, are not going to reflect TRLs. That does not mean TRLs can be ignored. To the contrary, attention is paid in analysis to the program's associated Technology Readiness Assessment (TRA), Technology Development Plan (TDP) and System Engineering Plan (SEP) to assess the degree to which the program management system is geared to mature (and assess progress in maturing) a given technology. There is a direct association between TRL and risk, and significant effort in time and resources is invariably required to progress from one TRL to the next higher level. One way or another, current and projected maturity of key technologies should be reflected by the management system.

1.3 Data Review

Findings from the data review that have connotations to the EAC analysis should be identified in a Findings Log. This Findings Log should be viewed as a potential list of risks and opportunities to be presented to the PM for consideration for inclusion in the Program Risk Register. The suggested format for the Findings Log is shown in Table 2.

TABLE 2
Findings Log
Findings Log

| | | | | | | | | |
|---|---|---|---|---|---|---|---|---|
| | | Origi- | Descrip- | | Fac- | | Factored | Com- |
| ID | Date | nator | tion | WBS | tor | Value | Value | ments |

1.3.1 Earned Value/CPR Data

The data analysis and set of standard observations used to determine the EV data validity and their potential causes or interpretations are found in Table 3. Findings here should be documented in the findings log and carried forward into the Gate 3 analysis when developing ETCs. At a minimum, each observation should be applied to the CA or the lowest level WBS element. The set of standard observations is not all inclusive but is an initial set of observations that the authors believe represent the key observations which the analyst should make relative to the data provided. Other data analysis can and should be performed, depending on the overall program environment.

TABLE 3
Earned Value Data Validity Checks

| Obser- | | | Possible Causes/Interpretations | |
|---|---|---|---|---|
| vation | Description | Formula | (not all inclusive) | Questions for CAM (or G-CAM) |
| 1 | Performance credited | (% Complete > | Lag in accounting system posting | Is there a rationale for the accounting lag? |
| | with $0 expenditures | 0 but | actuals; element is a subcontract and | Do you agree with the performance taken? |
| | | ACWP = $0) | not using estimated actuals | This says you have accomplished work but it didn't |
| | | | | cost anything to do it - help me understand how |
| | | | | this could be done. |
| 2 | Performance credited | (% Complete > | Scope not kept with its budget; work | Do you agree with the performance taken? |
| | with no budget | 0 but | package closed and budget moved to | How does this impact the schedule? |
| | | BCWS = $0) | other work package without taking the | It would appear that someone used the wrong |
| | | | EV with it; work authorization not | charge number or your plan has not been updated - |
| | | | followed | please explain otherwise how performance can be |
| | | | | taken with no money available. |
| 3 | No Budget | BAC = $0 | Work package closed and budget | Do you agree with the re-plan of the work? |
| | | | moved without moving associated EV | If actuals have accrued, was this move allowed by |
| | | | and actual | the EVMS system description? |
| | | | | Your control account has no budget. Does this |
| | | | | really exist or is there a miscommunication |
| | | | | between you and the person who runs the EVM |
| | | | | engine? |
| 4 | Percent Complete is | LRE “spent” < | % complete may actually be less than | Do you agree with the performance taken to date? |
| | higher than the LRE | % Complete | what has been reported | Is this performance consistent with the progress |
| | “spent” by more than | | | made against the TPMs? |
| | 5% | | | What you are saying is what you have |
| | | | | accomplished so far does not quite line up with |
| | | | | what you say you have left to do. Which is more |
| | | | | accurate: what you have accomplished or what you |
| | | | | say is left? |
| 5 | Percentage of LRE | LRE “spent” | LRE not updated recently | Is the future work planned appropriately? |
| | representing | (i.e., | | Is the future work resourced properly? |
| | completed work is | ACWP/LRE) > | | Is there an opportunity that should be captured? |
| | greater than % | % Complete | | How often do you update your own revised |
| | Complete | | | estimate to complete and what is the current one |
| | | | | based upon? It doesn't line up with what you have |
| | | | | accomplished so far? Are you expecting a change |
| | | | | in future work efficiency? |
| 6 | Budget Remaining is | BAC-BCWS < | Cost overrun for this CA or WP | Is the future work planned appropriately? |
| | less than Work | BAC-BCWP | | Is the future work resourced properly? |
| | Remaining | | | Is there a technical risk? |
| | | | | Based on what you have done so far and what it has |
| | | | | cost you, it doesn't look like you have enough |
| | | | | budget. Are you doing unplanned, in scope work |
| | | | | that might require MR? Do you need to revise your |
| | | | | estimate to show an overrun? |
| 7 | Budget Remaining is | BAC-BCWS > | Cost under-run for this CA or WP; | Is the future work realistically planned and |
| | greater than the Work | BAC-BCWP | work not being done; schedule delay | resourced? |
| | Remaining by 5% or | | | Is there a risk or opportunity that should be |
| | more | | | captured? |
| | | | | You have more budget remaining than you need for |
| | | | | the work remaining. How much of an opportunity |
| | | | | do you expect to capture and where is that going to |
| | | | | be recorded? Are you planning to transfer budget |
| | | | | back to the PM for overall management reserve |
| | | | | use? |
| 8 | LRE is less than the | LRE < IEAC1 | LRE not updated recently | Is the future work planned appropriately? |
| | (calculated) | | | Is the future work resourced properly? |
| | Independent Estimate | | | Is there a technical risk? |
| | At Complete | | | The typical EVM prediction formulas used are |
| | (IEAC1), where | | | showing, based on what you have done so far, that |
| | Actuals are added to | | | you are going to overrun. How is your LRE |
| | the (Remaining Work x | | | derived and what confidence do you have in it? |
| | the current CPI) | | | |
| 9 | LRE is higher than | LRE < IEAC1 | LRE has unrealistically overestimated | What has increased in the future effort? |
| | the IEAC1 by more | and difference | the cost of the remaining work; scope | Is the future work realistically planned and |
| | than 5% | is >5% | included in the LRE may have been | resourced? |
| | | | added since the IBR; additional scope | Is there a risk or opportunity that should be |
| | | | may have been established in a | captured? |
| | | | separate CA | Your LRE is much more conservative than even |
| | | | | what the EVM formulas are predicting. That is |
| | | | | unusual. Are you taking into account more work |
| | | | | than your plan currently shows? Do you expect to |
| | | | | be more inefficient? Why? |
| 10 | Current CPI is | CPI > 1.5 | Overestimated accomplishment | Do you agree with the performance taken to date? |
| | greater than 1.5 or for | | | Is this performance consistent with the progress |
| | every $1 spent more | | | made against the TPMs? |
| | than $1.50 worth of | | | Is the future work realistically planned and |
| | work is being | | | resourced? |
| | accomplished | | | Having such a positive cost efficiency is very |
| | | | | unusual. Assuming this is not an understaffed LOE |
| | | | | EV technique account, how realistic is your plan? |
| | | | | Did you capture an opportunity that is not |
| | | | | recorded? Are you going to take 50% of your |
| | | | | budget and give it back to the PM for management |
| | | | | reserve? |
| 11 | No performance has | CPI = 0 | Delay in start of work | Is this a WBS element where work is to occur in |
| | been taken and $0 | | | the future? |
| | have been spent | | | How does this impact the schedule? |
| | | | | The EVM data indicates this is delayed because |
| | | | | you haven't taken performance and no money has |
| | | | | been spent. Is this accurate or has work been |
| | | | | accomplished and there are lags in accounting? |
| | | | | And does this agree with what the IMS says? |
| 12 | Cost performance | CPI < .9 | Poor performance or risk element not | Was a risk realized? |
| | indicator is less than | | highlighted to management in time | If yes, was the risk identified? When? |
| | .9 or for every $1 | | enough to mitigate it. | Your cost efficiency is low, which means you are |
| | being spent less than | | | going to overrun significantly if something doesn't |
| | $0.90 worth of work | | | change. What has happened since work started that |
| | is being | | | is not the same as what you planned? And have |
| | accomplished | | | you translated this predicted overrun into the risk |
| | | | | register? |
| 13 | Actual expenditures | ACWP > LRE | Cost overrun for this CA or WP; LRE | Given the actuals to date already exceed the LRE, |
| | to date have already | | may need updating | how is the future work being addressed? |
| | exceeded the LRE | | | Do you agree with the schedule and resources |
| | | | | allocated to the future work? |
| | | | | Is the performance taken to date consistent with the |
| | | | | progress made against the TPMs? |
| | | | | You have already spent more money that you have |
| | | | | forecasted it will cost at completion. Clearly |
| | | | | something is wrong here. Has there been |
| | | | | significant unauthorized use of your CA charge |
| | | | | number by others or is this a case where you have |
| | | | | not updated your estimate? And what conditions |
| | | | | led you to wait this long to update the estimate? |
| | | | | Are we the only ones who have asked this |
| | | | | question? |
| 14 | The To Complete | TCPI > CPI | Estimate of remaining work may be | What has increased in the future effort? |
| | Performance Index | and the | overly optimistic; need to weigh along | Is the future work realistically planned and |
| | (TCPI) is higher than | difference | with element's percent complete | resourced? |
| | the current CPI sum | is >5% | | Is there a risk or opportunity that should be |
| | by more than 5% | | | captured? |
| | | | | EVM and acquisition history tells us there is almost |
| | | | | no way you are going to change your cost |
| | | | | efficiency overnight to achieve your LRE. Are you |
| | | | | absolutely sure your estimate is accurate? If so, |
| | | | | what is significantly different about the future work |
| | | | | that leads you to believe you will manage it even |
| | | | | more efficiently than previously? |
| 15 | The TCPI is less than | TCPI < CPI | May be nearing completion; LRE may | Is the future work planned appropriately? |
| | the current CPI sum | and the | be too low or not recently updated | Is the future work resourced properly? |
| | by more than 5% | difference | | Is there a technical risk? |
| | | is >5% | | Your estimate tells us that you are planning to be |
| | | | | inefficient in your work from here forwards? Why |
| | | | | are you planning to be so inefficient? What risks |
| | | | | are embedded in this plan forward that aren't in the |
| | | | | risk register? If there are no risks, then why not |
| | | | | challenge yourself to operate at something closer to |
| | | | | the efficiency you can currently achieve? |

It may be important to identify all of the CAs or lowest level WBS elements and tagged them. ETCs will be developed for those elements with work remaining. These ETCs will then be added to the Actual Cost of Work Performed (ACWP) to calculate the EAC. If a WBS element is forgotten, such as an element that is 100 percent complete at the time of the analysis, the resulting EAC will be inaccurate.

Schedule/IMS Data and Standard Observations

The data analysis and a set of standard observations used to determine the IMS data validity and their potential causes or interpretations are found in Table 4. Findings here will be documented in the findings log and carried forward into the Gate 3 analysis when developing ETCs for schedule risk assessment and the cost ETC. The observations are split between those appropriate to be applied to the CA or the lowest level WBS element and those to be applied to the overall master schedule. Additionally, the observations can also be applied to the remaining detailed planned work compared to the remaining work that has not been detailed planned, especially if a rolling wave concept is being used for planning details. The set of standard observations are not all inclusive but are an initial set of observations that the authors believe represent key observations which the analyst should make relative to the data provided. Other data analysis can and should be performed, depending on the overall program environment.

Schedule analysis is critical to maintaining the health of a schedule. Whether the user is managing a “simple” project schedule or an integrated master schedule (IMS) for a complex program, the need to maintain and monitor the schedule health is important. A schedule is a model of how the team intends to execute the project plan. The ability of a schedule to be used as a planning, execution, control, and communications tool is based upon the health or quality of the schedule and the data in the schedule. For a schedule to be a predictive model of project execution, there are certain quality characteristics that should be contained and maintained in the schedule throughout the life of the project or program.

This section is geared towards schedule development, control and analysis of projects that are required to manage and report EV data or schedule risk analysis (SRA) data. Developing an IMS which meets the intent of the EV or SRA requirements requires the integration of several pieces of information that do not necessarily directly relate to scheduling.

Schedule Validation and Compliance Analysis

Before schedule analysis can be performed, a series of checks must be completed. They are grouped into two sets:
Validation Checks which are entirely qualitative and determine if the schedule is compliant with contract requirements and should be accepted as a deliverable or not
Quantitative Checks to determine what areas of the schedule will produce valid data analysis

### Schedule Validity Analysis

The validity analysis checklist is a series of ten questions that should be answered each time a schedule is delivered by the supplier for acceptance by the customer. The over-all assessment as to whether to accept or reject a delivery is a qualitative decision that must be evaluated on a case by case basis. If a schedule delivery is rejected, the rejection notification should contain specific reasons/criteria for the rejection and what needs to be done to make the delivery acceptable.

The questions that should be asked as a part of the validity analysis are as follows:
Does the schedule cover all of the work described in the Work Breakdown Structure (WBS)?
Are project critical dates identified in the schedule?
Is the scheduled work logically sequenced?
Are any schedule constraints, lead times, or lag times justified?
Are the duration estimates meaningful and tied to a Basis of Estimate (BOE)?
Are the resource estimates reasonable and tied to a BOE?
Do the float times seem reasonable?
Is the number of activities on the critical path decreasing?
Is the project status logical and do the forecasts seem reasonable?
Is the schedule executable with an acceptable level of risk to project completion?

These questions, while seemingly innocuous, delve into the heart of project management. Further elaboration of each question reveals the level of complexity involved in these questions.

The ten questions can then be grouped into 3 larger groups. The first 7 questions have to do with how well the schedule is planned out or constructed. The answer to these questions should slowly improve over time if the overall schedule quality is improving. Questions 8 and 9 have to do with the quality of the status updates that are incorporated in the schedule. These may vary from month to month. The last question, number 10, has to do with the ability of the schedule to be predictive. If the schedule quality is improving, this metric should also be improving.

### Schedule Compliance Analysis

Schedule compliance analysis is more qualitative than schedule validation analysis. Schedule compliance analysis determines whether or not the schedule meets the deliverable specifications and the type of analysis that can be performed on the schedule once it is received. The results of the schedule analysis may be invalid as a result of the schedule being non-compliant. The schedule compliance metrics are broken into the same general groupings as the schedule validation analysis.

The questions that should be asked as a part of the compliance analysis are the same as for the schedule validation except this time the answers are quantitative instead of qualitative and use schedule metrics to determine schedule “goodness.” As before, there are still three major groupings but the individual metrics help define additional integrating questions or answer each of the integrating questions.

The schedule metrics are summarized in a table below:

TABLE 4
Schedule Validity Data Checks

| | | | | |
|---|---|---|---|---|
| Obser- | | | | Possible Cause/ |
| vation | Criteria Name | Guidelines | Description | Interpretation |

Quality of the Schedule Plan
1. Does the Schedule cover all of the work described in the Work Breakdown Structure?

| | | | | |
|---|---|---|---|---|
| 1 | Tasks With Missing WBS | G—0%-2% | All tasks should have a Work Breakdown Structure (WBS) | Change Request being |
| | | Y—2%-5% | identifier assigned. The WBS is the key to cost schedule | prepared. Alternatives |
| | | R—5%-100% | integration. A missing WBS identifier gives the appearance of | analysis being performed. |
| | | | work being done that is not within the budget or scope of the | Schedule not ready for |
| | | | program. Calculation is tasks with missing WBS as a | baseline. Schedule and EV |
| | | | percentage of all tasks. | engine maintained |
| | | | | separately |
| 1 | Tasks With Missing OBS | G—0%-2% | All tasks should have an OBS identifier assigned. The OBS is | Change Request being |
| | | Y—2%-5% | one of the keys to cost schedule integration. A missing OBS | prepared. Alternatives |
| | | R—5%-100% | identifier gives the appearance of work being done that is not | analysis being performed. |
| | | | within the responsibility of the program. Calculation is tasks | Schedule not ready for |
| | | | with missing OBS as a percentage of all tasks. | baseline. Schedule and EV |
| | | | | engine maintained |
| | | | | separately |
| 3 | Baseline Resources and | G—0 | Electronic integration of the resource loaded schedule with | Change Request being |
| | Performance Measurement | Y—N/A | the EV engine is a best practice. It allows for greater | prepared. Alternatives |
| | Technique Don't Match | R—>1 | transparency in the EVMS and provides management | analysis being performed. |
| | | | controls which make data manipulation between the | Schedule not ready for |
| | | | schedule engine and the cost engine more difficult. All of the | baseline. Schedule and EV |
| | | | tasks that have resources assigned must have a WBS code, | engine maintained |
| | | | an OBS code, a performance measurement technique (PMT) | separately |
| | | | and a Work Package identity (WPID) identified in order for | |
| | | | the schedule information to be integrated into the EV engine. | |

2. Are the project critical dates identified in the schedule?

| | | | | |
|---|---|---|---|---|
| 4 | Project Critical Dates | G—0%-5% | Project critical dates should be identified in an Integrated | Project critical dates may |
| | | Y—5%-15% | Master Plan (IMP). The IMS should be vertically traceable to | not be identified and |
| | | R—15%-100% | the IMP. The schedule should have a numbering system that | maintained in the schedule. |
| | | | provides traceability to the IMP. The IMP should identify and | Project is behind schedule |
| | | | assess actual progress versus the planned progress using | in key areas. |
| | | | Key Performance Parameters (KPPs) and Technical | |
| | | | Performance Measures (TPMs). Are the Project Critical | |
| | | | Dates being met? | |

3. Is the scheduled work logically sequenced?

| | | | | |
|---|---|---|---|---|
| 5 | Missing Predecessors | G—0%-2% | All tasks should have a predecessor, with a few exceptions | Schedule is not a CPM |
| | | Y—2%-6% | like starting milestones. The calculation is tasks that are | schedule. SRA results will |
| | | R—6%-100% | missing predecessors as a percentage of incomplete tasks & | be invalid. Schedule is |
| | | | milestones. | comprised mainly of |
| | | | | constraints. Team does not |
| | | | | understand how the work |
| | | | | is/will be performed. |
| 6 | Missing Successors | G—0%-2% | Almost every task should have a successor, with a few | Schedule is not a CPM |
| | | Y—2%-6% | exceptions like the end of project milestone. The question to | schedule. SRA results will |
| | | R—6%-100% | ask is: ‘If the output of the task's effort does not go to anyone | be invalid. Schedule is |
| | | | else, why are we doing the work?’ The calculation is tasks | comprised mainly of |
| | | | that are missing successors as a percentage of incomplete | constraints. Team does not |
| | | | tasks & milestones. | understand how the work |
| | | | | is/will be performed. |
| 7 | Tasks Without Finish- | G—0%-15% | The majority of the task dependencies should be Finish-to- | SRA results may be invalid. |
| | to-Start Predecessors | Y—15%-25% | Start. Since most of the tasks represent work that will have a | Team does not understand |
| | | R—25%-100% | start and an end date resulting in some product or document | how the work is/will be |
| | | | that is needed by someone else, the work is performed in | performed. Schedule may |
| | | | some sequence most of the time. If the majority of the tasks | be at too high a level. |
| | | | require parallel linkages the tasks may be at too high a level. | |
| | | | Calculation is tasks without finish-to-start predecessors as a | |
| | | | percentage of effort tasks. | |
| 8 | Summary Tasks With | G—0 | Summary tasks should not have predecessors or | Schedule is not a CPM |
| | Predecessors | Y—N/A | successors. Many scheduling software applications have | schedule. SRA results will |
| | | R—>1 | difficulty calculating dates and critical paths when summary | be invalid. Team does not |
| | | | tasks and detail tasks are linked. | understand how the work |
| | | | | is/will be performed. |
| | | | | Schedule may be a too low |
| | | | | a level. |
| 9 | Summary Tasks With | G—0 | Summary tasks should not have predecessors or | Schedule is not a CPM |
| | Successors | Y—N/A | successors. Many scheduling software applications have | schedule. SRA results will |
| | | R—>1 | difficulty calculating dates and critical paths when summary | be invalid. Team does not |
| | | | tasks and detail tasks are linked. | understand how the work |
| | | | | is/will be performed. |
| | | | | Schedule may be a too low |
| | | | | a level. |

4. Are any schedule constraints, lead times, or lag times justified?

| | | | | |
|---|---|---|---|---|
| 10 | Tasks with | G—0%-15% | Tasks should rarely be artificially tied to dates. Durations | Schedule is not a CPM |
| | Constrained Dates | Y—15%-20% | and/or Resources combined with schedule logic and work | schedule. SRA results will |
| | | R—20%-100% | day calendars should determine schedule dates. If a | be invalid. Team does not |
| | | | significant number of constrained dates are used, the | understand how the work |
| | | | schedule may not calculate the critical path and near critical | is/will be performed. If large |
| | | | paths correctly. Calculation is tasks with a constrained date | lead and lag times are also |
| | | | as a percentage of incomplete tasks and milestones. | present, the schedule may |
| | | | | be at too high a level. |

5. Are the duration estimates meaningful and tied to a Basis of Estimate (BOE)?

| | | | | |
|---|---|---|---|---|
| 11 | Effort Tasks | G—20%-100% | Effort tasks as a percentage of all tasks. | Team does not understand |
| | | Y—10%-20% | | how the work is/will be |
| | | R—0%-10% | | performed. The schedule |
| | | | | may be at the wrong level. |
| 12 | Milestones | G—0%-20% | The schedule should be primarily made up of discrete tasks | Team does not understand |
| | | Y—20%-30% | that have work associated with them. Summaries and | how the work is/will be |
| | | R—30%-100% | Milestones are needed for reporting and program tracking | performed. The schedule |
| | | | but should not be the majority of the line items. | may be at the wrong level. |
| | | | | The Team is trying to track |
| | | | | everything through |
| | | | | milestones which can be |
| | | | | onerous. |
| 13 | Summary Tasks | G—0%-20% | The schedule should be primarily made up of discrete tasks | Team does not understand |
| | | Y—20%-30% | that have work associated with them. Summaries are needed | how the work is/will be |
| | | R—30%-100% | for reporting and program tracking but should not be the | performed. The WBS is far |
| | | | majority of the line items. | too detailed. The schedule |
| | | | | may be at too low a level. |
| 14 | Task With | G—0%-25% | Task durations should generally be between 5 and 20 | Team does not understand |
| | Duration <5 d | Y—25%-35% | working days. Too much detail can make the schedule | how the work is/will be |
| | | R—35%-100% | unreadable, unmaintainable, and ultimately unusable as a | performed. The schedule |
| | | | management tool. Too little detail can make the schedule | may be at too low a level. |
| | | | little more than window dressing. Sufficient detail must exist | The level of detail may |
| | | | to clearly identify all the key deliverables and must contain | become onerous. SRA |
| | | | enough information to know what state the project is in at any | results may be inaccurate. |
| | | | given point in time. Industry consensus is that near term | |
| | | | tasks should be a week to a month in length. When less than | |
| | | | a week, you will spend more time maintaining and updating | |
| | | | the schedule than is practical. When more than a month, you | |
| | | | will not be able to get an accurate estimate of progress and | |
| | | | forecasted completion dates. Calculation is tasks with a | |
| | | | duration of less than 5 days as a percentage of effort tasks. | |
| 15 | Task With | G—0%-15% | Task durations should generally be between 5 and 66 | Team does not understand |
| | Duration >66 d | Y—15%-20% | working days or 1 week and 3 months. Too little detail can | how the work is/will be |
| | | R—20%-100% | make the schedule little more than window dressing. | performed. The schedule |
| | | | Sufficient detail must exist to clearly identify all the key | may be at too high a level. |
| | | | deliverables and must contain enough information to know | The percentage of LOE may |
| | | | what state the project is in at any given point in time. Industry | be high. There may be a lot |
| | | | consensus is that near term tasks should be a week to three | of planning packages. SRA |
| | | | months in length. When tasks are more than a three months | results may be inaccurate. |
| | | | long, it is difficult to accurately estimate progress and | |
| | | | forecast completion dates. | |

6. Are the resource estimates reasonable and tied to a BOE?

| | | | | |
|---|---|---|---|---|
| 16 | Summaries With | G—0 | As a general rule, summary tasks should not have resources | Team does not understand |
| | Resources | Y—N/A | assigned to them. They are strictly an outlining or rolling up | how the work is/will be |
| | | R—>1 | feature and should not drive schedule dates or resource | performed. The schedule |
| | | | loading. There may be instances when it is acceptable to | may be at too low a level. |
| | | | assign resources to summary tasks instead of detail tasks. | There may be a lot of |
| | | | This is acceptable as long as resources are not loaded at | planning packages. The |
| | | | both levels where they would be double counted. The | resources may be double |
| | | | calculation is tasks with summary resources as a percentage | counted. |
| | | | of effort tasks. | |
| 17 | Tasks Without | G—0%-5% | A resource loaded project schedule should have resources | The resources for the work |
| | Assigned Resources | Y—5%-10% | assigned to all discrete tasks and should not have resources | may be contained in |
| | | R—10%-100% | assigned to summary tasks. Resource planning requires that | another control account or |
| | | | all discrete tasks be resource loaded in order to analyze and | schedule line. The schedule |
| | | | identify resource constraints or overloaded resources. | and the EV engine may be |
| | | | Calculation is tasks without assigned resources as a | maintained separately. |
| | | | percentage of incomplete tasks. | |
| 18 | Milestones with | G—0 | Milestones should not have resources assigned to them. | The team may be trying to |
| | Resources Assigned | Y—N/A | They have zero duration and thus cannot have work | identify who is responsible |
| | | R—>1 | assigned to them. There are no instances when it is | for or performing the work |
| | | | appropriate to assign resources to a milestone. | leading up to the milestone. |

7. Do the float times seem reasonable?

| | | | | |
|---|---|---|---|---|
| 19 | Tasks with Total | G—0 | All schedules should have a reasonably small amount of | Team does not understand |
| | Slack >200 d | Y—N/A | slack or float. Large positive or negative slack values may | how the work is/will be |
| | | R—>1 | indicate a poorly constructed schedule. Large negative slack | performed. There may be a |
| | | | indicates a logic error or a program that is no longer on track | lot of planning packages. |
| | | | to meet its commitment dates. Large positive slack may | SRA results may be |
| | | | indicate poor or missing logic. | inaccurate. Work may be |
| | | | | missing from the network. |
| | | | | Project end date may be |
| | | | | constrained. Network logic |
| | | | | may be flawed. |
| 20 | Tasks with Total | G—0 | Most projects fall behind schedule during their normal | Team does not understand |
| | Slack <−200 d | Y—N/A | execution. However, a project should not operate for a | how the work is/will be |
| | | R—>1 | significant period of time with large negative slack. Recovery | performed. SRA results will |
| | | | plans or workarounds should be identified and implemented. | be inaccurate. Project end |
| | | | If none are feasible, a new plan should be drafted to an | date may be constrained. |
| | | | agreed-upon completion date. | Schedule is not statused |
| | | | | correctly. Network logic may |
| | | | | be flawed. |
| 21 | Tasks with Total | G—0%-25% | All schedules should have a reasonably small amount of | Team does not understand |
| | Slack >44 d | Y—25%-50% | slack or float. Slack values of more than 44 days, or 2 | how the work is/will be |
| | | R—50%-100% | months, indicate that work can wait for over 2 months to start | performed. SRA results may |
| | | | the next task. This amount of slack indicates that there may | be inaccurate. Project end |
| | | | be missing work in the network. | date may be constrained. |
| | | | | Schedule is not statused |
| | | | | correctly. Network logic may |
| | | | | be flawed. Resource |
| | | | | allocations may drive slack |
| | | | | results. |
| 22 | Tasks with Total | G—0%-10% | All schedules should have a reasonably small amount of | Team does not understand |
| | Slack <−20 d | Y—10%-15% | slack or float. Large positive or negative slack values may | how the work is/will be |
| | | R—15%-100% | indicate a poorly constructed schedule. Large negative slack | performed. SRA results will |
| | | | indicates a logic error or a program that is no longer on track | be inaccurate. Project end |
| | | | to meet its commitment dates. Large positive slack may | date may be constrained. |
| | | | indicate poor or missing logic. | Schedule is not statused |
| | | | | correctly. Network logic may |
| | | | | be flawed. Project may be |
| | | | | unrecoverable under current |
| | | | | operations. |

Quality of the Schedule Status
8. Is the number of tasks on the critical path increasing?

| | | | | |
|---|---|---|---|---|
| 23 | Incomplete | G—0%-15% | The Critical Path is one of the most important areas of the | Project is behind schedule |
| | Critical Tasks | Y—15%-25% | program schedule. It is usually the most difficult, time- | and getting worse. Team |
| | | R—25%-100% | consuming, and technically challenging portion of the | does not understand how |
| | | | schedule. It should represent a small portion of the overall | the work is/will be |
| | | | program schedule. This score measures the percent of all | performed. Project end date |
| | | | incomplete tasks that are critical. | may be constrained. |
| | | | | Schedule is not statused |
| | | | | correctly. Network logic may |
| | | | | be flawed. |

9. Is the project status logical and do the forecasts seem reasonable?

| | | | | |
|---|---|---|---|---|
| 24 | Tasks Without | G—0 | Baseline dates for tasks and milestones should be | Change Request being |
| | Baseline Start | Y—N/A | established in the project schedule early in the program. For | prepared. Alternatives |
| | | R—>1 | large projects, the contract may require this to be done in 60 | analysis being performed. |
| | | | to 90 days after the start date and prior to a formal review. | Schedule not ready for |
| | | | Calculation is tasks without a baseline start as a percentage | baseline. Schedule and EV |
| | | | of incomplete tasks and milestones. | engine maintained |
| | | | | separately |
| 25 | Tasks Without | G—0 | Baseline dates for tasks and milestones should be | Change Request being |
| | Baseline Finish | Y—N/A | established in the project schedule early in the program. For | prepared. Alternatives |
| | | R—>1 | large projects involving a customer, the contract may require | analysis being performed. |
| | | | this to be done in 60 to 90 days after the start date and prior | Schedule not ready for |
| | | | to a formal review. Calculation is tasks without a baseline | baseline. Schedule and EV |
| | | | finish as a percentage of incomplete tasks and milestones. | engine maintained |
| | | | | separately |
| 26 | Tasks Without | G—0 | As a general rule, only detail tasks should have resources | Change Request being |
| | Baseline Resources | Y—N/A | assigned to them. Detail tasks that do not have resources | prepared. Alternatives |
| | | R—>1 | assigned to them have no work assigned to them. There may | analysis being performed. |
| | | | be instances when it is acceptable to not assign resources to | Schedule not ready for |
| | | | detail tasks. This is acceptable as long as there is a valid | baseline. Schedule and EV |
| | | | reason for not assigning resources. Baseline resources for | engine maintained |
| | | | tasks should be established in the project schedule early in | separately |
| | | | the program. For large projects, the contract may require this | |
| | | | to be done in 60 to 90 days after the start date and prior to a | |
| | | | formal review. Once the schedule is baselined, all schedule | |
| | | | elements should contain baseline values. | |
| 27 | Tasks With Missing | G—0 | Baseline information for tasks and milestones should be | Change Request being |
| | Baseline Information | Y—N/A | established in the project schedule early in the program. For | prepared. Alternatives |
| | | R—>1 | large projects, the contract may require this to be done in 60 | analysis being performed. |
| | | | to 90 days after the start date and prior to a formal review. | Schedule not ready for |
| | | | Once the schedule is baselined, all schedule elements | baseline. Schedule and EV |
| | | | should contain baseline values. | engine maintained |
| | | | | separately |
| 28 | Out of Sequence Tasks | G—0 | Determines tasks that have begun when their predecessors | Project may be trying to |
| | | Y—N/A | or successors are not 100% complete | improve schedule by |
| | | R—>1 | | opening work packages. |
| | | | | Project may be trying to |
| | | | | “fast track” schedule. |
| 29 | Predecessors Complete, | G—0%-10% | Schedule progress should drive the end dates of the | Project may be under a stop |
| | Task Not Started | Y—10%-15% | program. Not scheduling forward or leaving incomplete work | work. Work may be delayed |
| | | R—15%-100% | in the past does not allow for a true picture of the project | due to other undocumented |
| | | | status and projected end date. | resources, constraints, or |
| | | | | predecessors. |
| 30 | Delinquent Tasks | G—0 | Tasks that should have started but didn't or should have | Project may be under a stop |
| | | Y—N/A | finished (but didn't). Task Summary is No and Task Start ≦ | work. Work may be delayed |
| | | R—>1 | Project Status Date and Actual Start is not set or Task | due to other undocumented |
| | | | Finish ≦ Project Status and Actual Finish is not set | resources, constraints, or |
| | | | | predecessors. |
| 31 | Actual Start/Finish | G—0 | Actual dates must reflect when a task started and or | Project may be inputting |
| | Dates in the Future | Y—N/A | completed. They should not be auto-generated and should | status in wrong schedule. |
| | | R—>1 | not exist in the future. An actual finish date cannot be earlier | Project may be “forecasting” |
| | | | than the actual start date for a task. Calculation is tasks with | status. |
| | | | start/finish dates in the future as a percentage of effort | |
| | | | tasks. | |
| 32 | Actual Finish Before | G—0 | An actual finish date should never be before an actual start | Project may be “forecasting” |
| | Actual Start | Y—N/A | date. Calculation is tasks with actual finish dates before the | status. |
| | | R—>1 | actual start dates as a percentage of effort tasks. | |
| 33 | Baseline Vertical | G—0 | Looks at each summary task and makes sure that the next | Project may be |
| | Schedule Integration Error | Y—N/A | level tasks all roll up. The calculation compares the baseline | incorporating baseline |
| | | R—>1 | start and finish dates of the summary tasks to those of the | changes at a lower level |
| | | | lower level details tasks. | and not rolling them up to |
| | | | | upper levels. Schedule may |
| | | | | be too complex. |

Predictive Ability of the Schedule
10. Is the schedule executable with an acceptable level of risk to project completion?

| | | | | |
|---|---|---|---|---|
| 34 | Incomplete Tasks | G—N/A | The closer a project is to completion, the less we are able to | The project may be detailing |
| | | Y—N/A | influence its final financial and schedule outcome without a | out planning packages. The |
| | | R—N/A | significant intervention. The calculation is incomplete tasks | project may be continually |
| | | | as a percentage of effort tasks. | replanning and defining |
| | | | | work. |
| 35 | Baseline Execution Index | G—95%-100% | Finished tasks as a percentage of tasks that should be | The project may be detailing |
| | | Y—85%-95% | finished | out planning packages. The |
| | | R—0%-85% | | project may be continually |
| | | | | replanning and defining |
| | | | | work. |
| 36 | Complete Tasks | G—N/A | This metric counts the percentage of complete tasks to total | The project may be detailing |
| | | Y—N/A | tasks. The higher the percentage of complete tasks to the | out planning packages. The |
| | | R—N/A | total number of tasks, the less opportunity to make changes | project may be continually |
| | | | that will affect the schedule outcome. The calculation is | replanning and defining |
| | | | complete tasks as a percentage of effort tasks. | work. |
| 37 | In Process Tasks | G—N/A | This metric counts the percentage of in process tasks to total | Project may be trying to |
| | | Y—N/A | tasks. An increasing percentage of in process tasks could be | improve schedule by |
| | | R—N/A | an indication that the project is falling behind schedule. | opening work packages. |
| | | | | Project may be trying to |
| | | | | “fast track” schedule. |
| 38 | Not Started Tasks | G—N/A | This metric counts the percentage of tasks that have not | Project may be under a stop |
| | | Y—N/A | started and compares it to total tasks. The higher the | work. Work may be delayed |
| | | R—N/A | percentage of not started tasks to the total number of tasks, | due to other undocumented |
| | | | the more opportunity to make changes that will affect the | resources, constraints, or |
| | | | schedule outcome. The calculation is not started tasks as a | predecessors. The project |
| | | | percentage of effort tasks. | may be detailing out |
| | | | | planning packages. The |
| | | | | project may be continually |
| | | | | replanning and defining |
| | | | | work. |
| 39 | Project Has Status Date | G—Yes | Without a status date, it is not known whether the status | Change Request being |
| | | | information in the file is up to date. The schedule status date | prepared. Alternatives |
| | | | defines the point in time that progress was measured | analysis being performed. |
| | | | against. | Schedule not ready for |
| | | | | baseline. Schedule and EV |
| | | | | engine maintained |
| | | | | separately |

1.3.2 Program Risk Assessment

The program and/or contract risk registers should be mapped to the contract WBS. It is important to understand which risks and opportunities have been incorporated into the budgets of the CAs and therefore already included in the PMB.

Other risks and opportunities may have been included in MR. When completing the analysis, it is necessary to compare the value of the risks and opportunities to the available MR and avoid double-counting.

1.3.3 Schedule Risk Assessment

Specific details on how to perform a Schedule Risk Assessment (SRA) are located in Appendix X of the GAO Cost Estimating and Assessment Guide: Best Practices for Developing and Managing Capital Program Costs, Appendix X.

1.3.3.1 Results of Schedule Risk Assessment

The major components of an SRA include:

1. Determining Risk Areas: The technical areas that contain the most risk are determined by the use of a Criticality Index. This index provides a probability of an individual task becoming critical at some point in the future.

2. Performing a Sensitivity Analysis: This analysis determines the likelihood of an individual task affecting the program completion date. In many tools, an output of a schedule risk assessment is a sensitivity analysis. It is also known as a “Tornado Chart” because of its funnel shaped appearance. The chart outlines the singular impact of each task on the end of the project thereby highlighting high-risk tasks/focus areas.

3. Quantifying Risk using Dates: A histogram is used to show dates when key events or milestones will occur. The use these dates help portray the distribution of risk to the program office. A trend diagram showing the results of subsequent schedule risk assessment is used to reflect the results of mitigation efforts or whether more risk is being incurred. Cost Estimate/BOEs and CFSR Data and Standard Observations

The data analysis and a set of standard observations (to be developed) are used to determine the cost estimate and CFSR data validity, and their potential causes or interpretations are found in Table 3. Findings here will be documented in the findings log and be carried forward into the Gate 3 analysis when developing ETCs for schedule risk assessment and the cost ETC. The set of standard observations have not been developed as of this document writing, but observations should be made relative to the data provided. Technical/TPMs, TRLs and Other Technical Data and Standard Observations

The data analysis and a set of standard observations (to be developed) are used to determine the Technical data validity and their potential causes or interpretations. Findings here will be documented in the findings log and carried forward into the Gate 3 analysis when developing ETCs for schedule risk assessment and the cost ETC. The set of standard observations have not been developed as of this document writing, but observations should be made relative to the data provided.

Issues and Risks/Opportunities/ROAR Data

The program and/or contract issues list and ROAR should be mapped to the program and contract WBS. These lists/registers are the starting point for the overall risk adjustments to be performed in Gate 3. It is important to understand which issues, risks or opportunities have been incorporated into the CA budgets and, therefore, are already included in the PMB. As the findings logs are reviewed and considered for incorporation in to the lists/registers, each should be assessed on whether past performance and/or the current budget baseline has already captured the future costs/time required at the appropriate level given the uncertainty. Generally, the discrete list/registers are not comprehensive and unknowns abound which represent further adjustments that are not being made due to lack of knowledge and insight. This is where the Gate 2 assessment can assist the analysis in determining how much unknown issues, risks or opportunities should be incorporated in to the estimates.

1.3.3.2 Developing Correlation Matrices for Summation of WBS Elements

After decomposing the project schedule to the CA or lowest level elements consistent with the EV data, the next step is to develop correlation matrices for the statistical summation of the data.

The following default correlation coefficients should be used:
Assign 0.9 correlation coefficients to WBS elements whose paths join at integration points (events that integrate schedule network flow)
Assign 0.9 correlation coefficients to WBS elements that succeed each other on the critical path
Assign 0.2 correlation coefficients to WBS elements without paths joining at integration points
Assign 0.2 correlation coefficients to WBS elements that are related technically
Assign 1.0 correlation to typical MIL-HDBK-881A Level 2 WBS elements

It is up to the analyst to manually revise correlation coefficients when deemed appropriate based on their relationships in the schedule. However, the accepted range for any correlation coefficient is a value between 0.2 and 1.0.

FIG. 3A depicts an exemplary embodiment of an exemplary LCAA quantitative data process relationships flow diagram 300, according to an exemplary embodiment of the present invention.

2.1 Introduction to Data Transparency Assessment

As shown on FIG. 1, Gate 2 104, Data Transparency measurements help a PM to articulate the important role played by process risk and information dissemination in the management of acquisition programs. The measurements target processes and artifacts that can help shape the context for the PM's decision-making. The purpose of measuring data transparency is to provide two forms of actionable information to the PM. First, transparency serves as a relative measure of the management system's ability to reflect how a program is actually performing and predict future results. Second, transparency serves as a practical way to articulate relationships among program performance reporting, management process execution, quality assurance and EVM surveillance. Transparency helps PMs determine the extent to which their management systems are performing in terms of providing reliable and useful information. There are five program management areas measured for transparency in Gate 2 104:
Cost—Cost estimating (such as a program office estimate) as well as derivation of estimates at complete based on EVM analysis (to include CPR Format 5)
Risk—Risk management and reporting as expressed in the risk register (and occasionally CPR Format 5)
Earned Value Management—The anchor of the program's performance measurement system (typically reflected in CPR Format 1)
Schedule—Scheduling as reflected in the IMS and its associated periodic analysis
Technical—System engineering in terms of technical performance and the degree to which quality measurements are integrated into program performance reporting.

Programs with strong T-Scores™ tend to have a better chance of identifying and developing mitigation plans which are more efficient and less costly in avoiding risks and capturing opportunities than programs with weak transparency scores.

Summary of Gate 2 Transparency Scoring Steps

Link Gate 1 to Gate 2: This step ensures direct incorporation of Gate I documents and compliance findings, 15 EVM Observations (discussed below), Schedule Validity Check and Schedule Risk Analysis results.

Reinforce Quantitative Alignment With Technical: EVM performance data harvested, analyzed and subsequently incorporated into development of ETC's will not necessarily be an accurate reflection of technical performance. This ought to be explicitly considered in terms of adjusting for risk and/or generating ETCs, and thus should, as a minimum be part of Gate 3 analysis and Gate 4 outputs.

Execute Transparency Scoring for Discipline: The discipline transparency assessment step helps gauge the degree to which a PM's decision loop is open, which translates to the degree to which the PM can recognize change. It examines the relative quality of the major CREST functions (Cost, Risk, EVM, Schedule, and Technical) in terms of Organization and Planning, Compliance, Surveillance, Data Visibility, Analysis and Forecasting.

Execute Transparency Scoring for Linkage: The linkage transparency assessment step examines the planning and execution aspects of cost, risk, budget, schedule, engineering and the WBS upon which the disciplines are grounded. Here the objective is to assess how the management system “pulls” information across disciplines and translates it for effective management use as manifest in the planning documents and performance reporting. This step also directly incorporates the following from Gate 1: documents and compliance findings, 15 EVM Observations, Schedule Validity Check and Schedule Risk analysis

Develop Composite Transparency Score Matrix: This step calculates the overall Data Transparency score to reflect the relative objective assessment of the management system outputs and helps a PM to assess the role played by information dissemination in managing his/her acquisition program.

Record Findings, Identify Risks and Construct Input to Gate 4: Findings from the Gate 2 assessments should be added to the Findings Log created during the Gate 1 Data Review. This Findings Log should be viewed as a potential list of risks and opportunities to be presented to the PM for consideration for inclusion in the Program Risk Register. This ensures identification and prioritization of possible conditions leading to cost, schedule and technical risk impacts in a manner traceable to the lowest practicable WBS element or control account. This is then integrated with a “pre-mortem” framework and inputs for accomplishment of executive intent.

Link Gate 1 to Gate 2

Documents: The previous section covering Gate 1 articulated the documentation optimally required to accomplish a complete LCAA. The following succinctly describes the unique inputs each document provides to Gate 2 Transparency. The range of artifacts characterized horizontally (across disciplines) and vertically (in scope and breadth) allows, through use of checklists and prompts by software, targeted sampling of linkage and consistency. It also helps correlate broader goals and objectives to the ability of the program Performance Measurement System to indicate progress towards the same. This information is provided by each of the following:

Programmatic
Concept of Operations: strategic implications, capability gap, relation to business case analysis, system architecture, potential resources requirements, key performance objectives, affordability, environmental issues, interoperability, support considerations, operational considerations.
Technology Development Plan/Strategy: R&D strategy, maturity of technology to support further development within reasonable risk tolerance (including cost, schedule, performance, security), role of prototypes, and demos, consistency and linkage with acquisition strategy; Describes significant events for incorporation into the IMP, Plans technology developments and demonstrations (in coordination with systems engineering, test and evaluation and logistics and support personnel/organizations) needed for the capability under consideration.
Acquisition Strategy: acquisition approach, contracting approach, significant risks, program management philosophy; dependencies; significant events (for incorporation into imp), funding source(s); funding constraints; schedule constraints; total ownership costs.
Acquisition Program Baseline (APB): provides broad frame of reference for analysis in terms of acceptable objectives and thresholds in terms of cost, schedule and performance.
Program Management Plan (PMP): provides insight into the relationships anticipated between and among constituent functions and other elements germane to the program office.
Periodic Program Management Review (PMR) Charts: best “snapshot” indicators of program information directly pushed to PM based on PM preferences, the actionability of performance information and linkage across disciplines.

Cost
Program Life-Cycle Cost Estimate (PLCCE): provides insight into the cost estimating discipline, its linkage to other program support disciplines, and also serves as a useful source of risk information not otherwise recorded within the risk management system.
Contract Fund Status Report (CFSR): provides insight into the program financial function and the degree of linkage to other disciplines, especially EVM.

Risk
Risk Management Plan (RMP): provides frame of reference for risk management discipline and calibrates perspective on expectations on the contribution of risk management within the program office.
Program and Contractor Risk, Opportunity and Assessment Registers (ROARs): although this document doesn't necessarily exist as written, the minimum requirement is access to the detailed risk register in order to gauge discipline and consistency in process execution.

Earned Value
Contract Performance Report (CPR): provides insight into the process discipline associated with EVM implementation as well as its linkage to all other disciplines that shape contract and program performance. Is also the source of the “15 observations”.
CWBS Dictionary: enables direct insight into scope development and potential gaps, to include incorporation of requirements, derived requirements in particular.

Schedule
Integrated Master Plan (IMP): characterizes program architecture and articulates key events and associated success criteria contained in artifacts such as the Concept of Operations, Acquisition Strategy, and plans for Technology Development, Test & Evaluation and Logistics and Support, thus enabling rapid assessment of discipline linkage and reasonableness of framework used for performance measurement (including measures of effectiveness, measures of performance, technical performance measures, accomplishment criteria) and the realism in terms of linkage to the integrated master schedule.
Integrated Master Schedule (IMS): Source of detailed schedule validity analysis and primary focal point for practical linkage of disciplines across the program.

Technical
Systems Engineering Management Plan (SEMP), Software Development Plan (SDP) and Test & Evaluation Master Plan (TEMP): contribute to assessment of the overall technical approach, consistency in delineation of performance objectives, functional expectations, linkage to other artifacts, especially WBS, IMP, IMS, CPR and risk register.
Systems-level Requirements Document (SRD): provides key insight into how program office articulates the concept of scope so as to identify possible gaps and risks, enables correlation of technical work to technical approach, adequacy of performance measures.
Technical Performance Measures (TPMs): immediate applicability to EVM provides rapid insight into linkage between the key disciplines that anchor a performance measurement system and helps calibrate reasonableness of claimed program performance in ways not otherwise apparent through isolated examination of EVM data.

15 Observations: The original purpose behind the “observations” found in Table 3 was as a precursor to transparency scoring during the first use of a preliminary LCAA effort on a major DoD program. Although the 15 Observations have since been evolved, adjusted and incorporated directly into the quantitative Gate 3 analysis, the preservation of the linkage to Transparency remains. Table 5 shows suggested questions for CAMs based on the EVM data results, which is a recommended approach should the opportunity become available during Gate 2 to communicate directly with program office staff. The results from this table could warrant further modifications to Transparency Scores generated using the checklist in terms of Organization and Planning, Compliance, Surveillance, Data Visibility, and Analysis.

TABLE 5
Observations and Resulting Transparency Score Input

| Obser- | Summary | | Frequency of Occurrence and |
|---|---|---|---|
| vation | Description | Questions for CAM (or G-CAM) | Resultant T-Score Input |
| 1 | Performance | Is there a rationale for the accounting lag? | If this occurs in any control account, |
| | credited with $0 | Do you agree with the performance taken? | recommend component T-scores reduced in: |
| | expenditures | This says you have accomplished work but it didn't cost anything to do it - | Discipline: Organization and Planning |
| | | help me understand how this could be done. | Discipline: Surveillance |
| | | | Discipline: Compliance |
| 2 | Performance | Do you agree with the performance taken? | If this occurs in any control account, |
| | credited with | How does this impact the schedule? | recommend component T-scores reduced in: |
| | no budget | It would appear that someone used the wrong charge number or your | Discipline: Organization and Planning |
| | | plan has not been updated - please explain otherwise how performance | Discipline: Compliance |
| | | can be taken with no money available. | Discipline: Surveillance |
| 3 | No Budget | Do you agree with the re-plan of the work? | If this occurs in any control account, |
| | | If actuals have accrued, was this move allowed by the EVMS system | recommend component T-scores reduced in: |
| | | description? | Discipline: Organization and Planning |
| | | Your control account has no budget. Does this really exist or is there a | Discipline: Compliance |
| | | miscommunication between you and the person who runs the EVM | Discipline: Surveillance |
| | | engine? | |
| 4 | Percent Complete | Do you agree with the performance taken to date? | If this occurs in any control account, |
| | is higher than | Is this performance consistent with the progress made against the | recommend component T-scores reduced in: |
| | the LRE “spent” | TPMs? | Discipline: Surveillance |
| | by more than 5% | What you are saying is what you have accomplished so far does not | If this occurs in >3% of control accounts, |
| | | quite line up with what you say you have left to do. Which is more | recommend additional component T-scores |
| | | accurate: what you have accomplished or what you say is left? | reduced in: |
| | | | Discipline: Analysis |
| | | | Linkage: Technical |
| 5 | Percentage of LRE | Is the future work planned appropriately? | If this occurs in any control account, |
| | representing | Is the future work resourced properly? | recommend component T-scores reduced in: |
| | completed work | Is there an opportunity that should be captured? | Discipline: Surveillance |
| | is greater than | How often do you update your own revised estimate to complete and | If this occurs in >3% of control accounts, |
| | % Complete | what is the current one based upon? It doesn't line up with what you | recommend additional component T-scores |
| | | have accomplished so far? Are you expecting a change in future work | reduced in: |
| | | efficiency? | Discipline: Analysis |
| | | | Linkage: Risk |
| | | | Linkage: Technical |
| 6 | Budget Remaining | Is the future work planned appropriately? | If this occurs in any control account, |
| | is less than | Is the future work resourced properly? | recommend component T-scores reduced in: |
| | Work Remaining | Is there a technical risk? | Discipline: Surveillance |
| | | Based on what you have done so far and what it has cost you, it doesn't | If this occurs in >3% of control accounts, |
| | | look like you have enough budget. Are you doing unplanned, in scope | recommend additional component T-scores |
| | | work that might require MR? Do you need to revise your estimate to | reduced in: |
| | | show an overrun? | Discipline: Analysis |
| | | | Linkage: Risk |
| 7 | Budget Remaining | Is the future work realistically planned and resourced? | If this occurs in any control account, |
| | is greater than | Is there a risk or opportunity that should be captured? | recommend component T-scores reduced in: |
| | the Work | You have more budget remaining than you need for the work remaining. | Discipline: Surveillance |
| | Remaining by | How much of an opportunity do you expect to capture and where is that | If this occurs in >3% of control accounts, |
| | 5% or more | going to be recorded? Are you planning to transfer budget back to the | recommend additional component T-scores |
| | | PM for overall management reserve use? | reduced in: |
| | | | Discipline: Analysis |
| | | | Linkage: Risk |
| 8 | LRE is less than | Is the future work planned appropriately? | If this occurs in any control account, |
| | the (calculated) | Is the future work resourced property? | recommend component T-scores reduced in: |
| | Independent | Is there a technical risk? | Discipline: Surveillance |
| | Estimate At | The typical EVM prediction formulas we use are showing, based on what | If this occurs in >3% of control accounts, |
| | Complete (IEAC1), | you have done so far, that you are going to overrun. How is your LRE | recommend additional component T-scores |
| | where Actuals are | derived and what confidence do you have in it? | reduced in: |
| | added to the | | Discipline: Analysis |
| | (Remaining Work x | | Linkage: Risk |
| | the current CPI) | | |
| 9 | LRE is higher | What has increased in the future effort? | If this occurs in any control account, |
| | than the IEAC1 | Is the future work realistically planned and resourced? | recommend component T-scores reduced in: |
| | by more than 5% | Is there a risk or opportunity that should be captured? | Discipline: Surveillance |
| | | Your LRE is much more conservative than even what the EVM formulas | If this occurs in >3% of control accounts, |
| | | are predicting. That is unusual. Are you taking into account more work | recommend additional component T-scores |
| | | than your plan currently shows? Do you expect to be more inefficient? | reduced in: |
| | | Why? | Discipline: Analysis |
| | | | Linkage: Risk |
| 10 | Current CPI is | Do you agree with the performance taken to date? | Discipline: Analysis |
| | greater than 1.5 | Is this performance consistent with the progress made against the | Linkage: Risk |
| | or for every $1 | TPMs? | Discipline: Data Visibility |
| | spent more than | Is the future work realistically planned and resourced? | |
| | $1.50 worth of | Having such a positive cost efficiency is very unusual. Assuming this is | |
| | work is being | not an understaffed LOE EV technique account, how realistic is your | |
| | accomplished | plan? Did you capture an opportunity that is not recorded? Are you | |
| | | going to take 50% of your budget and give it back to the PM for | |
| | | management reserve? | |
| 11 | No performance | Is this a WBS element where work is to occur in the future? | If this occurs in any control account, |
| | has been taken | How does this impact the schedule? | recommend component T-scores reduced in: |
| | and $0 have | The EVM data indicates this is delayed because you haven't taken | Discipline: Surveillance |
| | been spent | performance and no money has been spent. Is this accurate or has work | If this occurs in >3% of control accounts, |
| | | been accomplished and there are lags in accounting? And does this | recommend additional component T-scores |
| | | agree with what the IMS says? | reduced in: |
| | | | Discipline: Analysis |
| | | | Discipline: Data Visibility |
| 12 | Cost performance | Was a risk realized? | If this occurs in any control account, |
| | indicator is | If yes, was the risk identified? When? | recommend component T-scores reduced in: |
| | less than .9 or | Your cost efficiency is low, which means you are going to overrun | Discipline: Surveillance |
| | for every $1 | significantly if something doesn't change. What has happened since | If this occurs in >3% of control accounts, |
| | being spent less | work started that is not the same as what you planned? And have you | recommend additional component T-scores |
| | than $0.90 | translated this predicted overrun into the risk register? | reduced in: |
| | worth of work | | Discipline: Analysis |
| | is being | | Linkage: Risk |
| | accomplished | | Discipline: Data Visibility |
| 13 | Actual | Given the actuals to date already exceed the LRE, how is the future work | If this occurs in any control account, |
| | expenditures | being addressed? | recommend component T-scores reduced in: |
| | to date have | Do you agree with the schedule and resources allocated to the future | Discipline: Surveillance |
| | already | work? | If this occurs in >3% of control accounts, |
| | exceeded the LRE | Is the performance taken to date consistent with the progress made | recommend additional component T-scores |
| | | against the TPMs? | reduced in: |
| | | You have already spent more money that you have forecasted it will cost | Discipline: Analysis |
| | | at completion. Clearly something is wrong here. Has there been | Linkage: Risk |
| | | significant unauthorized use of your CA charge number by others or is | Discipline: Data Visibility |
| | | this a case where you have not updated your estimate? And what | |
| | | conditions led you to wait this long to update the estimate? Are we the | |
| | | only ones who have asked this question? | |
| 14 | The To Complete | What has increased in the future effort? | If this occurs in any control account, |
| | Performance | Is the future work realistically planned and resourced? | recommend component T-scores reduced in: |
| | Index (TCPI) | Is there a risk or opportunity that should be captured? | Discipline: Surveillance |
| | is higher than | EVM and acquisition history tells us there is almost no way you are going | If this occurs in >3% of control accounts, |
| | the current | to change your cost efficiency overnight to achieve your LRE. Are you | recommend additional component T-scores |
| | CPI sum by | absolutely sure your estimate is accurate? If so, what is significantly | reduced in: |
| | more than 5% | different about the future work that leads you to believe you will manage | Discipline: Analysis |
| | | it even more efficiently than previously? | Linkage: Risk |
| 15 | The TCPI is less | Is the future work planned appropriately? | If this occurs in any control account, |
| | than the current | Is the future work resourced property? | recommend component T-scores reduced in: |
| | CPI sum by | Is there a technical risk? | Discipline: Surveillance |
| | more than 5% | Your estimate tells us that you are planning to be inefficient in your work | If this occurs in >3% of control accounts, |
| | | from here forwards? Why are you planning to be so inefficient? What | recommend additional component T-scores |
| | | risks are embedded in this plan going forward that aren't in the risk | reduced in: |
| | | register? If there are no risks, then why not challenge yourself to operate | Discipline: Data Visibility |
| | | at something closer to the efficiency you can currently achieve? | Linkage: Risk |

Schedule Validity and SRA: Table 6 shows a summary related to the schedule validity checks associated with Gate 1. The IMP and IMP artifacts receive additional attention due to their critical role played in establishing the program architecture and dynamic model of program execution. The results from this table could warrant further modifications to Transparency Scores generated using the checklist in terms of Organization and Planning, Compliance, Surveillance, Data Visibility, and Analysis.

TABLE 6
Gate 1 Schedule Transparency Score Modifiers

| | GATE 1 TRANSPARENCY SCORE MODIFIERS | | | | |
|---|---|---|---|---|---|
| | DEDUCTION TO | | | | |
| | ORGANIZATION | DEDUCTION TO | DEDUCTION TO | DEDUCTION TO | DEDUCTION TO |
| | AND PLANNING | COMPLIANCE | SURVEILLANCE | DATA VISIBILITY | ANALYSIS |
| QUALITY OF | Significant | Significant | Significant | | |
| INTEGRATED MASTER | deduction if IMP | deduction if IMP | deduction if IMP | | |
| PLAN | missing or of | missing or of | missing or of | | |
| | poor quality | poor quality | poor quality | | |
| VALIDITY CHECK: | Significant | Significant | Significant | Significant | Significant |
| Quality of the Schedule | deduction if “red” | deduction if “red” | deduction if “red” | deduction if “red” | deduction if “red” |
| Plan | ratings occur in | ratings occur in | ratings occur in | ratings occur in | ratings occur in |
| | greater than 25% | greater than 25% | greater than 25% | greater than 25% | greater than 25% |
| | of observations | of observations | of observations | of observations | of observations |
| | and/or yellow in | and/or yellow in | and/or yellow in | and/or yellow in | and/or yellow in |
| | greater than 50% | greater than 50% | greater than 50% | greater than 50% | greater than 50% |
| | of observations | of observations | of observations | of observations | of observations |
| SCHEDULE RISK | | | Significant | Significant | Significant |
| ANALYSIS (organically | | | deduction if SRA | deduction if SRA | deduction if SRA |
| developed by program) | | | missing or of | missing or of | missing or of |
| | | | poor quality | poor quality | poor quality |

Reinforce Quantitative Alignment with “Technical”

The LCAA process helps management effectively manage programs by providing leaders needed insight into potential future states that allow management to take action before problems are realized. Technical leading indicators, in particular, use an approach that draws on trend information to allow for predictive analysis (i.e. they are forward looking) and enable easier mating with other CREST elements such as EVM and schedule. Leading indicators typically involve use of empirical data to set planned targets and thresholds. Where organizations lack this data, expert opinion may be used as a proxy to establish initial targets and thresholds until a good historical base of information can be collected.

Leading indicators of technical performance evaluate the effectiveness of a how a specific activity is applied on a program in a manner that provides information about impacts that are likely to affect the system performance objectives. A leading indicator may be an individual measure, or collection of measures, that are predictive of future system performance before the performance is realized. Leading indicators aid leadership in delivering value to customers and end users, while assisting in taking interventions and actions to avoid rework and wasted effort. They also potentially provide a linkage between system engineering and EVM.

Unfortunately, this linkage does not occur very often but is usually the easiest to establish and repair, or at least accommodate in analysis of performance and risk. It is therefore explicitly included as part of Gate 2 per Table 7.

TABLE 7
Technical Leading Indicators Used in Gate 2

| | | Examples of | Examples of |
|---|---|---|---|
| Technical Leading | Contribution to | Quantitative | Derived |
| Indicator | LCAA | Measurements Required | Measurements |
| REQUIREMENTS | Indicates how well the | Number of: requirements, | # requirements approved, % |
| | system is maturing as | requirements associated with | requirements growth, # |
| | compared to expectations. | MOE, MOP, TPM, TBDs, TBRs, | TBD/TBR closure per plan, |
| | | defects, changes | estimated impact of |
| | | | changes, defect profile, |
| | | | defect density, cycle time for |
| | | | requirements changes |
| SYSTEM | Helps analyst understand if | Number of: requests for change, | Approval rates, closure |
| DEFINITION | changes are being made in | changes by priority, changes by | rates, cycle times, priority |
| CHANGE BACKLOG | a timely manner | cause, changes by association | density |
| | | with given MOE, MOP, TPM, | |
| | | Timelines (start-implement- | |
| | | incorporate-approve) | |
| INTERFACE | Helps analyst evaluate risk | Number of interface-related: | # interfaces approved, % |
| | associated with interface | requirements, TBDs, TBRs, | interface growth, # TBD/TBR |
| | development and maturity | defects, changes | closure per plan, estimated |
| | | | impact of interface changes, |
| | | | defect profile, defect density, |
| | | | cycle time for interface |
| | | | changes |
| REQUIREMENT | Helps analyst understand if | Number of: requirements, | Requirements validation |
| VALIDATION | requirements are being | planned validated requirements, | rate; Percent requirements |
| | validated with applicable | actual validated requirements. | validated |
| | stakeholders appropriate to | Time expended for validation | |
| | the level of requirement. | activities. Also categorize by | |
| | | MOE, MOP, TPM. | |
| REQUIREMENT | Helps analyst understand if | Number of: requirements, | Requirements verification |
| VERIFICATION | requirements are being | planned verified requirements, | rate; Percent requirements |
| | verified appropriate to the | actual verified requirements. | verified |
| | level of requirement. | Time expended for verification | |
| | | activities. Also categorize by | |
| | | MOE, MOP, TPM. | |
| WORK PRODUCT | Evaluates work progress | Number of: work products, | Approval rate, distribution of |
| APPROVAL | and approval efficiency | approvals, work products per | dispositions, approval rate |
| | | approval decision, submitted | performance |
| | | work products by type | |
| TECHNICAL/DESIGN | Helps analyst assess | Number of: action items, action | Closure rates, action item |
| REVIEW ACTION | progress in closing | items per disposition category, | closure performance, |
| CLOSURE | significant action items from | action items per priority, action | variance from thresholds |
| | technical reviews | items per event/review, impact | |
| | | for each action item | |
| TECHNOLOGY | Helps analyst compare | Number of: TRL-specific criteria | Component TRL, Subsystem |
| MATURITY | maturity of key components, | met, remaining, expected time | TRL, element TRL, System |
| | subsystems, elements to | to specific maturity level, actual | TRL, Technology opportunity |
| | expectations laid out in | time to maturity, expected cost | exposure, technology |
| | baseline and risk | of maturation, actual cost of | obsolescence exposure |
| | assumptions | maturation, technology | |
| | | opportunity candidates, | |
| | | technology obsolescence | |
| | | candidates | |
| TECHNICAL RISK | Helps analyst gauge | Number of: risk handling | Percentage of risk handling |
| HANDLING | effectiveness of the risk | actions, handling actions by | actions closed on time, |
| | management process | disposition, associated risk | percent overdue, percent of |
| | | levels, planned versus actual | risks meeting handling |
| | | handling date starts, | expectations |
| | | completion, Baseline Execution | |
| | | Index (IMS metric) in terms of | |
| | | risk handling activities | |
| TECHNICAL | Helps analyst understand | Total: hours planned, actual | Technical effort staffing, |
| STAFFING AND | adequacy of technical effort | hours, hours by labor category | variance; efficiency by labor |
| SKILLS | and dynamics of actual | planned, hours by labor | category |
| | staffing mix | category actual, hours planned | |
| | | by task type, actual hours by | |
| | | task type | |
| TECHNICAL | Enables the analyst to | Planned values for MOE, MOP, | Delta performance (planned |
| PERFORMANCE | understand the current | TPM, Actual values for MOE, | versus actual); delta |
| | performance status, | MOP, TPM | performance to thresholds, |
| | projections and associated | | objectives |
| | risk | | |

### Execute Transparency Scoring for Discipline:

Discipline scoring is accomplished using the detailed checklist found in the appendices. The scoring methodology is designed to be relatively simple so that it is not a burden to conduct and can be reasonably interpreted and is repeatable. The approach, generally speaking, is for the analysts to compare the expectations (conditions/criteria) described with the actual program evidence available.
If the evidence strongly supports the expectations as described, score “2”
If there is little or no evidence that the expectations are met, score “1”
Any other condition, score “1”
Modify score as appropriate based on additional Gate 1—related inputs (15 observations, schedule validity)

TABLE 8
Risk Discipline Transparency Assessment

| | Risk Discipline T-Score ® |
|---|---|
| | Meets |
| | Expectations—Score = 2 |
| | Some Gaps—Score = 1 |
| | Clearly Absent—Score = 0 |
| Organization & Planning: Program planning | 2 |
| and/or system process documents clearly | |
| identify a responsible organization and a | |
| Point of Contact for Risk Management. | |
| Documentation clearly supports that the | |
| program has a risk-adjusted baseline | |
| Compliance: Risk artifacts (plans, register, | 2 |
| etc.) reflect a process that is continual, | |
| timely and clearly includes identification, | |
| analysis, handling and monitoring. WBS is | |
| compliant with WBS (DI-MGMT-81334C) | |
| in that lower levels of WBS visibility are | |
| accorded to higher risk areas of the program. | |

The discipline transparency assessment helps gauge the degree to which a PM's decision loop is open, which translates to the degree to which the PM can recognize change. It examines the relative quality of the major CREST functions (Cost, Risk, EVM, Schedule, and Technical) in terms of Organization and Planning, Compliance, Surveillance, Data Visibility, Analysis and Forecasting. This is summarized in Table 9.

TABLE 9
Discipline Transparency Assessment

| | COST | RISK | EVM | SCHED | TECH |
|---|---|---|---|---|---|
| ORGANIZATION | Clearly defined | Clearly defined | Consistency, | IMP trace to | Lead engineer, |
| and PLANNING | central Cost ORG, | program risk ORG | product orientation | IMS | SE planning and |
| | POC and | plus risk adjusted | and resource | | event based |
| | interdisciplinary | baseline | loading | | review |
| | approach | | | | |
| COMPLIANCE | Cost CDRL (e.g. | Artifacts reflect | CPR CDRL and | IMS CDRL and | SE and CM |
| | CFSR, CCDR, | dynamic updating | WBS compliance; | WBS | process execution |
| | SRDR) and WBS | and WBS | EVM consistent | compliance | compliant with SE |
| | compliance | dictionary | with NDIA PMSC | | plan; WBS |
| | | addresses risk | guidance | | compliant |
| SURVEILLANCE | Quality control | Risk Artifact and | Risk-based | Schedule | Technical process |
| | process in place and | risk process QC | surveillance | construction QC | and artifact quality |
| | executed for cost | process in place | process in place | process in place | control process in |
| | estimating derivation | and executed | and executed by | and executed | place and |
| | and results | | independent ORG | | executed |
| DATA VISIBILITY | Assumptions and | CA-level or lower | CA level visibility at | Vertical | Vertical |
| | WBS traceability to | risk visibility and | all times and lower | traceability from | traceability MOE |
| | estimates | WBS correlation | visibility when | milestones to | to MOP to KPP to |
| | documented and | from IBR forward | required for root | detailed | TPM |
| | traced | | cause | activities | |
| ANALYSIS & | Regularly updated | Quantified risk | Monthly CA | Monthly | Periodic TPM |
| FORECASTING | estimates using | impacts derived in | analysis include | schedule | analysis, trend |
| | program performance | terms of cost, | realism of EAC and | analysis and | analysis and |
| | data as inputs | schedule and | schedule | periodic SRA | performance |
| | | performance via | | | forecasting |
| | | CRA and SRA | | | |

### Execute Transparency Scoring for Linkage:

Linkage scoring is accomplished using the detailed checklist found in Appendix A.

The scoring methodology is designed to be relatively simple so that it is not a burden to conduct and can be reasonably interpreted and is repeatable. The approach, generally speaking, is for the analysts to compare the expectations (conditions/criteria) described with the actual program evidence available.
If the evidence strongly supports the expectations as described, score “2”
If there is little or no evidence that the expectations are met, score “1”
Any other condition, score “1”
Modify score as appropriate based on additional Gate 1—related inputs (15 observations, schedule validity)

The linkage transparency assessment looks at the planning and execution aspects of cost, risk, budget, schedule, engineering and the WBS upon which the disciplines are grounded. Here the objective is to assess how the management system “pulls” information across disciplines and translates it for effective management use as manifest in the planning documents and reported artifacts. There are some important differences in linkage scoring as compared to discipline scoring noted above that are evident in the summary table below:
The most important difference is that the vertical and horizontal axes are identical when looking at each CREST discipline in relation to the other disciplines.
Another important difference is the explicit inclusion of the work breakdown structure (WBS) because the WBS serves as the most critical “common denominator” for all CREST disciplines.
This table is also color-coded such that there is a purple region and a white region.

The purple region reflects planning and the white represents execution

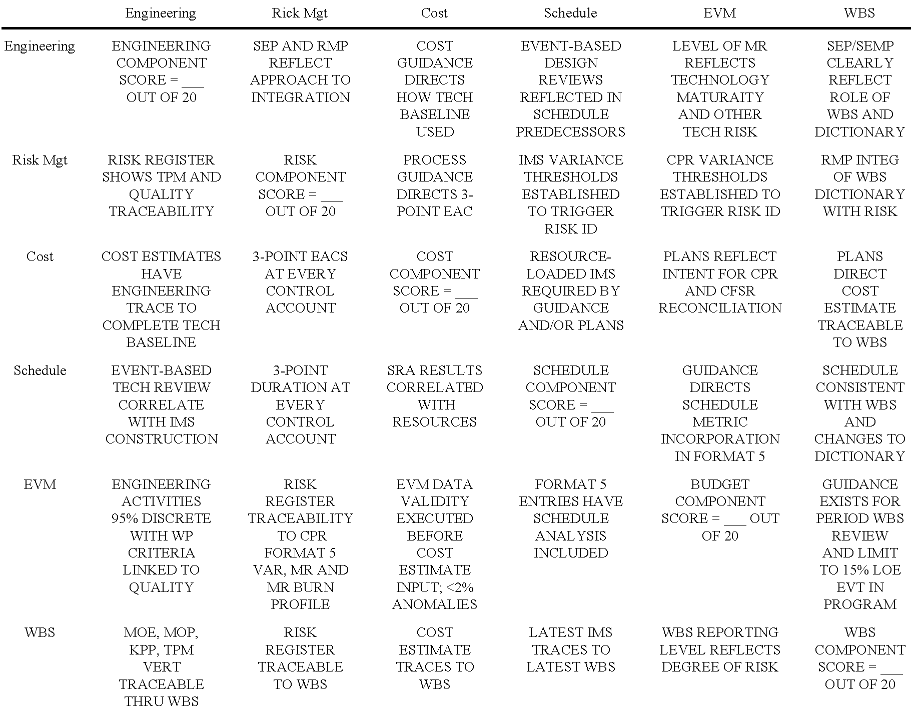

### Useful, Concrete and Tangible Results of Gate 2 Transparency

In a sense, Transparency discerns the degree to which programs are “checking the box” in terms of management system design and implementation (e.g., write a risk management plan “just to have one” and to meet a requirement, but it sits on the shelf unused) as opposed to tapping into the management system to support leadership decision processes. Transparency target processes and artifacts that can help shape the context for PM leadership and decision-making in two key ways: First, transparency serves as a relative measure of the management system's ability to reflect how a program is actually performing and to predict future results. Second, transparency serves as a practical way to articulate relationships among program performance measurement and reporting, management process execution, and linkage among the program management support disciplines. Transparency helps PMs determine the extent to which their management systems are performing in terms of providing reliable and useful information, and the derivation of actionable information provides PM's the information needed to drive positive change by proactively engaging the program team

Transparency Scores are not absolute measurements; to a great degree, transparency is in the eyes of the beholder thus, which makes biases and frames of reference is very critical considerations. For example, the scoring criteria tends to be biased towards use of a product-oriented WBS, existence of a well-constructed IMP and IMS, and assumes relatively rare occurrences of unexplained data anomalies generated by the EVM engine. Programs not meeting these basic conditions will tend to score poorly. This bias is based on the authors' experience that the product-oriented WBS, IMP, IMS and reasonable EVM data are key ingredients to successful management system design because of their key role in linking together program management support disciplines.

A poor Transparency Score does not automatically mean a program is failing; it could mean, among other things: (1) that a management system will be less likely to indicate that something is wrong, and/or (2) that subjective measures and guesswork tend to outweigh objective measures and quantitative predictions in periodic reporting. Outstanding leaders can find themselves at the helm of a management system with abysmal transparency. Such a condition does not automatically indicate failure; it merely serves to make the PM's daily job harder than it has to be. A poor score also indicates that the criteria for ultimate success are less discernable than they otherwise would be. A simple metaphor helps explain what Transparency Scores mean for a program: a program with poor transparency is like driving a car at night on a winding country road with the headlights off. The car may be running fine, but the driver has no idea if there is a tree ahead. In other words, the program's ability to execute risks identification and handling is poor and adverse events—to include major breaches of cost and schedule targets—can occur with little or no warning from the management system.

Over time, Transparency Scores should reflect changing program conditions. As a general rule, composite matrix movement down and/or to the right over time is a reflection of sustained process improvement. It may take a program months or years to improve its transparency score and move into an adjacent shaded region. Since movement across a transparency score matrix takes time, it is generally of little value, except perhaps in high risk programs undergoing significant change, to do monthly transparency scoring. A quarterly basis for detailed transparency scoring will usually suffice to discern changes.

Currently performed transparency research and analysis indicates that programs scoring in the black, red, or yellow region will tend to be less capable of avoiding risks and capturing opportunities than programs scoring in the green or blue region.

### The Composite Transparency Score Matrix

Scores derived from the detailed checklist-based review are summarized in a Transparency Score Summary Matrix (Table 10) and then normalized in order to be accommodated onto the Composite Transparency Score Matrix (Table 11).

TABLE 10
Transparency Scoring Summary Matrix

| | COST | RISK | EVM | SCHED | TECH | WBS | TOTAL |
|---|---|---|---|---|---|---|---|
| ORGANI- | 2 | 1 | 1 | 0 | 2 | | 6 |
| ZATION | | | | | | | |
| COMPLI- | 2 | 0 | 0 | 2 | 2 | | 4 |
| ANCE | | | | | | | |
| SURVEIL- | 1 | 0 | 0 | 0 | 2 | | 3 |
| LANCE | | | | | | | |
| ANALYSIS | 0 | 1 | 1 | 1 | 2 | | 5 |
| FORE- | 1 | 0 | 1 | 0 | 1 | | 3 |
| CASTING | | | | | | | |
| TOTAL | 6 | 2 | 3 | 3 | 9 | | 21 |
| DISCI- | | | | | | | |
| PLINE | | | | | | | |
| LINKAGE | 2 | 4 | 4 | 4 | 9 | 7 | 30 |
| PLANNING | | | | | | | |
| LINKAGE | 2 | 7 | 3 | 3 | 5 | 7 | 27 |
| EXE- | | | | | | | |
| CUTION | | | | | | | |
| TOTAL | 4 | 11 | 7 | 7 | 13 | 14 | 56 |
| LINKAGE | | | | | | | |

| | |
|---|---|
| NORMALIZED TOTAL | NORMALIZED TOTAL LINKAGE SCORE |
| DISCIPLINE SCORE | 56/24 = 2.3 |
| 21/10 = 2.1 | |

The discipline and linkage score are then recorded onto the Composite Transparency Score Matrix as shown in Table 11.

TABLE 11
Composite Data Transparency Score Matrix

| Composite Data | 0-1 Low Linkage | | | | 4-5 High Linkage |
|---|---|---|---|---|---|
| Transparency | (slow OODA loop | 1-2 Moderate- | 2-3 Moderate | 3-4 Moderate- | (fast OODA loop |
| Score Matrix | speed) | Low Linkage | Linkage | High Linkage | speed) |
| 0-1 Low | BLACK | RED | RED | YELLOW | YELLOW |
| Discipline | | | | | |
| (closed OODA | | | | | |
| loop) | | | | | |
| 1-2 Moderate- | RED | RED | YELLOW | YELLOW | GREEN |
| Low Discipline | | | | | |
| 2-3 Moderate | RED | YELLOW | YELLOW | GREEN | GREEN |
| Discipline | | | | | |
| 3-4 Moderate- | YELLOW | YELLOW | GREEN | GREEN | BLUE |
| High Discipline | | | | | |
| 4-5 Excellent | YELLOW | GREEN | GREEN | BLUE | BLUE |
| Discipline (open | | | | | |
| OODA loop) | | | | | |

Each color-coded region of the preceding table is defined in Table 12. The regions characterize the overall transparency of the program, and it will be noted (referring to the arrow on the right-hand side) that these regions also reflect the relative ability of management system products to support quantitative analysis.

TABLE 12
Composite Data Transparency Key

| | | |
|---|---|---|
| BLK RED YEL GRE BLU | Black Hole - This represents the worst possible transparency conditions. The program management system is either broken or inoperative and it is very possible that breach conditions are imminent and the program may not be able to recognize it. Poor Data Transparency - Program reporting does not reflect actual conditions. Significant process issues exist within the management system and require immediate intervention and aggressive oversight. Forecasting is likely to be unrealistically optimistic. It is unlikely the program will be able to consistently minimize risks and capture opportunities. Breach conditions will be reported with little or no warning Marginal Data Transparency - Program reporting is not consistently a reflection of actual conditions and is probably optimistic. Program requires aggressive oversight. Breach conditions will occur with minimal warning. Program has limited capability to avoid risks and capture opportunities Average Data Transparency - Program reporting is usually a reflection of actual conditions. The program demonstrates capabilities to minimize risks and capture opportunities. Some demonstrate management strengths exist, but system weaknesses will require periodic monitoring to ensure quality remains the same. Breach conditions will occur with some warning, usually in time for corrective actions to have a positive impact. Excellent Transparency - Program reporting is sufficiently predictive and highly reliable. The program has self- sustaining surveillance. Data quality and accuracy is ensured over the long term. The program management system should be reviewed for inclusion into best practice documentation | 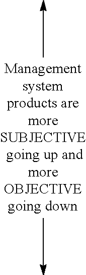 |

It is important to re-emphasize that Transparency is not an absolute measurement. To a great degree, transparency is subjective, so the frame of reference and potential for bias are very critical to consider. The example showed how easily transparency scoring can be favorably biased with lenient scoring criteria. The transparency matrix is most effective when used as a comparative tool, with scores used in a relative sense to one another (assuming care is taken in frame of reference). For example, a PM may want to compare various IPTs or CAs in terms of transparency. A PM can also measure the overall program over time to spot trends in transparency.

Over time, Transparency Scores should reflect changing program conditions. As a general rule, movement in Table 11 down and/or to the right over time is a reflection of sustained process improvement. It may take a program months or years to improve its transparency score and move into an adjacent shaded region. Since movement across a transparency score matrix takes time, it is generally of little value, except perhaps in high risk programs undergoing significant change, to do monthly transparency scoring. A quarterly basis for detailed transparency scoring will usually suffice to discern changes.

Currently performed transparency research and analysis indicates that programs scoring in the black, red, or yellow region will tend to be less capable of avoiding risks and capturing opportunities than programs scoring in the green or blue region.

Transparency measurements target processes and artifacts that can help shape the context for PM decision-making. The purpose of measuring data transparency is to provide two forms of actionable information to the program management team. First, transparency serves as a relative measure of the management system's ability to reflect how a program is actually performing and to predict future results. Second, transparency serves as a practical way to articulate relationships among program performance reporting, management process execution, quality assurance and EVM surveillance. Transparency helps PMs determine the extent to which their management systems are performing in terms of providing reliable and useful information.

At this time, there is neither an intention nor a demonstrated capability to directly integrate Transparency Score results into the quantified cost estimate. Instead, this scoring is used to help set expectations for the analysts using the data as well as inform the program manager how effective the management system is performing. A great degree of further research and data analysis is required in order to begin to explore quantified relationships between Transparency Scoring and estimates to complete. For now, this scoring serves very effectively as a disciplined, but subjective assessment of the management system dynamics.

2.2 Transparency and Decision Support

Transparency analysis targets the PM's Observe-Orient-Decide-Act (OODA) decision loop. Decision loops are applicable to all levels of management, but attention is focused on the PM. The OODA loop, developed by Colonel John Boyd, USAF, refers to a model of decision-making that combines theoretical constructs from biology, physics, mathematics and thermodynamics [Boyd]. A summary diagram is shown on FIG. 3B.

FIG. 3B depicts an exemplary embodiment of an exemplary observe, orient, decide and act loop diagram 350, according to an exemplary embodiment of the present invention.

Two key characteristics of OODA loops are openness and speed. The more open the PM loop is, the more the PM can assimilate information from a wide variety of sources, which means the PM will be more prepared to recognize change. The speed through which a PM progresses through a complete loop reflects relative ability to anticipate change. Openness and Speed are driven largely by the Observation and Orientation steps, respectively, and these are the steps over which the management system in place wields the largest influence.

Applied to a PM's decision process in a simplistic sense, the loop begins in Observation when information is “pushed” to the PM or “pulled” by the PM. The robustness of the management system and the quality of information generated is a key enabler during this step. Another important consideration is the degree to which the PM utilizes the information provided by management system versus that from other sources. For example, what inputs does the PM use on a daily basis to figure out how the program is progressing? Some PMs rely upon talking to their line managers to gauge their individual progress and then “in their head” figure out what that means for the program. If that dialogue does not include, for example, any outputs from the program's IMS then clearly something is awry. Sometimes that is because the PM does not understand what a scheduling tool can do, other times there might not be trust or confidence in the schedule or how it was derived. For whatever reason in this case, a key part of the management system has been made irrelevant and therefore not part of the manager's decision cycle.

The T-Score™ process examines the Observation step by assessing the quality of artifacts designed for management use. It determines whether artifacts comply with the guidance governing their construction and includes an assessment of the relevant discipline(s) charged with producing the artifact. The EVMS implementation itself and the artifacts (e.g., the CPR and IMS) that are produced by that implementation can be looked at.

The Orientation step is shaped by a number of factors, not the least of which is the PM's own personal, professional and cultural background. It is this step where the PM comprehends what the management system has yielded during the Observation phase. Although this step is shaped by many factors unique to the PM, the management system's ability to interpret information and to help explain what it produces in a way that is useful to the PM cannot be overlooked. Although the last two steps in the process appear relatively straightforward, (i.e., the PM decides what action to take and then executes the action) it is important to note that the Decision and Action steps hinge entirely on the results of the Observation and Orientation steps.

The T-Score™ development process examines the Orientation step by assessing the ability of the planning and execution functions to produce information that reflects a linkage of the key PM support disciplines. Does the EVM data reflect technical progress? Is schedule variance (SV) explained in terms of EVM and an analysis of the scheduling tool? Are known risks quantified? Can the amount of MR be traced to WBS elements and to the risk register? Is schedule analysis considered a standard part of the monthly PMR? Is it clear to what degree management decisions reflect what the management system is reporting?

A key assumption in T-Scoring™ is that a critical factor in determining the importance of a management system is its degree of use by the PM to help recognize and anticipate changes to the conditions that might affect the program. Poor T-Scores™ do not automatically mean a program is failing. Poor T-Scores™ mean that a management system will not be able to indicate that something is wrong. Poor T-Scores™ imply that subjective measures and guesswork tend to outweigh objective measures and quantitative predictions in periodic reporting. Although T-Scoring™ cannot measure subjective factors such as leadership and intuition that does not mean such factors are unimportant. Outstanding leaders can find themselves at the helm of a management system with abysmal transparency. Such a condition does not automatically indicate failure; it merely serves to make the PM's daily job harder than it has to be. Poor T-Scores™ also indicate that the criteria for ultimate success are less clearly discernable than they otherwise would be. A program with poor transparency is like driving in a car at night on a winding country road with the headlights off. The car may be running fine, but the driver has no idea if there is a tree ahead.

In other words, transparency helps gauge the relative ability of a management system to influence the Openness and Speed of an OODA loop. T-scoring™ also finds use in comparing programs, the most common situation being comparisons between prime contractors and their government Program Management Office (PMO) oversight. The OODA Loop Table shows potential ramifications when prime and PMO are assessed in terms of openness and speed of OODA loops.

2.3 Scoring Methodology for Transparency Assessment

The strength of transparency is not necessarily anchored in a one-time assessment of an individual snapshot scoring of a CA, IPT, or program. The real strength—its value to a PM—depends on multiple comparative assessments of similar entities or the same entity over time. The scoring methodology is designed to be relatively simple so that it can be reasonably interpreted and repeatable for use by non SMEs. A series of questions determines whether or not scoring conditions are clearly met. A score of 2 means clearly met. A score of 0 means not clearly met. Any other condition is scored with a 1.

Because the definition of met is subjective and reflective of program maturity, it is possible for those criteria to be defined in a local, adjustable way. It is sometimes feasible, for example, to use “moving” criteria. For example, during an initial assessment, if a PM can produce documentation showing us the WBS, full credit (a T-Score™ of 2.0) may be awarded. On the other hand, if a PM cannot provide the WBS documentation, a T-Score™ of 0 will be awarded. If the PM demonstrates some WBS knowledge, partial credit (a T-Score™ of 1.0) will be awarded. However, 6 months later, the expectation would be that the WBS be product-oriented and consistent with MIL-HDBK 881A to receive full credit. Such an approach helped program staff see readiness scoring as a tool for improvement rather than an assessment. It allowed basic T-Scoring™ concepts to be quickly introduced and used within an immature management system.

However, moving criteria are of little use when you want to compare one program against another, one IPT against another, or the same program over time. Complying with best known practices and maintaining a high standards may be useful. Such an approach ensures analytic rigor in analysis through the remainder of the LCAA process. The following subsections demonstrate consistent T-Scoring™ in terms of quality (i.e., organization, compliance, surveillance, data visibility, analysis and forecasting) for each major CREST component: Cost, Risk, EVM, Schedule, and Technical.

In some cases there will be instances of identical or nearly identical scoring criteria appearing in more than one table. This is intentional because it reflects the linkage between elements and the increased degradation to performance measurement when critical elements are missing or unlinked.

2.4 Discipline (OODA Openness) Transparency Assessment

The discipline transparency assessment helps gauge the degree to which a PM's decision loop is open, which translates to the degree to which the PM can recognize change. It examines the relative quality of each CREST component (i.e., Cost, Risk, EVM, Schedule, and Technical) in terms of the following:
Organization and Planning
Compliance
Surveillance
Data Visibility
Analysis and Forecasting

TABLE 13
Cost Discipline Transparency Assessment

| | |
|---|---|
| | Meets Expectations—Score = 2 |
| | Some Gaps—Score = 1 |
| Cost Discipline T-Score © | Clearly Absent—Score = 0 |

Organization and Planning: Cost estimate team is multidisciplinary to
include financial management, engineering, acquisition, logistics, scheduling
and mathematics. Cost analysts come from centralized sources that support
multiple organizations/programs
Compliance: Cost-related artifacts demonstrate compliance with: CCDR
(DI-FNCL-81565B, 81566B and 81567B); SRDR (DI-MGMT-81739 and
81740); CFSR (DI-MGMT-81468); WBS (DI-MGMT-81334C).
Surveillance: A clearly-documented quality control process is in place and
each cost estimate (initial and updated) is internally assessed (whether by the
program or the centralized cost organization) for being well-documented,
comprehensive, accurate and credible.
Data Visibility: Estimating method and data are documented and reported by
WBS cost element. That same WBS used is identical to or is 100% traceable
to the WBS used by the program for execution.
Analysis and Forecasting: The cost estimate is regularly updated to reflect
all changes to include requirements changes, major milestones, EVM
performance changes, variances, actual technical performance, risk
realization.
Cost Discipline score (Possible score-zero to 10)

TABLE 14
Risk Discipline Transparency Assessment

| | Meets Expectations—Score = 2 |
|---|---|
| | Some Gaps—Score = 1 |
| Risk Discipline T-Score © | Clearly Absent—Score = 0 |
| Organization and Planning: Program planning and/or system process | |
| documents clearly identify a responsible organization and a Point of Contact | |
| for Risk Management. Documentation clearly supports that the program has a | |
| risk-adjusted baseline. | |
| Compliance: Risk artifacts (plans, register, etc.) reflect a process that is | |
| continual, timely, and clearly includes identification, analysis, handling and | |
| monitoring. WBS is compliant with DI-MGMT-81334C so that higher risk | |
| areas of the program are represented by lower levels of the WBS. | |
| Surveillance: There is a clear intent, with supporting documentation, that the | |
| program continually monitor its own management processes to ensure that the | |
| processes are capable of revealing program performance and detecting risks. | |
| Data Visibility: Starting with the IBR, risks are correlated with WBS | |
| elements; CA level visibility and correlation to risks are always available at | |
| the program level. | |
| Analysis and Forecasting: Risks and their root causes are continually | |
| reevaluated; periodic, independent analysis of the EAC and projected finish | |
| date are conducted via cost-risk analysis and schedule-risk analysis, | |
| respectively. | |

Risk Discipline score (Possible score-zero to 10)

TABLE 15
EVM Discipline Transparency Assessment

| | |
|---|---|
| | Meets Expectations—Score = 2 |
| | Some Gaps—Score = 1 |
| EVM Discipline T-Score © | Clearly Absent—Score = 0 |

Organization and Planning: EVMS is implemented at the program level,
not just the contract level. The WBS is product-oriented, and a RAM clearly
enables CA identification and CAM assignment. A resource-loaded schedule
is baselined.
Compliance: Implementation is consistent with the intent of the ANSI/EIA-
748 guidelines. CPR is compliant with DI-MGMT-81466A and WBS is
compliant with DI-MGMT-81334C.
Surveillance: EVMS surveillance is conducted by an organization
independent of the program, consistent with the NDIA PSMC Surveillance
Guide and surveillance priority, and actions are based on assessment of risk.
Data Visibility: CA level visibility of performance in terms of planned value,
actual value and actual costs is always provided. Analysis reflects the level of
reporting detail necessary to ascertain the root cause of variance.
Analysis and Forecasting: Analysis is performed at least monthly and
includes regular assessments of data validity and trends. Schedule variance
analysis includes analysis of critical path. Estimates to complete are
generated below the program level, are regularly assessed for validity and
have clearly-justified best case; most likely and worst case value.
EVM Discipline Score (Possible score-zero to 10)

TABLE 16
Schedule Discipline Transparency Assessment

| | Meets Expectations—Score = 2 |
|---|---|
| | Some Gaps—Score = 1 |
| Schedule Discipline T-Score © | Clearly Absent—Score = 0 |
| Organization and Planning: The program has an IMP that is | |
| consistent with the IMP and IMS Preparation and Use Guide. | |
| Compliance: The program networked schedule is compliant with DI-MGMT- | |
| 81650 and the WBS is compliant with DI-MGMT-81334C. | |
| Surveillance: A clearly-documented quality control process is in place and | |
| periodically executed for scheduling. Qualitative expectations for schedule | |
| quality are documented, and they explicitly include measures such as float, | |
| number of tasks with lags, constraints, frequency of statusing and execution. | |
| Data Visibility: Critical and near-critical path elements are generally | |
| identified and reported with higher priority than non-critical path elements. | |
| CA and lower level visibility to schedule status are always provided in the | |
| CPR when schedule variances are analyzed. | |
| Analysis and Forecasting: Periodic schedule analysis is conducted in | |
| parallel with monthly EVM analysis. Variances are investigated to determine | |
| proximity to critical path. Monte Carlo-based SRA is conducted and updated | |
| at reasonable time intervals (e.g., major milestones). | |

Schedule Discipline score (Possible score-zero to 10)

The technical discipline transparency assessment criteria are provided in Table 17.

TABLE 17
Technical (Engineering) Discipline Transparency Assessment

| | Meets Expectations—Score = 2 |
|---|---|
| | Some Gaps—Score = 1 |
| Technical Discipline T-Score © | Clearly Absent—Score = 0 |
| Organization and Planning: There is a DAWIA Level 3 certified lead SE | |
| POC who has clearly defined roles and responsibilities. A SEMP, that is | |
| traceable to the IMP, establishes event-driven technical reviews with clearly- | |
| defined entry and exit criteria. | |
| Compliance: Technical processes and artifacts are compliant with the | |
| program's SEMP. The SEMP is compliant with the SEP Preparation Guide. | |
| The WBS is consistent with MIL-HDBK-881A. Configuration management, | |
| especially in terms of cost and schedule impact analysis, is performed in a | |
| manner consistent with MIL-HDBK-61. | |
| Surveillance: A technical authority outside the program chain of command | |
| actively ensures proper SE process application and proper training, | |
| qualification, and oversight of SE personnel assigned to the program. | |
| Visibility: Program-level operational performance measures are directly | |
| traceable in terms of the design and development effort from the system level | |
| down through the element, subsystem, assembly, subassembly and component | |
| level. These measures include planned value profiles and milestones. Each | |
| level of TPM is correlated to an equivalent WBS element (for cost and | |
| schedule). | |
| Analysis and Forecasting: Meaningful and quantifiable product and process | |
| attributes are analyzed periodically in terms of cost, schedule, performance | |
| and risk. Trend analysis of these attributes is used to forecast future | |
| performance and potential risk. A disciplined trade study approach clearly | |
| delineates choices as appropriate. | |

Technical Discipline score (Possible score-zero to 10)

Discipline Transparency Score Analysis

The totals for each discipline transparency score are tabulated (Table 18) and then normalized by dividing by the maximum score (i.e., by 10).

TABLE 18
Discipline Transparency Score Analysis

| | |
|---|---|
| Discipline T-Score © Analysis | Discipline Total |

Cost
Risk
EVM
Schedule
Technical
Total

Normalized Total (Total/10) (1-5)

Linkage (OODA Speed) Transparency Assessment

The linkage transparency assessment looks at the planning and execution aspects of cost, risk, budget, schedule, engineering and the WBS upon which the disciplines are grounded. Here the objective is to assess how the management system “pulls” information across disciplines and translates it for effective management use as manifest in the planning documents and reported artifacts.

This directly relates to the “orientation” step of the CODA loop and a gauge of relative speed.

TABLE 19
Cost Linkage Transparency Assessment

| | |
|---|---|
| | Meets Expectations—Score = 2 |
| | Some Gaps—Score = 1 |
| Cost Linkage T-Score © (EAC/CCDR) | Clearly Absent—Score = 0 |

Is the cost estimate technical baseline documented in a Cost Analysis
Requirements Document (CARD) or equivalent, which was developed by an
interdisciplinary team?
Process guidance ensures that risk impacts (derived from the risk register) are
directly incorporated into the EAC.
Results of SRA explicitly answer how resource estimates were developed for
each schedule activity and if those resources will be available when needed.
EVM data validity checks are performed routinely and as part of each
recurring cost estimate. Checks include searching for negative values of
ACWP, BAC, BCWP, BCWS, or EAC; unusually large performance swings
(BCWP) from month to month; BCWP and/or BCWS with no corresponding
ACWP (or vice-versa); BCWP with no BCWS; ACWP that is way above or
below the planned value; no BAC but an EAC or a BAC with no EAC;
ACWP, BCWP or BCWS exceeds EAC; rubber and front-loaded baseline
indicators.
The program cost estimate is updated with actual program costs, is reconciled
with the program budget, and the reasons for changes are directly traceable to
WBS elements.
At a minimum, the technical baseline used for periodic cost estimates includes
TRL of key technologies, detailed technical system and performance
characteristics, a product-oriented WBS, a description of legacy or similar
systems, details of the system test and evaluation plan, safety, training,
logistics support and tracking of changes from the previous baseline.
The program conducts integrated cost-schedule risk analyses and the cost
elements that relate to time uncertainty (labor management, rented facilities,
and escalation) can be linked directly to uncertainty in the schedule.
Risk-based, 3-point estimates of cost at completion (best case, worst case, and
most likely) exist for every CA and the most likely EAC is continually
reassessed to preclude the need for periodic, bottoms-up estimating.
Budgets, especially crossovers into subsequent fiscal years, are assessed and
updated with every change to the performance measurement baseline so as to
ensure validity of out-year planning and not breach annual budgets. Budget
analysis also reflects periodic CPR and CFSR reconciliation.
The latest cost estimate is directly traceable to the current WBS and OBS
being executed by the program.
Cost Linkage score (Possible score-zero to 20)

TABLE 20
Risk Linkage Transparency Assessment

| | |
|---|---|
| | Meets Expectations—Score = 2 |
| | Some Gaps—Score = 1 |
| Risk Linkage T-Score © (CPR Format 5/Risk Register) | Clearly Absent—Score = 0 |

Entries in the program risk register relating to technical risk clearly show
traceability to specific WBS elements and can be traced via measures relating
to engineering process, quality, control and performance.
Process guidance ensures that risk impacts (derived from the risk register) are
directly incorporated into the EAC.
A schedule reserve has been established for risk handling. Additionally, there
are documented metric thresholds established in the IMS including float and
Baseline Execution Index that, when breached, automatically trigger risk
identification actions. These are subsequently documented in the program
risk register.
Variance thresholds established in CPR (e.g., CV %, SV %, CPI vs. TCPI) that
automatically trigger risk identification actions that are documented in the
program risk register.
Risk Management Plan clearly reflects the role of a product WBS in risk
planning and all program Risk Register entries are traceable to lowest relevant
WBS element. As required, the WBS is expanded to lower levels in areas
where there are elevated risk levels.
The SEMP and Risk Management Plan clearly identify the importance of
integrating risk management and systems engineering, and also describe how
the integration is to occur in a repeatable fashion.
Risk-based, 3-point estimates of cost at completion (best case, worst case, and
most likely) exist for every CA and the most likely EAC is continually
reassessed to prevent the need for periodic, bottoms-up estimating.
3-point estimates (best case, worst case, and most likely) exist for every CA in
terms of time. The rationale for each schedule risk is documented in the
program risk register along with a description of how this CA risk correlates
with other CAs. This is reassessed and updated regularly and used as a direct
feed into periodic SRAs.
Risk register entries quantify cost and schedule impacts and are directly
traceable to at least a portion of MR (cost) and Schedule Reserve (time), and
enable the program to generate a planned MR burn profile.
No later than the IBR, all risks in the program risk register are traceable to the
lowest possible WBS element, preferably each CA
Risk Linkage score (Possible score-zero to 20)

TABLE 21
EVM Linkage Transparency Assessment

| | Meets Expectations—Score = 2 |
|---|---|
| | Some Caps—Score = 1 |
| EVM Linkage T-Score © (PMB/CFSR) | Clearly Absent—Score = 0 |
| The majority of engineering activities use discrete (non-Level of Effort) EV | |
| techniques for performance management; quality-type measurements and | |
| linkage of EV and completion criteria to TPMs are integrated directly into CA | |
| planning. Planned profiles are used for TPM planning and integrated with | |
| BCWS profiles. | |
| Risk register entries quantify cost and schedule impacts and are directly | |
| traceable to a least a portion of MR (cost) and Schedule Reserve (time), and | |
| enable the program to generate a planned MR burn profile. | |
| EVM data validity checks are performed routinely and as part of each | |
| recurring cost estimate. Checks include negative values for ACWP, BAC, | |
| BCWP, BCWS, or EAC; unusually large performance swings (BCWP) from | |
| month to month; BCWP and/or BCWS with no corresponding ACWP (or | |
| vice-versa); BCWP with no BCWS; ACWP that is way above or below the | |
| planned value; no BAC but an EAC or a BAC with no EAC; ACWP, BCWP | |
| or BCWS exceeds EAC; rubber and front-loaded baseline indicators. | |
| CPR Format 5 analysis directly integrates schedule duration analysis and | |
| performance information with variance analysis, especially where schedule | |
| variance is concerned. | |
| A documented intent exists for government and contractor to periodically (at | |
| least quarterly) review and adjust WBS reporting levels, and evidence exists | |
| that such reviews have taken place as planned. | |
| Risk-adjusted baseline and levels of MR and Schedule Reserve directly reflect | |
| (i.e., are supported by evidence) the demonstrated maturity level of critical | |
| technologies and engineering processes. | |
| Variance thresholds established in CPR (e.g., CV %, SV %, CPI vs. TCPI, etc) | |
| that automatically trigger risk identification actions are documented in the | |
| program risk register. | |
| Budgets, especially crossovers into subsequent fiscal years, are assessed and | |
| updated with every change to the performance measurement baseline to | |
| ensure validity of out-year planning and not breached annual budgets. Budget | |
| analysis also reflects periodic CPR and CFSR reconciliation. | |
| Program planning procedures ensure that results of monthly schedule analysis | |
| and periodic SRAs are incorporated directly into the CPR and correlated with | |
| CA EVM performance information. Evidence of this exists in actual | |
| reporting. | |
| The program's product-oriented WBS minimizes the use of LOE EV | |
| technique. LOE tasks represent less than 15% of the total planned value. | |

EVM Linkage score (Possible score-zero to 20)

TABLE 22
Schedule Linkage Transparency Assessment

| | |
|---|---|
| | Meets Expectations—Score = 2 |
| | Some Gaps—Score = 1 |
| Schedule Linkage T-Score © (CPR Format 5/IMS/SRA) | Clearly Absent—Score = 0 |

Exit criteria for design reviews clearly indicate that a detailed review of the
schedule is required and an SRA is performed. The IMS accurately reflects
engineering activity.
3-point estimates (best case, worst case, and most likely) exist for every CA in
terms of time. The rationale for each schedule risk is documented in the
program risk register along with a description of how this CA risk correlates
with other CAs. The risk register is reassessed and updated regularly and
used as a direct feed into periodic SRAs.
Results of SRA explicitly answer how resource estimates were developed for
each schedule activity and if those resources will be available when needed.
Program planning procedures ensure that results of monthly schedule analysis
and periodic SRA are incorporated directly into the CPR and correlated as
appropriate to CA EVM performance information. Evidence of this exists in
actual reporting.
Schedule activities reflect key dependencies in the program WBS Dictionary.
Process guidance ensures changes to one are to be reflected in the other.
Design reviews are event-driven and have clearly documented entry and exit
criteria traceable to the IMP. Key activities related to the achievement of
those criteria are reflected in the IMS and appropriately incorporated as
predecessors and successors to the reviews.
The risk register contain entries—identified risks—that result purely from the
breaching of pre-determined schedule metrics and/or SRA results.
The program conducts integrated cost-schedule risk analyses such that the
cost elements that relate to time uncertainty (labor management, rented
facilities, escalation) can be linked directly to uncertainty in the schedule.
CPR Format 5 analysis directly integrates schedule analysis and performance
information with variance analysis, especially where schedule variance is
concerned.
Work packages, activities and resource-loading in the IMS are traceable and
consistent with information contained in the WBS dictionary text. This
includes evidence of controlled changes to text that correspond to significant
changes in the schedule.
Schedule Linkage score (Possible score-zero to 20)

TABLE 23
Technical (Engineering)

| | Meets Expectations—Score = 2 |
|---|---|
| Technical Linkage T-Score © (System Engineering Management | Some Gaps—Score = 1 |
| Plan/CPR Format 5/Technical Performance Measures) | Clearly Absent—Score = 0 |
| The SEMP and Risk Management Plan clearly identify the importance of | |
| integrating risk management and SE, and also describe how the integration is | |
| to occur in a repeatable fashion. | |
| Is the cost estimate technical baseline documented in a Cost Analysis | |
| Requirements Document (CARD) or equivalent, which was developed by an | |
| interdisciplinary team? | |
| Design reviews are event-driven and have clearly documented entry and exit | |
| criteria traceable to the IMP. Key activities related to the achievement of | |
| those criteria are reflected in the IMS and appropriately incorporated as | |
| predecessors and successors to the reviews. | |
| Risk-adjusted baseline and levels of MR and Schedule Reserve directly reflect | |
| (i.e., are supported by evidence) the demonstrated maturity level of critical | |
| technologies and engineering processes. | |
| The SEMP clearly reflects the important role of the WBS in engineering | |
| planning and references latest WBS version. | |
| Entries in the program risk register relating to technical risk clearly show | |
| traceability to specific WBS elements and can be traced via measures relating | |
| to engineering process, quality, control and performance. | |
| At a minimum, the technical baseline used for periodic cost estimates includes | |
| TRL of key technologies, detailed technical system and performance | |
| characteristics, a product WBS, a description of legacy or similar systems, | |
| details of the system test and evaluation plan, safety, training, logistics | |
| support and tracking of changes from the previous baseline. | |
| Exit criteria for design reviews clearly indicate that a detailed review of the | |
| schedule is required and an SRA be performed. The IMS accurately reflects | |
| engineering activity. | |
| The majority of engineering activities use discrete (non-Level of Effort) EV | |
| techniques for performance management. Quality-type measurements are | |
| integrated directly into CA planning. Planned profiles are used for TPM | |
| planning and integrated with BCWS profiles. | |
| KPPs, TPMs, applicable engineering and process and quality metrics, and | |
| TRLs are traceable to the appropriate level of WBS. | |

Technical Linkage score (Possible score-zero to 20)

TABLE 24
WBS Linkage Transparency Assessment

| | |
|---|---|
| | Meets Expectations—Score = 2 |
| | Some Gaps—Score = 1 |
| WBS Linkage T-Score © (WBS Dictionary) | Clearly Absent—Score = 0 |

KPPs, TPMs, applicable engineering, process and quality metrics and
Technology Readiness Levels are traceable to the appropriate WBS level
No later than the IBR, all risks in the program risk register are traceable to the
lowest possible WBS element, preferably to each CA
The program cost estimate is updated with actual program costs, is reconciled
with the program budget, and the reasons for changes are directly traceable to
WBS elements.
Work packages, activities, and resource-loading in the IMS are traceable and
consistent with information contained in the WBS/WBS dictionary including
controlled documentation of changes.
The program's product-oriented WBS minimizes the use of LOE EV
technique. LOE tasks represent less than 15% of the total planned value.
The SEMP clearly reflects the important role of the WBS in engineering
planning and references latest WBS version.
The Risk Management Plan clearly reflects role of a product WBS in risk
planning and all program Risk Register entries are traceable to lowest relevant
WBS element. As required, the WBS is expanded to lower levels in areas
where there are elevated risk levels.
The latest cost estimate is directly traceable to the current WBS and OBS
being executed by the program.
Schedule activities reflect key dependencies in the program WBS Dictionary.
Process guidance ensures changes to one are to be reflected in the other.
A documented intent exists for government and contractor to periodically (at
least quarterly) review and adjust WBS reporting levels, and evidence exists
that such reviews have taken place as planned.
WBS Linkage score (Possible score-zero to 20)

TABLE 25
Linkage Transparency Score Analysis

| | |
|---|---|
| Linkage T-Score © Analysis | Linkage Total |

Cost
Risk
Budget
Schedule
Engineering
WBS
Total

Normalized Total (Total/24) (1-5)

2.7 Composite Data Transparency Score Trend Analysis

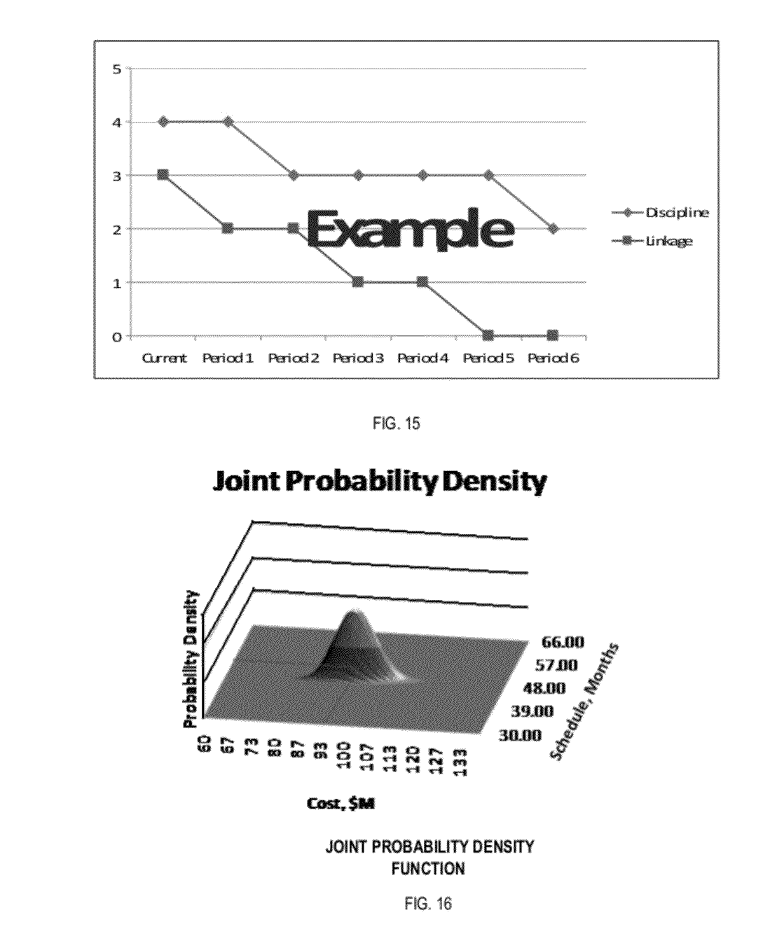

Presentations of Gate 2 analysis should include a trend chart, similar to the example in FIG. 15, that demonstrates the change in the Discipline and Linkage scores from period to period, typically determined by the frequency of the analysis.

2.8 Maintaining the Findings Log

Findings from the Gate 2 assessment should be added to the Findings Log, depicted in Table 26, created during the Gate 1 Data Review. This Findings Log should be viewed as a potential list of risks and opportunities to be presented to the PM for consideration for inclusion in the Program Risk Register.

TABLE 26
Findings Log
Findings Log

| | | | | | | | | |
|---|---|---|---|---|---|---|---|---|
| | | Origi- | Descrip- | | Fac- | | Factored | Com- |
| ID | Date | nator | tion | WBS | tor | Value | Value | ments |

3.1 Introduction to Link Data and Analyze

As shown on FIG. 1, Gate 3 106 pulls together the analysis and observations that have been documented as findings from the previous two gates and introduces the statistical rigor to provide the quantifiable data for the risk-adjusted ETC probability distribution. LCAA starts with traditional ETC formulas to “alert and guide” the project management team by presenting a three-point estimate for each lowest level WBS element. In this initial step, the analyst “alerts” the project team by presenting the current performance of the CA. From this initial estimate, the team can make adjustments for issues, risks or opportunities previously identified in Gates 1 and 2.

Those using LCAA should make a decision on the approach given the Gates 1 and 2 assessments and analyses and the level of participation of program experts. The statistical methods outlined below are based on the Method of Moments (MoM) and are instantiated in FRISK (Reference: P. H. Young, AIAA.92.1054) in automated tools, thus allowing for efficient development of a probability distribution around the ETC or EAC. Other methods of including discrete risk adjustments germane to statistical simulation may be used when applied appropriately.

Several additional existing concepts can be included in Gate 3, such as calculation of Joint Confidence Levels (JCLs) and comparison of means and contractor ETCs. The contractor's ETC=LRE−ACWP. These and other statistical approaches and comparisons can provide a quantifiable context for management team decisions. Many alternative distributions and methods could be used, but given that the focus of the LCAA method is in the project office with participation of much of the program team, the approaches below provide an effective and efficient method. FIG. 21 illustrates an exemplary flowchart of the process for linking risk data and performance data.

3.2 Organize Control Account Cost Performance Data

At a minimum, the following information should be organized by CA or lowest level WBS element:
Cumulative BCWS
Cumulative BCWP
Cumulative ACWP
BAC
LRE
Cumulative CPI
3-month moving average CPI
6-month moving average CPI
Cumulative SPI
3-month moving average SPI
6-month moving average SPI

If a contract has experienced a Single Point Adjustment (SPA), the cost and schedule variances were likely eliminated, thus re-setting the CPI and SPI to 1.0 and, therefore, losing knowledge of contractor historical past performance information. As a result, the project's performance can be masked by the now perfect performance of that accomplished prior to the SPA event. In these cases, it is important to conduct LCAA using only contractor performance since the SPA. In wInsight™, these data are referred to as adjusted or reset data and the following information should be organized by CA or lowest level WBS element:
Cumulative adjusted—BCWS
Cumulative adjusted—BCWP
Cumulative adjusted—ACWP
Cumulative ACWP
BAC
LRE
Cumulative adjusted-CPI
3-month moving average CPI (if more than 3 months since SPA)
6-month moving average CPI (if more than 6 months since SPA)
Cumulative adjusted-SPI
3-month moving average SPI (if more than 3 months since SPA)
6-month moving average SPI (if more than 6 months since SPA)

3.3 Apply Earned Value Data Validity Check Observations from Gate 1 and Gate 2

The validity of the cost performance data, as determined by the EV Data Validity Checks (Table 3), in Section 1.3.1) is applied to the information identified above in section 3.2. The determination of whether artifacts and data are valid and reliable are made using these observations.

If the following numbered EV Data Validity Check observations are found to be true,
(5) Percentage of LRE representing completed work is less than percent complete
(8) LRE is less than the (calculated) Independent Estimate At Complete [IEACI, where actuals are added to the (Remaining work x the current CPI])
(13) Actual expenditures to date have already exceeded the LRE
(14) The To Complete Performance Index (TCPI) is higher than the current CPI sum by more than 5 percent
(15) The TCPI is less than the current CPI sum by more than 5 percent

then the contractor LRE for those WBS elements is determined to be unrealistic and should not be used in calculating the ETC.

If the following Earned Value Data Validity Check Observations are found to be true,
(1) Performance credited with $0 expenditures AND
(11) No performance has been taken and $0 have been spent

then the various CPI indices should not be used in calculating the ETC.

If the Earned Value Data Validity Observation 2 (Performance credited with no budget) is observed, then the various SPI indices should not be used on calculating the ETC.

3.4.1 Develop Estimates to Complete for each Control Account or Lowest Level Element

The basic formula for calculating an ETC is to divide the Budgeted Cost of Work Remaining (BCWR) by a performance factor. The following performance factors are typically used:

1. CPI—current, cumulative, adjusted or reset, 3 and 6-month moving averages; results in the most optimistic ETC

2. SPI—current, cumulative, adjusted or reset, 3 and 6-month moving averages

3. Weighted Indices—calculated by adding a percentage of the CPI to a percentage of the SPI where the two percentages add to 100 percent; the weighting between CPI and SPI should shift, de-weighting SPI as the work program progresses since SPI moves to 1.0 as the work program nears completion.

4. Composite—calculated by multiplying the CPI times the SPI; results in the most conservative ETC

The current month CPI and SPI are considered too volatile for use in calculating ETCs for LCAA.

In addition to the contractor's ETC, 12 ETCs for each CA or lowest level WBS element are possible after applying all available performance factors. Those performance factors deemed to be invalid are not used.

3.4.2 Develop Estimates to Complete Probability Distributions

The 13 possible calculated ETCs are used to “alert and guide” the analyst and to provide an EV CPR-based estimate as starting point for risk adjustments. First, calculate the mean and standard deviation from the valid ETCs and report them to the analyst. The mean μ, is the simple average of the n valid ETCs as determined in section 3.4.1:

$$μ = \frac{1}{n} {\sum }_{j = 1}^{n} {ETC}_{j} \qquad [ Equation 1 ]$$

We then calculate the standard deviation a of the same n ETCs using the formula

$$σ = \sqrt{\frac{n {\sum }_{j = 1}^{n} {ETC}_{j}^{2} - {( {\sum }_{j = 1}^{n} {ETC}_{j} )}^{2}}{n - 1}} . \qquad [ Equation 2 ]$$

For each WBS element, at the lowest level available, use these statistical descriptors to help model the probability distribution of its ETC.

The n valid ETCs are treated as samples to calculate the mean and standard deviation of the ETC distribution but are communicated to the analyst as three points representative of the relative most likely range. To facilitate adjustments, three ETCs are selected from those calculated to “guide” the analysis team. The result is a three-point estimate defined by three parameters:

1. Low, L, which represents the minimum value of the relative range

2. Most likely, M, or the mode of the distribution

3. High, H, which is the highest value of the relative range

If the contractor's LRE is deemed valid, then it is postulated the most likely parameter. This assumes that the contractor's LRE represents the “best” estimate compared with the pure EV CPR-based ETC.

If the contractor's LRE is deemed invalid, then the most likely parameter is calculated by using Equations 1 (above) and 3 (below) instead.

M=3μ−L−H, if L≦M≦H [Equation 3]

While this initial three-point estimate is not the end of the analysis, right triangles are possible. It is up to the analyst to consider if this is realistic on a case-by-case basis. For example, a CA may represent an FFP subcontract with a negotiated price and therefore there is no probability the costs will go lower, creating a right-skewed triangle. On the other hand, a left-skewed triangle might represent an opportunity.

In the case where the most likely calculation in Equation 3 produces a result that falls outside the minimum or maximum value of the relative range it will be limited and set equal to the low or high value calculated from the n ETCs, respectively.

3.4.3 Risk-and-Opportunity-Adjusted ETC Probability Distributions

The initial statistics and three-point estimate (at any WBS level), based only on past data reflected in the CPR-based ETC estimates, account for contract performance to-date and are modified by the analyst with adjustments from the CAMs (or program management) for probabilistic impacts of future issues and uncertainties. The CREST philosophy considers four disciplines when providing ETC estimates of at the lowest level of the WBS:

1. Risk Analysis

2. Schedule Analysis

3. TPM Analysis

4. PLCCE

Valid risks and opportunities from the risk register are now used to expand the bounds of the probability distributions. Opportunities for each CA or lowest level WBS element are subtracted from the Low value, lowering this bound of the distribution. Risks are added to the high value, increasing this bound of the distribution.

To account for risks and opportunities that are not included in the CPR-based ETC, LCAA allows the incorporation of additional risk and opportunity impacts based on CAM inputs, a ROAR, results of a schedule risk analysis (SRA), and the statistics from multiple independent estimates. LCAA forms a composite estimate by weighting the estimates according to their estimated probability of occurrence in three steps. First, the analyst reviews the statistics and three-point representation of the CPR-based estimate for each WBS and determine if adjustments to the data are indeed required. These adjustments to the EV CPR-based estimate originate from CAM inputs or from an SRA.

If no adjustments are required, the EV CPR-based estimate is deemed to have a probability of occurrence (P_{CPR}) of 100% and is used as the “adjusted ETC” going forward.

If adjustments are required, the analyst provides a three-point estimate for ETC calculations for each adjusted WBS element. The mean and standard deviation statistics of a triangular distribution (Equations 4 and 5) will be used rather than the n ETCs, and this adjusted ETC will have a probability of occurrence (P_{ADJ}) of 100% and the P_{CPR} will be set to 0%

$$\begin{matrix} {μ}_{ADJ} = \frac{{L}_{ADJ} + {M}_{ADJ} + {H}_{ADJ}}{3} & [ Equation 4 ] \\ {σ}_{ADJ} = \sqrt{\frac{\begin{matrix}{( {L}_{ADJ} )}^{2} + {( {M}_{ADJ} )}^{2} + {( {H}_{ADJ} )}^{2} - \\ ( {L}_{ADJ} * {H}_{ADJ} ) - ( {L}_{ADJ} * {M}_{ADJ} ) - ( {M}_{ADJ} * {H}_{ADJ} )\end{matrix}}{18}} & [ Equation 5 ]\end{matrix}$$

Next, use all valid issues, risks and opportunities from the Issues list and the Risk and Opportunity Assessment Register (ROAR) to provide probabilistic impacts to the ETCs. To quantify the impacts of discrete risks and opportunities to the ETC, they are first “mapped” to the WBS elements they affect. The probabilities that reflect the likelihood that any combination (k: l≦k≦n), each of which is called a “risk state”, of the identified risks or opportunities will actually occur. (To simplify the algebraic symbolism, consider an opportunity to be a “negative risk,” representing its impact by shifting the probability distribution of the adjusted ETC to the left—the negative direction.) Denote the risks as R1, R2, R3, . . . , etc. and their respective probabilities of occurrence as P_{R1}, P_{R2}, P_{R3}, . . . etc. If there are n risks, and therefore m=2ⁿ−1 probable risk combinations denoted by S1, S2, S3, etc., the sum of these probabilities, together with P_{CPR}, the probability that there is no risk impact to the CPR-based ETC, is denoted as follows:

Pₒ=Πᵢ₌₁ⁿ(1−P_{Ri}) (i.e., no risk or opportunity occurs), [Equation 6]

and the mean of the states whereby any risk or combination of risks occur is denoted as:

$${μ}_{1} = {μ}_{0} + \frac{{\sum }_{i = 1}^{n} ( {P}_{Ri} Ri )}{( 1 - {P}_{0} )} . \qquad [ Equation 7 ]$$

Given this, the mean of the distribution formed by combining the CPR-based estimate and the risks is:

μ=P₀μ₀+(1−=P₀μ₁=μ₀+Σᵢ₌₁ⁿ(P_{Ri}Ri), [Equation 8]

where the term Σᵢ₌₁ⁿ (P_{Ri}Ri) is the sum of the “factored risks”, μ₀ is the mean of the CPR-based estimate (or analyst-adjusted estimate), and σ₀ is the standard deviation of the CPR-based estimate (or analyst-adjusted estimate).

The standard deviation of the distribution formed is a more difficult calculation. It is the square of the probability-weighted variances of 1) the state in which no risks occur and 2) the states in which one or any combination of risks occur.

σ=\sqrt{P₀[σ₀²+(μ₀−μ)²]+(1−P₀)[σ₁²+(μ₁−μ)²]} [Equation 9]

If there are n risks, then there are k=2n−1 possible states in which one or risk can occur the standard deviation of the distribution of these combined states is:

σ₁=\sqrt{Σᵢ₌₀^{k}P(Sᵢ)(σᵢ)²}=\sqrt{(σ_{c}_{₀})²+Σᵢ₌₀^{k}P(Sᵢ)[μ₀−μ+Dᵢ]²}, [Equation 10]

Where P(Sᵢ)=Πⱼ₌₁ⁿγ_{j,i}(P_{Rj},1−P_{Rj}), [Equation 11]

γ_{j,i}(x₁,x₂)=(βᵢ(j))x₁+(1−βᵢ(j))x₂, a bistate function, and [Equation 12]

βᵢ(j)=binary equivalent of i^{th} digit of value j. For example β₂(6)=β₂(110)=1.

If necessary to see the distribution as a range of values, the low is calculated as the 10^{th} percentile of the distribution and the high as the 90^{th} percentile. The most likely value is then calculated using the composite mean and standard deviation statistics.

As mentioned above, to avoid double-counting it is important to understand which risks, opportunities, and issues may have been incorporated into the CA budgets and adjustments and therefore are already included in the PMB or in the contractor's LRE.

The Findings Log established on the basis of work done in Gates 1 and 2 can also be used to generate probabilistic impacts of elements where risks, opportunities, or issues that have not yet been captured in the ROAR but have the concurrence of the PM or the analysis team. The PM team needs to decide which of the “findings” are captured as formal issues and risks/opportunities and thus have been or are to be used in any ETC modeling.

If a program or contract SRA has been performed, it should identify the probability distribution of the completion dates of key events within the program development effort remaining. This analysis can reveal significant cost impacts to the program due to schedule slips or missed opportunities. With a resource-loaded schedule, impacts to the CAs can be evaluated and used as an additional estimate to include as a weighted ETC. The PM should consider building a summary-level program SRA specifically to define the schedule ETC given all the findings and to inform the analysis team of how the findings further impact costs ranges via schedule uncertainties. Note: Use of LOE as an EV technique should be minimized; however, LOE is often used incorrectly for management activities by many contractors and the effect of a schedule slip is therefore likely to be overlooked in traditional EV analysis.

At a minimum, LOE WBS elements should be considered for adjustment since, by definition, they do not have a schedule performance index (SPD other than 1.0. The SRA can be used as an additional probabilistic estimate to appropriately capture schedule issues. The LOE EV technique typically means a standing army of support for the duration of the task or WBS element. During the SRA, if a schedule slip is deemed probable, the most likely cost will be the additional time multiplied by the cost of the standing army, ignoring effects of other possible risk issues. The output produced by the SRA at each WBS level should be considered to be a triangular distribution and applied to the ETC range as an additional adjustment.

TPM/TRL and other technical analyses are unique for each program, since each system will have different technical parameters based on the product delivered. Likewise, the analysis to understand the impacts to the ETCs will be unique for each program. The cost estimator will identify, usually through parametric analysis, where relaxed or increased requirements will have an impact on the program's development costs. Again, the possible pitfall is double counting risks that have already been identified for the program during prior adjustments.

If a cost estimate or BOEs have been mapped to the contract WBS, WBS element ETCs derived from the cost estimate can also be used as independent estimates. Often the mapping is not possible at the CA level but can be determined from a summation level higher within the WBS. If available, the cost estimate should be factored in as the summations occur, adjusting the appropriate level. Use of the cost estimate is the best way to capture what are often referred to as the unknown unknowns, namely the risks that have not been discretely listed in the analysis. This will be especially true if the original cost estimate used parametric methods.

The analyst can use these independent analyses to adjust the ETC distribution with by weighing the various estimates or by adjusting the Low, Most Likely and High values for each WBS element.

When using a weighting of the distributions, the composite weighted means and standard deviations of the risk adjusted and independent distributions for each WBS element will be

$$\begin{matrix}{μ}_{i} = ( {P}_{ROA} * {μ}_{ROA} ) + ( {P}_{Tech} * {μ}_{Tech} ) + ( {P}_{CE} * {μ}_{CE} ) , \\ where \\ {P}_{ROA} + {P}_{Tech} + {P}_{CE} = 1 \\ and & [ Equation 13 ] \\ {σ}_{i} \sqrt{\begin{matrix}( {P}_{ROA} * {σ}_{ROA}^{2} ) + ( {P}_{SRA} * {σ}_{SRA}^{2} ) + \\ ( {P}_{Tech} * {σ}_{Tech}^{2} ) + ( {P}_{CE} * {σ}_{CE}^{2} )\end{matrix}} & [ Equation 14 ]\end{matrix}$$

In the case of σᵢ, it is assumed that no double counting of risks has made its way into the analysis so that the various adjustments may be combined with confidence that they are independent of, or at least uncorrelated with, each other.

Overall, the team conducting the analysis should consider as much information as possible, but should also take care to consider the possibility that the initial performance data has already captured future effects. Double counting is possible, thus caution is necessary.

3.5 Statistically Sum the Data

Beginning at the CA level or lowest level of the WBS, the triangular probability distributions are statistically summed to the next highest WBS level. For example, the ETC probability distribution of a level five WBS element (parent) is calculated by statistically summing the probability distributions of the level six elements (children) that define it. This process of statistical summation is repeated for each roll-up until the results at the program level are calculated, making appropriate adjustments to the WBS ranges as determined earlier.

Inter-WBS correlation coefficients are required for the statistical summation. The schedule should be decomposed and reviewed at the CA or lowest-level elements to assist in determining relative correlations between WBS/OBS elements

It is up to the analyst to identify the appropriate correlation coefficients. For analysis to begin, a recommended correlation coefficient of 0.25 (GAO-09-3SP, GAO Cost Estimating and Assessment Guide, March 2009, p. 171.) can be used for most WBS elements and a correlation coefficient of 1.0 when summing the level-2 WBS elements. This should be viewed as a starting point only and further adjustments can be made based on program-specific conditions at the discretion of the analyst.

The assumption of positive correlation, in the absence of convincing evidence to the contrary, should be made in order to move the summation of cost distributions for WBS elements forward. This assumption may not always be appropriate when assigning correlation coefficients between tasks in a schedule assigned during an SRA.

The methodology used to statistically sum the ETCs is the choice of the analyst. For example, Method of Moments or statistical simulation based on Monte Carlo or Latin Hypercube methods may be used.

3.6 Compare the Mean and Contractor ETC

At the lowest level of the WBS, the mean of the risk-adjusted ETC range should be compared with the contractor ETC for the same WBS element to determine a percentage difference and a dollar value difference. The WBS elements can then be ranked by percent delta and the dollar value of the delta to expose the elements requiring attention. If an issue or risk has not yet been identified for the element, the analyst should evaluate the need for an entry into the findings log to capture management's attention.

3.7 Joint Confidence Levels (JTLs)

A JCL can be used to jointly view estimates of future costs (i.e., ETC) and further schedule (i.e., remaining months from a schedule risk analysis). Beginning with independent probability distributions of cost and schedule assigning an appropriate correlation will allow the determination of confidence levels of cost and schedule at a particular dollar value or time respectively. The JCL can be used to help the analyst select a course of action given the combined effects of both cost and schedule uncertainties. Caution is needed in this area, as most schedule analysis doesn't consider the costs of compressing a schedule, thus the joint confidence level often doesn't represent the real range of possibilities to the program management team.

The method uses the bivariate probability distributions of cost and schedule to allow the determination of meeting a particular cost and a particular schedule jointly (i.e., P[cost<a and schedule]) or meeting a particular cost at a specified schedule (i.e., P[cost<a|schedule=b ]). Assume the probability distributions of cost and schedule to be lognormal distributions, so the bivariate lognormal distribution developed by Garvey is used for calculations of joint confidence levels [Garvey]. An illustration of a joint probability density function of cost and schedule is shown in FIG. 16.

The bivariate lognormal density function is defined as

$$\begin{matrix} f ( {x}_{1} , {x}_{2} ) = \frac{{e}^{- \frac{w}{2}}}{2 π {Q}_{1} {Q}_{2} \sqrt{1 - {R}_{1 , 2}^{2}} {x}_{1} {x}_{2}} \\ where & Equation 15 \\ w = \frac{1}{1 - {R}_{1 , 2}^{2}} \{ {[ \frac{( ln ( {x}_{1} ) - {P}_{1} )}{{Q}_{1}} ]}^{2} - 2 {R}_{1 , 2} [ \frac{( ln ( {x}_{1} ) - {P}_{1} )}{{Q}_{1}} ] [ \frac{( ln ( {x}_{2} ) - {P}_{2} )}{{Q}_{2}} ] + {[ \frac{( ln ( {x}_{2} ) - {P}_{2} )}{{Q}_{2}} ]}^{2} \} & Equation 16\end{matrix}$$

P1, P2, Q1, and Q2 are defined by Equation 5 and Equation 6, respectively, and

$${R}_{1 , 2} = \frac{1}{{Q}_{1} {Q}_{2}} ln ( 1 + {ρ}_{1 , 2} \sqrt{{e}^{{Q}_{1}^{2}} - 1} \sqrt{{e}^{{Q}_{2}^{2}} - 1} ) \qquad Equation 17$$

where ρ_{1,2} is the correlation coefficient between the total program cost and associated schedule.

The joint confidence level of a particular schedule (S) and cost (C) is defined as:

P(cost≦C, schedule≦S)=∫₀^{S}∫₀^{C}∫(x₁,x₂)dx₁dx₂ Equation 18

It should be noted that the joint confidence level of a 50th percentile schedule and a 50th percentile cost estimate is not the 50th percentile but some smaller value.

3.8 Calculate Estimate at Completion

To calculate the EAC probability distribution, the ACWP is added to ETC distribution. Table 27 provides the summary statistics and confidence levels of the probability distribution function for an ETC calculation. In this example, the 80th percentile confidence level of the ETC is $1,732,492, meaning there is an 80 percent probability that the ETC will be $1,732,492 or lower.

TABLE 28
EAC Summary Statistics and Confidence Levels

| | |
|---|---|
| $7,889,701 | Mean (Expected Cost) |
| $7,886,909 | Median (50th percentile) |
| $7,793,706 | Mode (Most Likely) |
| $ 96,183 | Std. Deviation |

Confidence Percentiles

| | |
|---|---|
| $7,736,415 | 5% |
| $7,768,427 | 10% |
| $7,790,411 | 15% |
| $7,808,108 | 20% |
| $7,823,451 | 25% |
| $7,837,358 | 30% |
| $7,850,353 | 35% |
| $7,882,781 | 40% |
| $7,874,897 | 45% |
| $7,886,909 | 50% |
| $7,899,009 | 55% |
| $7,911,395 | 60% |
| $7,924,294 | 65% |
| $7,937,995 | 70% |
| $7,952,905 | 75% |
| $7,989,663 | 80% |
| $7,989,402 | 85% |
| $8,014,558 | 90% |
| $8,052,510 | 95% |

TABLE 27
ETC Summary Statistics and Confidence Levels

| | |
|---|---|
| $1,652,531 | Mean (Expected Cost) |
| $1,649,739 | Median (50th percentile) |
| $1,556,535 | Mode (Most Likely) |
| $ 96,183 | Std. Deviation |

Confidence Percentiles

| | |
|---|---|
| $1,499,244 | 5% |
| $1,531,257 | 10% |
| $1,553,241 | 15% |
| $1,570,938 | 20% |
| $1,586,281 | 25% |
| $1,600,187 | 30% |
| $1,613,182 | 35% |
| $1,625,611 | 40% |
| $1,637,727 | 45% |
| $1,645,735 | 50% |
| $1,681,829 | 55% |
| $1,674,224 | 60% |
| $1,687,123 | 65% |
| $1,700,824 | 70% |
| $1,715,735 | 75% |
| $1,732,432 | 80% |
| $1,752,231 | 85% |
| $1,777,288 | 90% |
| $1,815,339 | 95% |

The current cumulative ACWP in our example is $6,237,171. That total is added to the values in Table 27 to create a probability distribution representing the EAC (Table 28). In this example, the 80th percentile confidence level of the EAC is $7,969,663.

4.1 Introduction to Critical Analysis

As shown on FIG. 1, Gate 4 108, Critical Analysis, combines the probability distribution generated from Gate 3 106 with a) trending analysis and b) MCR Exposure and Susceptibility Indices, discussed below in paragraph 4.4. This analysis allows for identifying risks and opportunities drivers, and the formulation of recommendations for addressing these items at the individual CA level. These recommendations provide the program management team with tradeoffs between costs, schedule and scope associated with implementing changes in future efforts. This could allow, for example, the management team to make informed adjustments of a particular CA (or group of CAs) in terms of cost, schedule and/or scope that in turn reduce the range of possible program outcomes. This provides a more efficient and effective solution.

4.2 Display Results

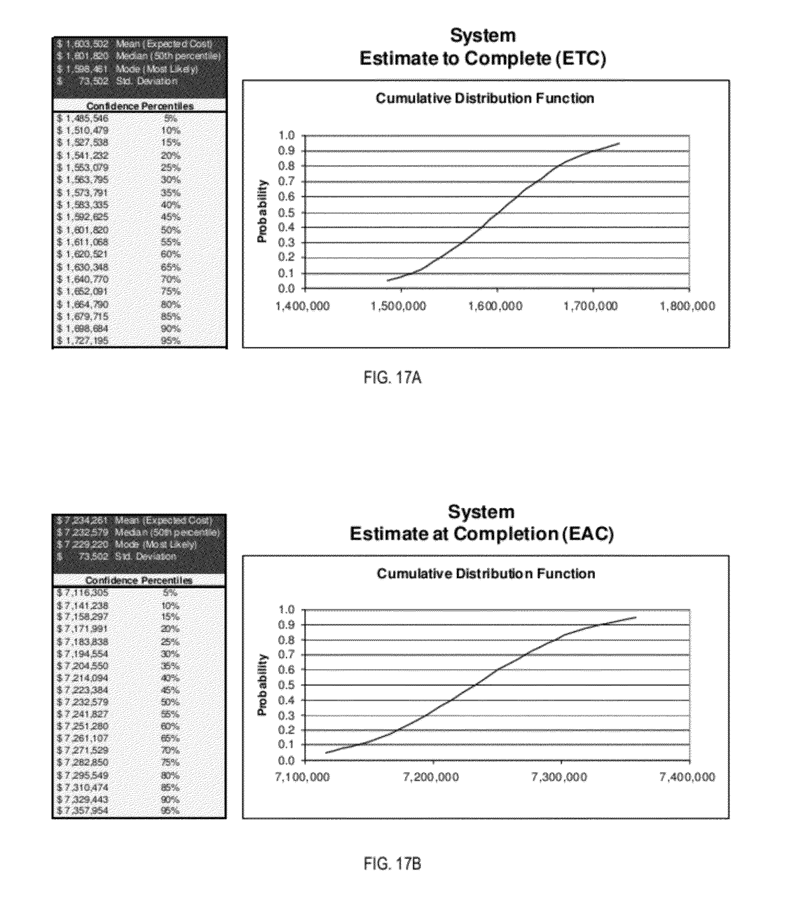

The results from the statistical summation are probability distributions for each WBS level and are illustrated in FIG. 17A. The contractor's ETC should be plotted on the cumulative distribution to demonstrate the confidence percentile it represents.

To calculate the EAC probability distribution, the ACWP is added to ETC distribution. An example is provided in FIG. 17B. Again, the contractor's EAC should be plotted on the cumulative distribution curve to demonstrate the confidence percentile it represents.

4.3 Trend Analysis

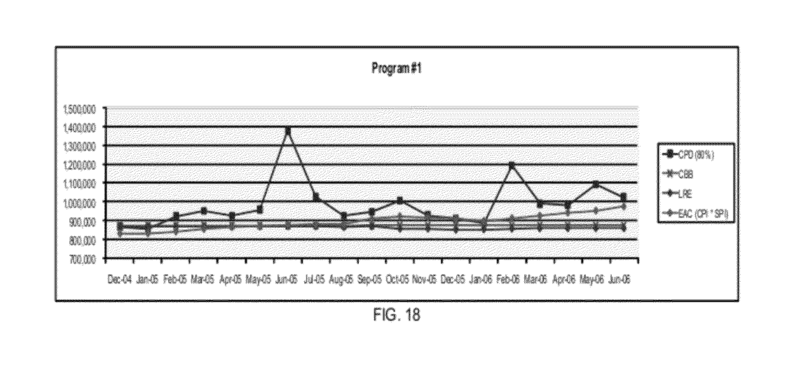

Plotting LCAA results over time, as shown in FIG. 18, identifies trends in contractor performance and program progress.

4.4. MCR Exposure and Susceptibility Indices

A program's Risk Liability (RL) is the difference between the estimated cost or schedule at completion at a high confidence percentile (e.g., 80th) and the current program baseline.

$$EI = 1 - \frac{RL}{Remaining Baseline} \qquad Equation 19$$

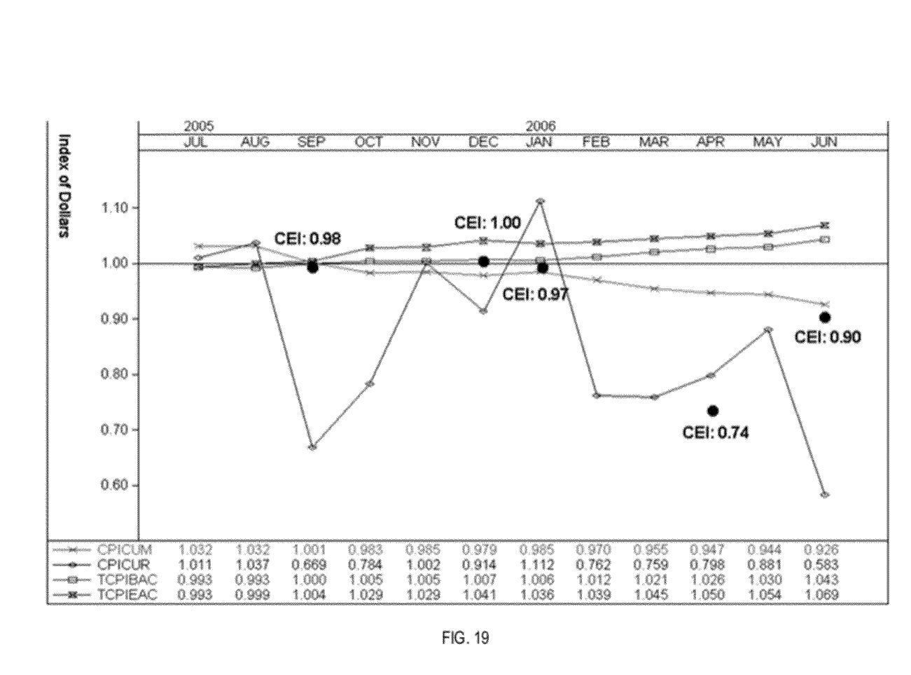

The Exposure Index (EI) indicates that ratio of risk compared to the remaining resources, either dollars or time, available to accomplish the project. A value of 0.75 indicates the program only has 75 percent of the resources needed to obtain project objectives at the established high confidence percentile. The index tracked over time, as illustrated in FIG. 19, will indicate if the program is decreasing risk liability at the same rate that resources are being consumed.

The Susceptibility Index (SI) indicates the ratio of MR compared to Risk Liability. A value of 0.75 indicates the program only has 75 percent of the MR necessary to cover the expected value of the remaining risk liability in cost or schedule. The index tracked over time will indicate if the program is decreasing MR as the same rate that the cost and schedule resources are being consumed.

$$SI = \frac{MR}{RL + MR} \qquad Equation 20$$

4.5 Identify Drivers/Make Recommendations

The purpose of LCAA is to provide the PM with actionable information. First, the most significant cost and schedule drivers in terms of cost and schedule should be identified. A breakdown of the program level results should identify which Level 2 WBS element is contributing the most to the program's RL either in total dollar value or schedule months. This breakdown can continue until the most serious issues are identified.

Other decision analyses to consider

Options to reduce uncertainty in the future

Mitigation steps that reduce future risks

4.6 Allocating Risk Liability to Individual Cost Elements

Based on Dr. Stephen Book's work, MCR has established a mathematical procedure that provides a means for allocation of RL dollars among program elements in a manner that is logically justifiable and consistent with the original goals of the cost estimate. Because a WBS element's “need” for risk dollars arises out of the asymmetry of the uncertainty in the cost of that element, a quantitative definition of “need” must be the logical basis of the risk-dollar computation. In general, the more risk there is in an element's cost, the more risk dollars will be needed to cover a reasonable probability (e.g., 0.50) of being able to successfully complete that program element. Correlation between risks is also taken into account to avoid double-billing for correlated risks or insufficient coverage of isolated risks.

It is a statistical fact that actual WBS element's 50th percentiles do not sum to the 50th percentile of total cost, and this holds true for 80th and all other cost percentiles. To rectify this situation, calculate the appropriate percentile (i.e., 50th, 80th, etc.) of total cost and then divide by the appropriate percentile total cost among the WBS elements in proportion to their riskiness, with inter-element correlations taken into account. Therefore the numbers summing to the 50th percentile of total cost will not be the actual 50th percentiles of each of the WBS elements but rather an allocated value based on the percentile of the total cost. For the remainder of this report, assume the appropriate percentile is the 50th percentile.

The calculated Need of any WBS element is based on its probability of overrunning its point estimate.

An element that has preponderance of probability below its point estimate has little or no need. For example, the definition of Need of project element k at the 50th percentile level is:

Needk=50th percentile cost minus the CBB

Needk=0, If the point estimate exceeds the 50th percentile cost

First, calculate the total Need Base, which is an analogue of total cost variance (σ²).

Need Base=Σᵢ₋₁ⁿΣⱼ₌₁ⁿNeedᵢNeedⱼ Equation 21

The Need Portion for WBS element k, which is an analogue of the portion of the total cost variance (σ² that is associated with element k is

Need Portionₖ=Σᵢ₌₁ⁿNeedᵢNeedⱼ Equation 22

The risk dollars allocated to WBS element k are

$$Need {Portion}_{k} = \frac{{\sum }_{i - 1}^{n} {Need}_{i} {Need}_{j}}{Need Base} * Risk Dollars \qquad Equation 23$$

which result is a percentage of total risk dollars. Now the Need of each WBS element is calculated based on the shape of the individual WBS element distribution.

For the triangular distribution, the dollar value Tp at which cost is less than or equal to the dollar value of that WBS element at the pth percentile is

$$\begin{matrix} {T}_{p} = Low + \sqrt{p ( Most Likely - Low ) ( High - Low )} ; \\ if p \leq \frac{Most Likely - Low}{High - Low} & Equation 24 \\ {T}_{p} = High - \sqrt{( 1 - p ) ( High - Low ) ( High - Most Likely )} ; \\ if p > \frac{Most Likely - Low}{High - Low} & Equation 25\end{matrix}$$

Therefore, the need for a WBS element triangular distribution is Tpk minus the point estimate (PEk). If the need is less than zero, the need base is set to zero.

Need Baseₖ=Tₚₖ−PEₖ; if PEₖ<Tₚₖ Equation 26

Need Baseₖ=0; if PEₖ≧Tₚₖ Equation 27

The need for a WBS element with a lognormal distribution is determined by subtracting the dollar value of the lognormal distribution at percentile p by its PE.

Linked Notebook and LENS

5.1 Linked Notebook

According to one exemplary embodiment, a Linked Notebook application program may include an Excel spreadsheet model developed to be a multistage tool that brings all CREST elements into a single place for the analyst and the program management team. The Linked Notebook™ application receives as input the data collected 102, processes the data as described herein 104, 106, and provides output 108 as also described herein in an exemplary embodiment.

Tab 1 documents the PLCCE and the mapping of the PWBS with the CWBS.

Tab 2 documents the program and/or contract Risk and Opportunity and Issues Assessment Register summarized by WBS element.

Tab 3 documents the observations made on the contract performance data and calculates the initial ETC ranges for each lowest level WBS element.

Tab 4 summarizes the results of the SRA, including the methodology that will be used to adjust the ETC ranges, if applicable.

Tab 5 calculates the risk-adjusted ranges for each lowest level WBS elements and statistically sums the data using the FRISK methodology.

Tab 6 documents the trend analysis and MCR Risk Indices™.

Tab 7 is the Findings Log.

Other tabs can be added to the Linked Notebook as required. For example, if the analyst completes a contract compliance analysis for a contractor data submission (e.g., CPR), then the compliance checklist and results could be included.

5.2 Linked Expanded Notebook System (LENS)

The LENS Requirements Document is another exemplary embodiment which is a database driven system that processes the inputs to provide similar outputs as discussed above with respect to the various example embodiments.

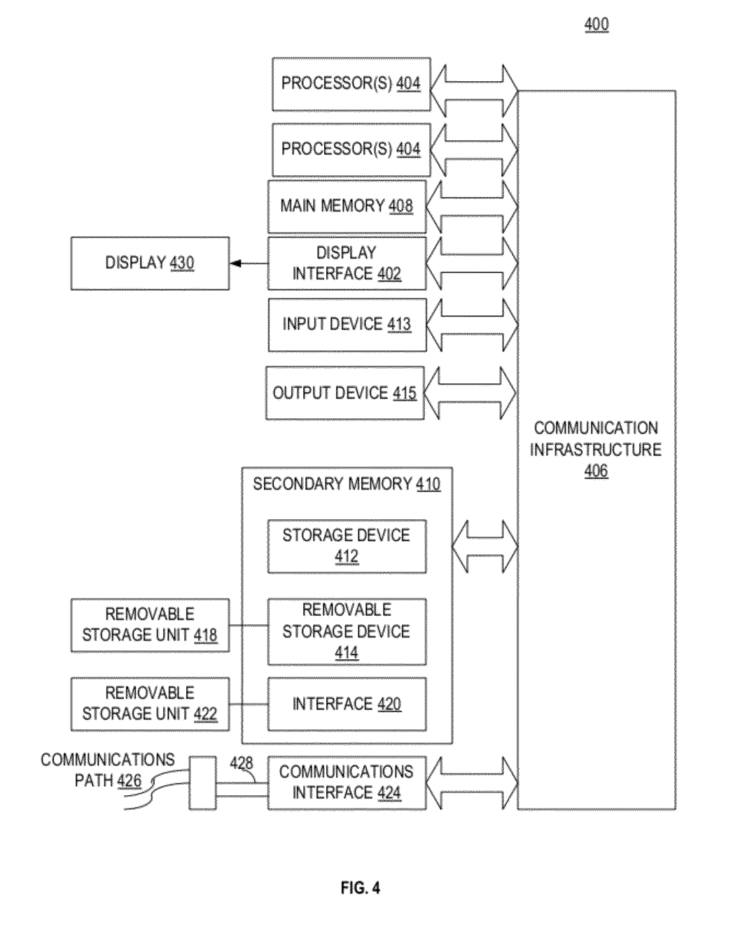

FIG. 4 depicts an exemplary embodiment of an exemplary computer system 400 which may be any combination of, a standalone system, or a component of a larger networked system, a client-server system, a multi-system networked system, a web based system, a database-driven system, an application service provider (ASP) offering, a software as a service (SaaS) based offering, a wired and/or wireless networked system, a mobile and/or fixed system, and/or browser based webserver/application server solution, or an exemplary but non-limiting computing platform 400 for executing a system, method and computer program product for providing enhanced performance management according to the exemplary embodiment of the present invention.

FIG. 4 depicts an illustrative computer system that may be used in implementing an illustrative embodiment of the present invention. In an example embodiment, a spreadsheet application program such as, MICROSOFT® EXCEL may be provided, running on an exemplary personal computer (PC) based system, however the system is not limited to such a system. The computer system may include, e.g., but not limited to, an online application server, a PC, or even an interactive DVD or BlueRay player application which may interactively prompt the user to enter responses to prompts, may analyze responses, and may provide appropriate output and instructions tailored based on the user responses and systems analysis and processing of that input.

Specifically, FIG. 4 depicts an illustrative embodiment of a computer system 400 that may be used in computing devices such as, e.g., but not limited to, client or server devices. FIG. 4 depicts an illustrative embodiment of a computer system that may be used as client device, or a server device, as part of an online multicomputer system, a standalone device or subcomponent, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 400 may be shown in FIG. 4, depicting an illustrative embodiment of a block diagram of an illustrative computer system useful for implementing the present invention. Specifically, FIG. 4 illustrates an example computer 400, which in an illustrative embodiment may be, e.g., (but not limited to) a personal computer (PC) system running an operating system such as, e.g., (but not limited to) MICROSOFT® WINDOWS® 7/NT/98/2000/XPNista/Windows 7/etc. available from MICROSOFT® Corporation of Redmond, Wash., U.S.A. However, the invention may not be limited to these platforms. Instead, the invention may be implemented on any appropriate computer system running any appropriate operating system. In one illustrative embodiment, the present invention may be implemented on a computer system operating as discussed herein. An illustrative computer system, computer 400 may be shown in FIG. 4. Other components of the invention, such as, e.g., (but not limited to) a computing device, a communications device, a telephone, a personal digital assistant (PDA), a personal computer (PC), a handheld PC, a laptop computer, a netbook, a video disk player, client workstations, thin clients, thick clients, a mobile device, a mobile phone, proxy servers, network communication servers, remote access devices, client computers, server computers, routers, web servers, data, media, audio, video, telephony or streaming technology servers, etc., may also be implemented using a computer such as that shown in FIG. 4.

The computer system 400 may include one or more processors, such as, e.g., but not limited to, processor(s) 404. The processor(s) 404 may be connected to a communication infrastructure 406 (e.g., but not limited to, a communications bus, cross-over bar, or network, etc.). Various illustrative software embodiments may be described in terms of this illustrative computer system. After reading this description, it may become apparent to a person skilled in the relevant art(s) how to implement the invention using other computer systems and/or architectures.

Computer system 400 may include a display interface 402 that may forward, e.g., but not limited to, graphics, text, and other data, etc., from the communication infrastructure 406 (or from a frame buffer, etc., not shown) for display on the display unit 430.

The computer system 400 may also include, e.g., but may not be limited to, a main memory 408, random access memory (RAM), and a secondary memory 410, etc. The secondary memory 410 may include, for example, (but not limited to) a hard disk drive 412 and/or a removable storage drive 414, representing a floppy diskette drive, a magnetic tape drive, an optical disk drive, a compact disk drive CD-ROM, DVD, BlueRay, etc. The removable storage drive 414 may, e.g., but not limited to, read from and/or write to a removable storage unit 418 in a well known manner. Removable storage unit 418, also called a program storage device or a computer program product, may represent, e.g., but not limited to, a floppy disk, magnetic tape, optical disk, magneto-optical device, compact disk, a digital versatile disk, a high definition video disk, a BlueRay disk, etc. which may be read from and written to by removable storage drive 414. As may be appreciated, the removable storage unit 418 may include a computer usable storage medium having stored therein computer software and/or data.

In alternative illustrative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, Flash memory device, SDRAM, and other removable storage units 422 and interfaces 420, which may allow software and data to be transferred from the removable storage unit 422 to computer system 400.

Computer 400 may also include an input device such as, e.g., (but not limited to) a mouse or other pointing device such as a digitizer, touchscreen, and a keyboard or other data entry device (none of which are labeled).

Computer 400 may also include output devices, such as, e.g., (but not limited to) display 430, and display interface 402. Computer 400 may include input/output (I/O) devices such as, e.g., (but not limited to) communications interface 424, cable 428 and communications path 426, etc. These devices may include, e.g., but not limited to, a network interface card, and modems (neither are labeled). Communications interface 424 may allow software and data to be transferred between computer system 400 and external devices. Other input devices may include a facial scanning device or a video source, such as, e.g., but not limited to, a web cam, a video camera, or other camera.

In this document, the terms “computer program medium” and “computer readable medium” may be used to generally refer to media such as, e.g., but not limited to removable storage drive 414, and a hard disk installed in hard disk drive 412, etc. These computer program products may provide software to computer system 400. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an illustrative embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to this data as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another illustrative embodiment, the invention may be implemented using a combination of any of, e.g., but not limited to, hardware, firmware and software, etc.

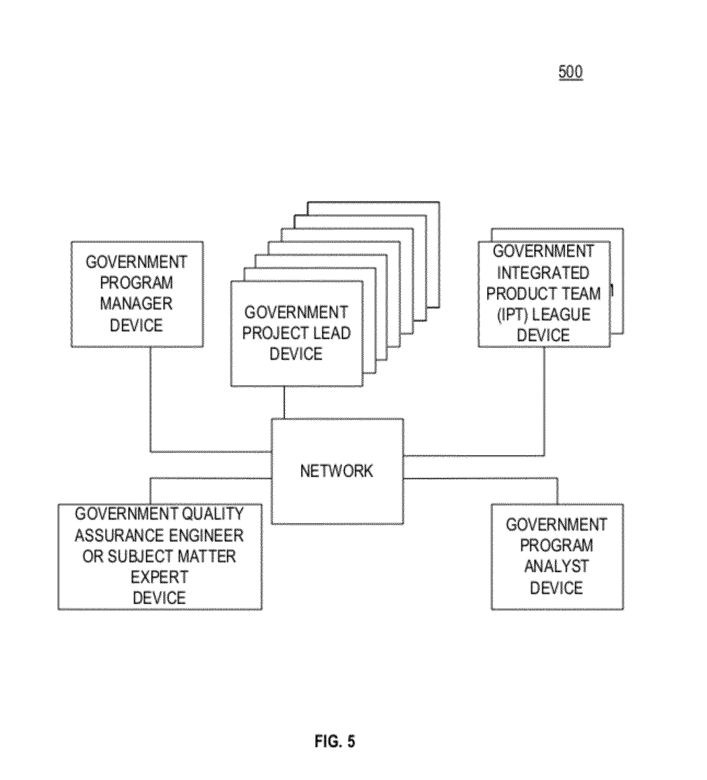

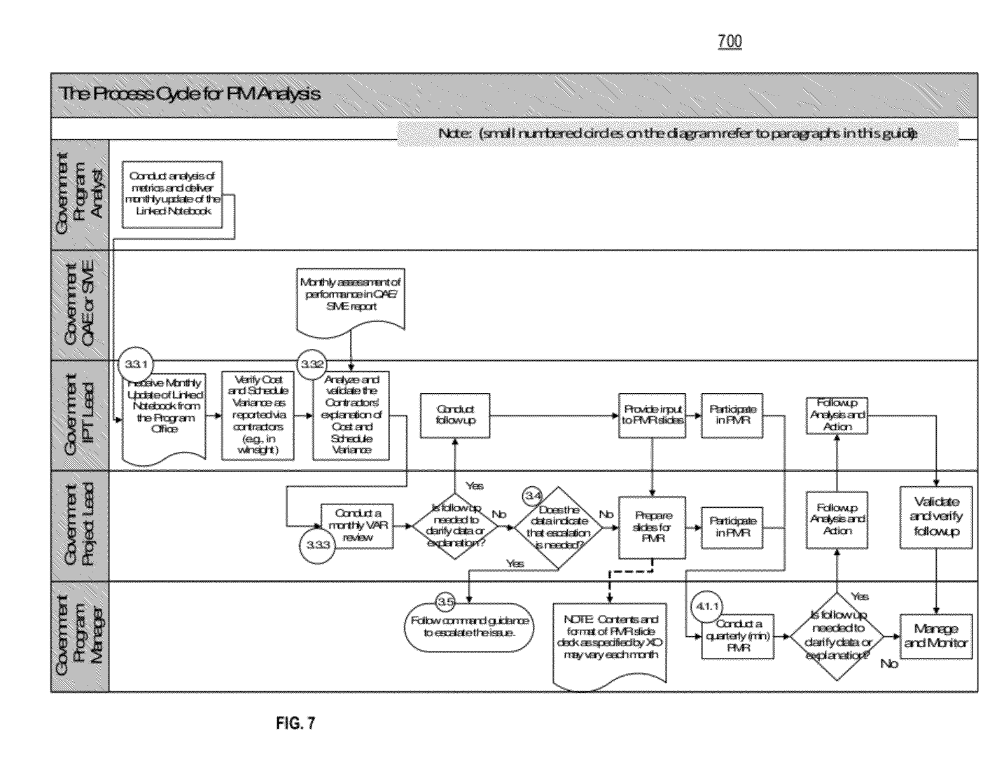

Various illustrative exemplary (i.e., example) embodiments may use any of various system designs such as illustrated in FIG. 5, system 500, which may be used to perform the workflow 700 illustrated in FIG. 7. An example software design architecture could include a hardware layer, an operating system layer above that, and an application layer above the operating system layer for communications, database management, collection and storage of data, processing including assessment and quality assessments and scoring of transparency, and providing output such as indices and the like, which may be used to implement an embodiment of the present invention on an exemplary one or more computer systems 400 as illustrated in FIG. 4. The architecture may provide a standard architecture. The architecture may be implemented, for example, as a web application, a client-server application, a distributed application, a peer-to-peer, a software as a service offering, an applet, a plugin, a widget, a mobile phone application, an interactive TV application, etc. This standard design pattern may isolate the business logic from the presentation and input of data.

FIG. 5 depicts an exemplary but not limiting embodiment of an exemplary system architecture 500 including various user devices including, but not limited to a project manager device 502, program manager device 504, project lead(s) device 506, integrated product team (IPT) lead(s) 508, quality assurance engineer(s) (QAEs) devices 510a, subject matter expert (SMEs) devices 510b, and program analyst devices 512. In an exemplary embodiment, the devices 502-512 may be coupled to one another via one or more networks 514 representing e.g., but not limited to, a wired or wireless, communications network such as, e.g., but not limited to, a local area network or wide area network, peer-to-peer, client server, application service provider (ASP), software as a service (SaaS), standalone, web-based, etc.

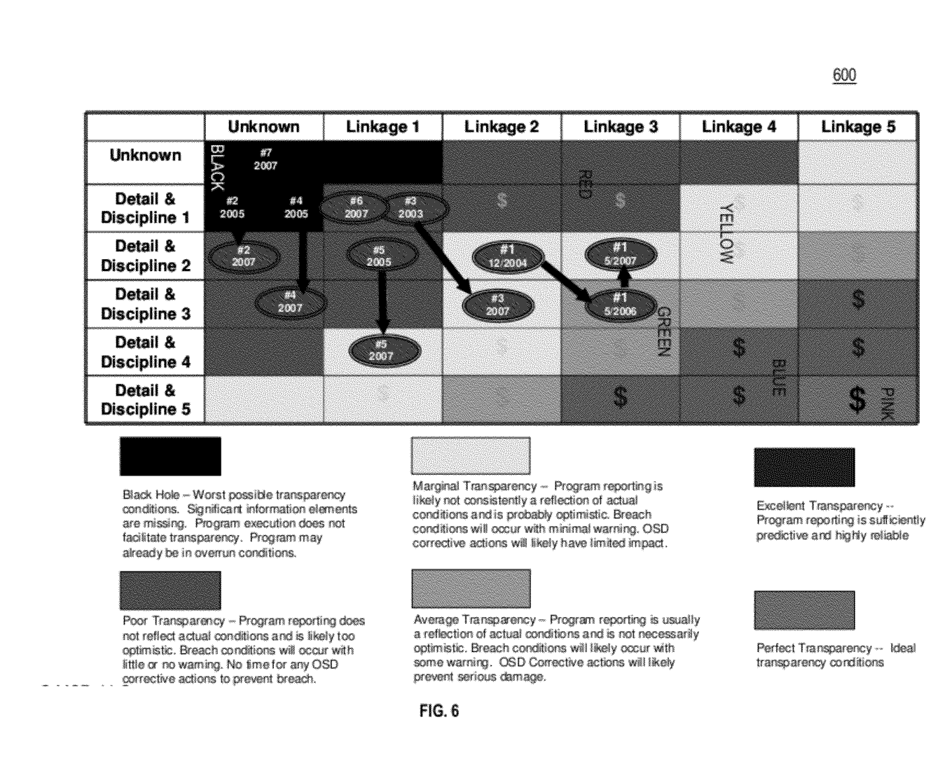

FIG. 6 depicts an exemplary embodiment of an example comparative tool, as may represent an exemplary chart, graphical user interface, computer output image, etc, according one exemplary embodiment.

FIG. 7 depicts an example flow diagram of an example process cycle 700 for Performance Management Analysis 700 according to an exemplary embodiment. The flow diagram illustrates an example interdevice data flow of FIG. 5. The devices upon which the process 700 executes may be illustrated by the system of FIG. 4, in one example embodiment. An illustrative embodiment of a possible online system according to an example embodiment of the present invention may also include a service provider 710 (not shown) which may provide a client-server network system network design like system 500 with back-end services and processing and may include of one or more web servers 712A, 712B, 712C, etc. (collectively 712) (not shown), one or more application servers 714A, 714B, and 714C, etc. (collectively 714) (not shown) and may have a physical or logical storage unit 718 (not shown). A single web server 712 may directly communicate with any of the application servers 714.

A provider 710 may create, store, and compress for electronic transmission or distribution content or data captured and collected as described with reference to FIG. 1. A service provider 710 may receive and decompress electronic transmissions from clients, customers, project managers, program managers, project lead(s), integrated product team (IPT) lead(s), quality assurance engineer(s) (QAEs), subject matter experts (SMEs), program analysts, and other interested individuals. The physical or logical storage unit 718 (not shown) may, for example, store client data. The servers 712 and 714 may be coupled to client devices 780A-780C (such as the devices shown in FIG. 5 having subsystems as shown in FIG. 4) and content creation device 770 (not shown) through a communications path 740 (e.g., but not limited to the internet or network of FIG. 5) via a load balancer 720 (not shown) and a firewall 730 (not shown). According to another embodiment (not shown), the system 700 could be represented by any of a number of well known network architecture designs including, but not limited to, peer-to-peer, client-server, hybrid-client (e.g., thin-client), or standalone. A standalone system (not shown) may exist where information may be distributed via a medium such as, e.g., a computer-readable medium, such as, e.g., but not limited to, a compact disc read only memory (CD-ROM), and/or a digital versatile disk (DVD), BLUERAY®, etc. Any other hardware architecture such as, e.g., but not limited to, a services oriented architecture (SOA) by one skilled in the art could also be used.

According to one embodiment, a content creation device 770 may provide tools for a user (see exemplary user devices in FIG. 5 associated with exemplary users) to process performance management analysis of collected data being processed by the system(s) supporting the workflow 700 which may be stored in a storage unit 718 (not shown). The devices 500 may include a computing device 400 or any other device or machine capable of collecting and processing the data and interacting with other devices as discussed herein via a network such as the communications path 740 (not shown). The application may be built upon an off the shelf (OTS) application, a proprietary, commercial, or open source software application or any combination.

The device 770 (not shown) may also contain a browser 750 (not shown) (e.g., but not limited to, Internet Explorer, Firefox, Opera, etc.), which may, in conjunction with web server 712, allow a user the same functionality as the enhanced performance management application 760. As recognized by one skilled in the art, several devices 770 may exist in a given system 700 (not shown).

The Multiple client devices 780A, 780B, 780C, etc., hereinafter collectively referred to as 780, (not shown) may exist in system 700. Client device 780 may be a computing device 400 or any other device capable of interacting with a network such as the communications path 740. Client device may contain a client application 790. Client application 790, may be proprietary, commercial, or open source software or a combination and may allow a user, client, or customer (not shown) with the ability to create a customized instructional cosmetic procedure. Client device 780 may also contain a browser 750 which may, in conjunction with web server 712, allow a user, client, or customer the same functionality as the client application 790.

System 700 may also contain a communications path 740 (not shown). Communications path 740 may include, e.g., but not limited to, a network, a wireless or wired network, the internet, a wide area network (WAN), or a local area network (LAN). The communications path may provide a communication medium for the content creation device 770, the client devices 780, and one or more servers 712 and 714 through a firewall 730.

In one illustrative embodiment, storage device 718 (not shown) may include a storage cluster, which may include distributed systems technology that may harness the throughput of, e.g., but not limited to, hundreds of CPUs and storage of, e.g., but not limited to, thousands of disk drives. As shown in FIG. 7, cosmetic content file upload and download operations may be provided via one or more load balancing devices 720. In one exemplary embodiment, the load balancer 720 may include a layer four (“L4”) switch. In general, L4 switches are capable of effectively prioritizing TCP and UDP traffic. In addition, L4 switches, which incorporate load balancing capabilities, may distribute requests for HTTP sessions among a number of resources, such as web servers 712. For this exemplary embodiment, the load balancer 720 may distribute upload and download requests to one of a plurality of web servers 712 based on availability. The load balancing capability in an L4 switch may be currently commercially available.

In one embodiment, the storage device 718 may communicate with web servers 714 and browsers 750 on remote devices 780 and 770 via the standard Internet hypertext transfer protocol (“HTTP”) and universal resource locators (“URLs”). Although the use of HTTP may be described herein, any well known transport protocol (e.g., but not limited to, FTP, UDP, SSH, SIP, SOAP, IRC, SMTP, GTP, etc) may be used without deviating from the spirit or scope of the invention. The client devices 780 and content creation device 770, the end-user, may generate hyper text transfer protocol (“HTTP”) requests to the web servers 712 to obtain hyper text mark-up language (“HTML”) files. In addition, to obtain large data objects associated with those text files, the end-user, through end user computer devices 770 and 780, may generate HTTP requests (via browser 750 or applications 760 or 790) to the storage service device 718. For example, the end-user may download from the servers 712 and/or 714 content such as, e.g., but not limited to, customized instructional cosmetic application videos. When the user “clicks” to select a given URL, the content may be downloaded from the storage device 718 to the end-user device 780 or 770, for interactive access via browser 750, and/or application 760 and/or 790, using an HTTP request generated by the browser 750 or applications 760 or 790 to the storage service device 718, and the storage service device 718 may then download the content to the end-user computer device 770 and/or 780.

FIG. 7 illustrates an example embodiment of flow diagram 700 of an example process cycle for performance management (PM) analysis according to one exemplary embodiment.

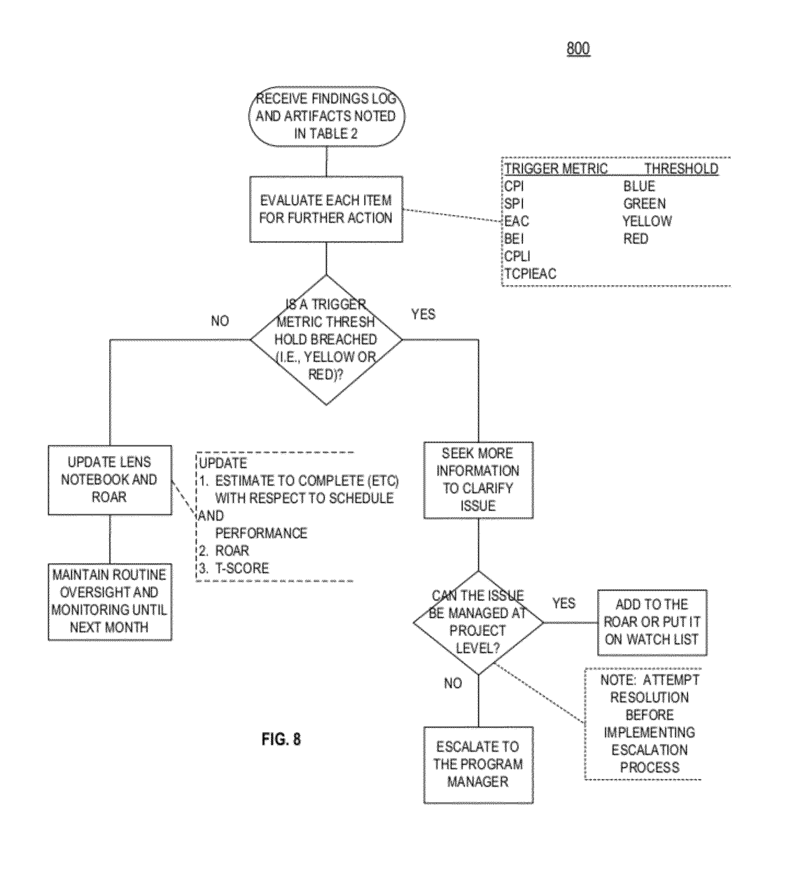

FIG. 8 illustrates an example embodiment of flow diagram 800 of an example trigger threshold flow diagram of an exemplary LENS notebook application according to an exemplary embodiment.

FIG. 9 illustrates an example embodiment of flow diagram 900 of an example issue resolution management and escalation flow diagram of an exemplary application according to an exemplary embodiment.

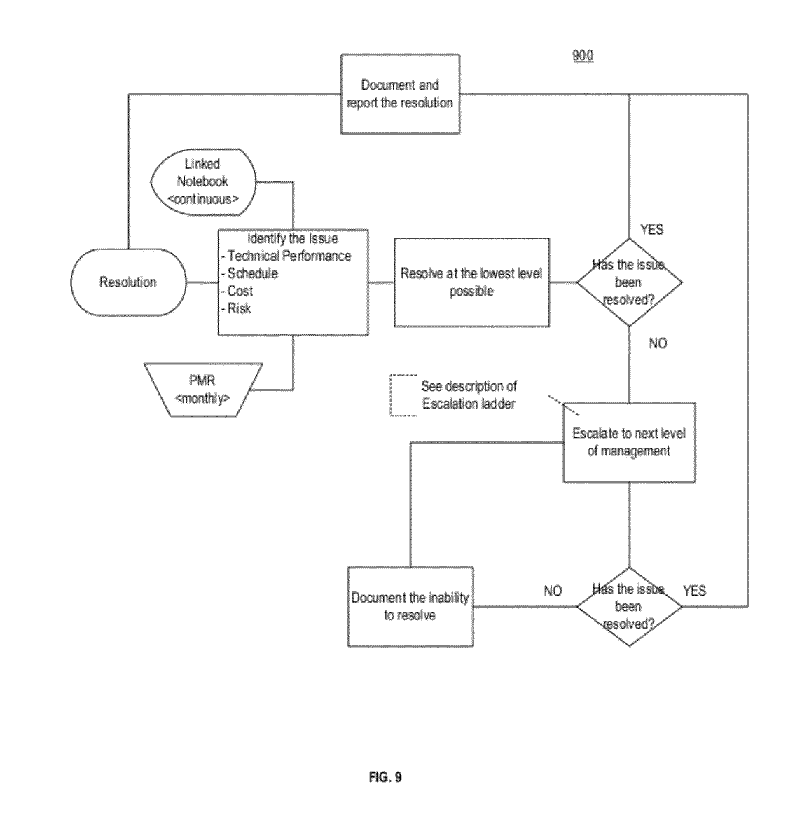

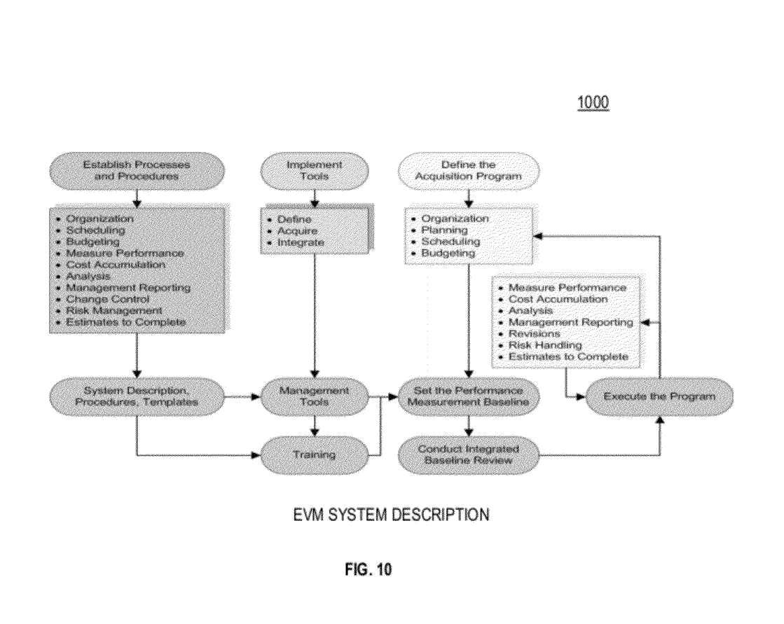

FIG. 10 illustrates an example embodiment of exemplary EVM system 1000 description according to an exemplary embodiment.

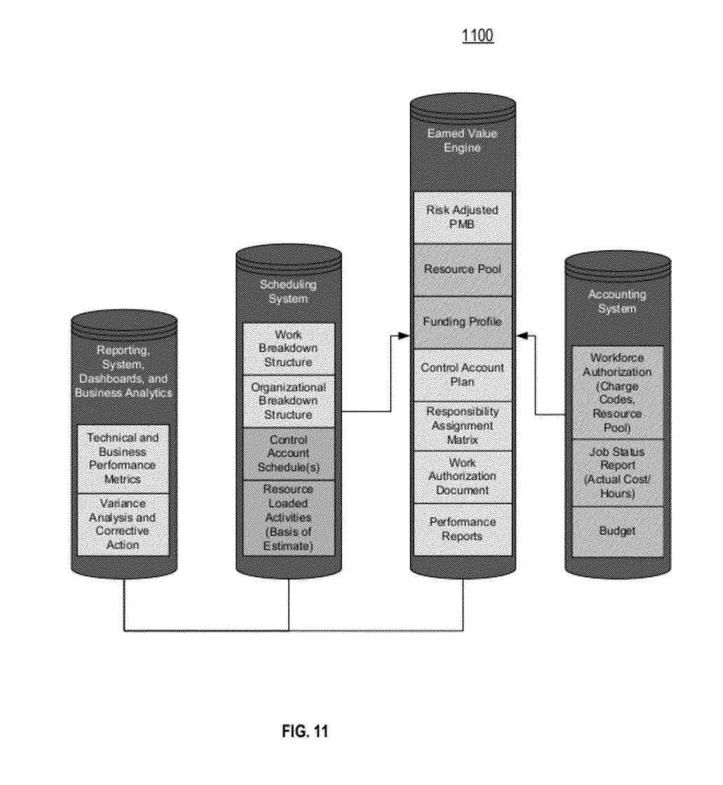

FIG. 11 illustrates an example embodiment of exemplary system 1100 including a reporting system, dashboard, scheduling system, earned value engine, and accounting system and exemplary data flow description according to an exemplary embodiment.

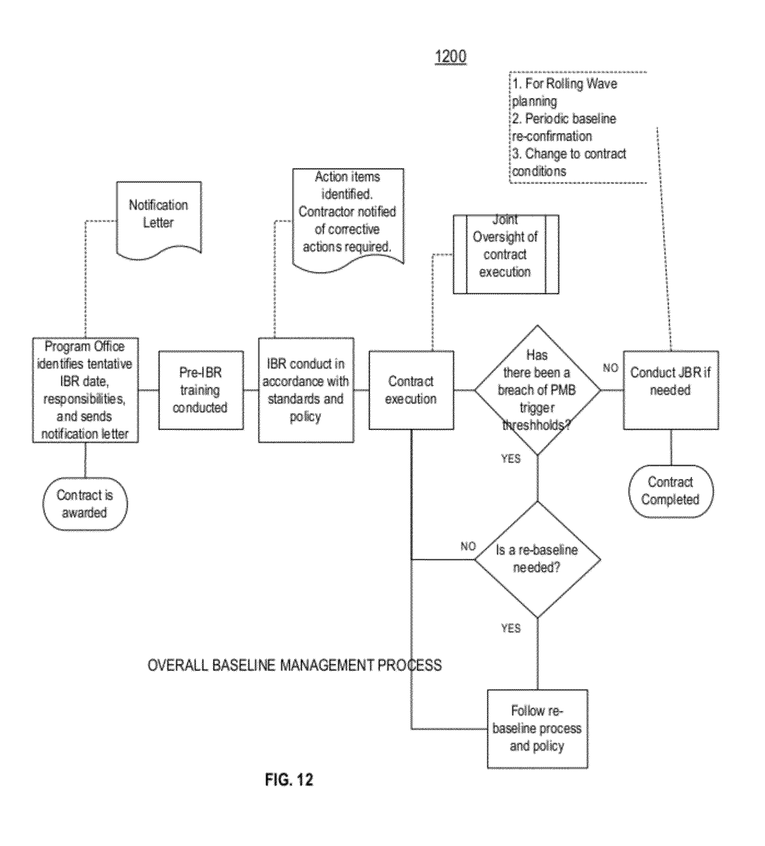

FIG. 12 illustrates an example embodiment of an exemplary overall baseline management process flow diagram 1200 according to an exemplary embodiment.

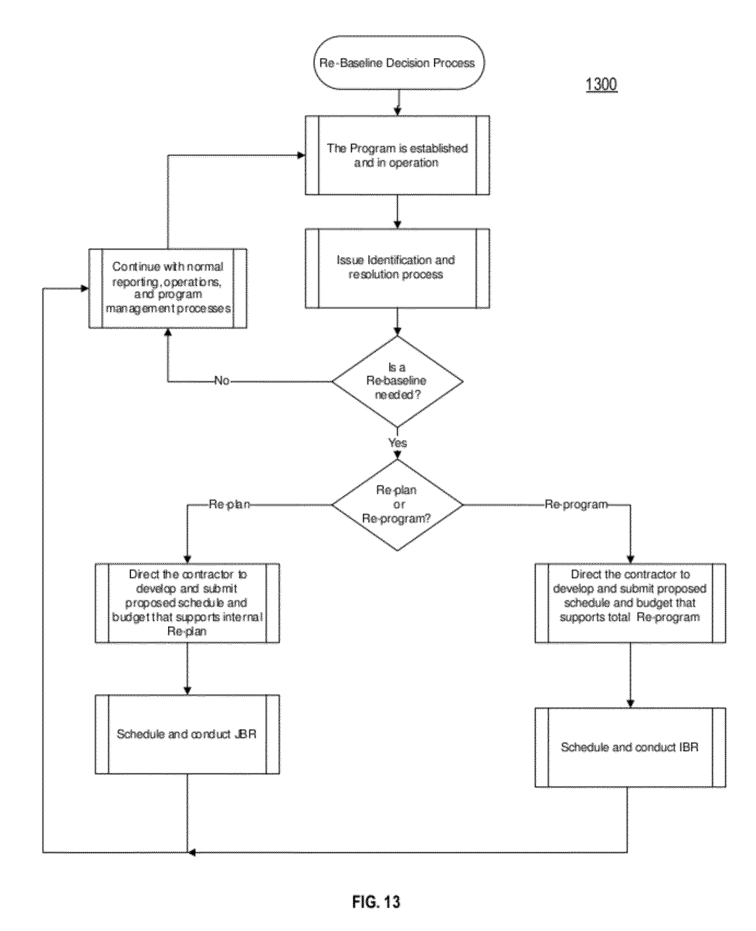

FIG. 13 illustrates an example embodiment of an exemplary re-baseline decision process flow diagram 1300 according to an exemplary embodiment.

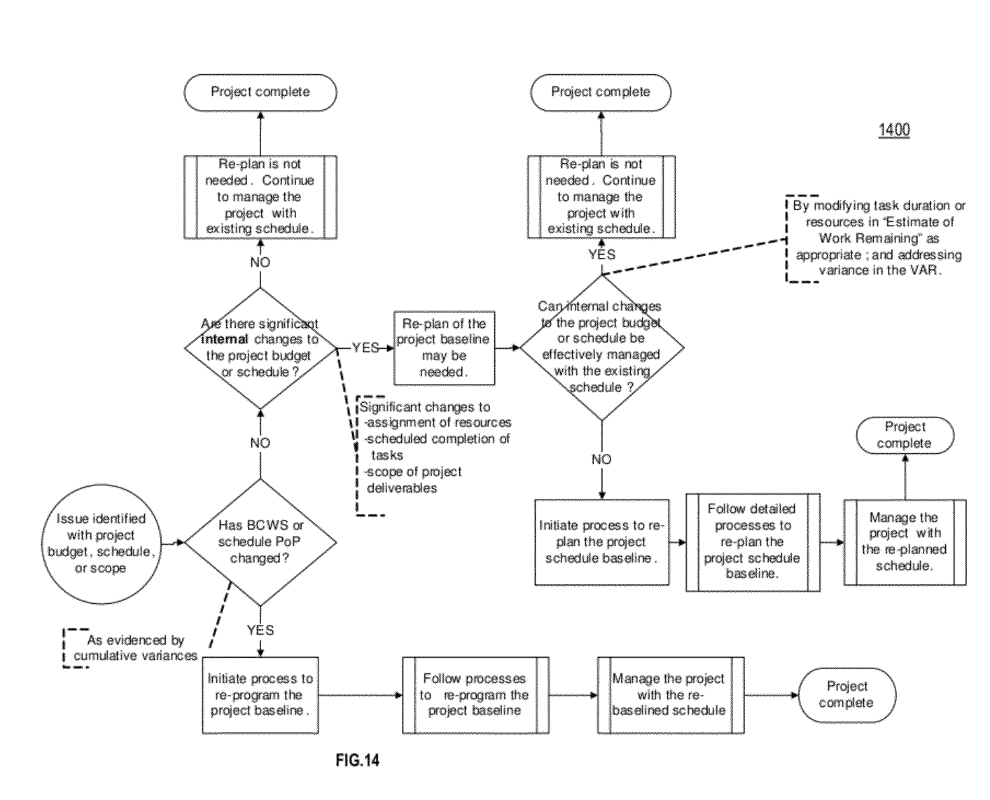

FIG. 14 illustrates an example embodiment of an exemplary baseline project re-program process flow diagram 1400 according to an exemplary embodiment.

FIG. 15 illustrates an example embodiment of an exemplary composite data transparency trend analysis 1500 according to an exemplary embodiment.

FIG. 16 illustrates an example embodiment of an exemplary three dimensional graph of an exemplary joint probability density function 1600 according to an exemplary embodiment.

FIG. 17A illustrates an example embodiment of an exemplary two dimensional graph 1700 of an exemplary system program estimate to complete (ETC) according to an exemplary embodiment.

FIG. 17B illustrates an example embodiment of an exemplary two dimensional graph 1750 of an exemplary system program estimate at complete (EAC) according to an exemplary embodiment.

FIG. 18 illustrates an example embodiment of an exemplary two dimensional graph 1800 of an exemplary LCAA Trend Analysis according to an exemplary embodiment.

FIG. 19 illustrates an example embodiment of an exemplary two dimensional graph 1900 of an exemplary cost exposure index over time according to an exemplary embodiment.

### Transparency Scoring Defined

Transparency scoring occurs in Gate 2 of the LCAA process. It exists to profoundly shape the LCAA final product through direct application of qualitative assessment to a quantitative result. Transparency scoring enables LCAA outputs to be actionable.

### The Problem Statement for Transparency Scoring

Two recurring symptoms of Federal and Defense acquisition program failure are cost and schedule overruns. These typically occur as a result of inattention to linkage among the program management support disciplines as well as insufficient development and sustainment of leadership capacity. Transparency scoring offers insight to these recurring failure conditions by addressing a recurring design problem existent within program management offices: Management system process outputs for use by program leadership consist of information that are neither linked nor responsive to leadership capacity. Consequently, the outputs from these systems provide limited utility to program leadership. Beyond solving technical problems, program managers (PM) must be able to create and sustain cross-functional teams that produce linked, multidisciplinary information capable of supporting proactive decisions. Program managers must interpret information from multiple disciplines in real time and be capable of identifying trends that are likely to affect their organization. A PM must be capable of creating a vision and conducting strategic planning to generate a holistic approach that fits the mission, motivates collaborators (often across multiple organizations) and establishes appropriate processes to achieve that vision in a coordinated fashion. Management system outputs, since they are usually dominated by quantified management support functions, rarely reflect these leadership capacity-centric dynamics.

Two root causes of this recurring management system design problem are inherent within acquisition management, particularly within the program/project management discipline. These root causes are explained below:

Root Cause #1: Program Managers (PM) Often Receive, Sort by Relevance and Interpret Multi-Disciplinary Management Information Generated by Separate Sources, and Often do so Under Time Constraints

Program offices, and the management systems that support them, tend to be “stove-piped” in functionality and discipline due to culture, history and practice. A typical condition is the existence of separate teams, processes and reporting based on discipline and/or function. A cost estimating lead, for example, might not routinely coordinate analysis and reporting with a program risk manager. Monthly reports using earned value management data (a CPR for example) will not necessarily incorporate analysis of the program schedule or status of technical performance measures. The schedule shown to customers and stakeholders does not necessarily reflect what the lead engineer uses to coordinate technical design activities. The five most relevant examples to LCAA are:
Cost—Cost estimating (such as a business case analysis or lifecycle cost estimate) and financial reporting (such as CFSR)
Risk—Risk and opportunity management and reporting as expressed in a monthly “review board” process and storage of risk information in a “register” or equivalent.
Earned Value Management—The implementation of a performance measurement system in a manner assumed to be consistent with ANSI/EIA-748B
Scheduling—The management of time and dependencies, usually depicted in a commercial network scheduling tool
Technical—system engineering, test & evaluation, information technology, logistics and product support in terms of planning, execution and measurement of performance (to include quality)

This “stove-pipe” approach creates separate, often independent streams of inputs, processes and outputs. This often creates multiple, independent and sometimes incompatible views of the same program. For example, program cost estimate results reported to stakeholders might be derived from aggregated elements of expense (labor, material, functions) at the same time estimates at complete (EAC) are generated based on the product work breakdown structure (WBS) in place within the EVM system implementation. If neither the elements of expense nor WBS relate to each other, the PM is often faced with differentiating between two different forecasted outcomes, neither of which are generated using the same frame of reference he might use for day-to-day decisions. This example illustrates that “stove-piping” resulted in two degraded forecasts (each could likely have benefited from the other in terms of frame of reference and inputs) that are not able to be reconciled and will likely be rejected by the PM, perhaps resulting in significant re-work, inefficient use of resources and tools, and limited useful management information.

Root Cause #2: the Program Management Discipline is Characterized by a Self-Sustaining Culture that Emphasizes the Primacy of Technical Capacity Over Leadership Capacity, Because the Former is Readily Associated with Quantitative Measurement of Status and Well-Known Processes for Certification.

Since program success is typically defined in terms of comparison to quantified cost, schedule and performance objectives, current or potential failure conditions are likewise defined in a similar fashion. Root causes for failure are traced only as far as convenient quantification might allow, such as, non-compliant processes, inaccurate performance measurement, unrealistic forecasting, inappropriate contract type and/or gaps in training. This dynamic places excessive focus on the symptoms of failure and limits program leadership to assess the critical root causes. This situation is sustained across industry and the Federal government by the use of similarly-constructed certification mechanisms for program managers and the management systems over which they preside. Federal Acquisition Certification as a Senior Level Program/Project Manager (FAC P/PM) is anchored in imprecisely defined “competencies” with heavy emphasis on requirements management and technical disciplines. Similar requirements are in place for Defense Acquisition Workforce Improvement Act (DAWIA) Level 3 Program Managers and industry's Project Management Professional (PMP). At the organizational level SEI-CMMI Level 2, 3, 4 and 5 “certification” or EVM system “validation” is based on a process of discrete steps designed explicitly to assess artifacts and quantified evidence. In addition, Federal and industry organizations tend to promote their most proficient technicians into leadership positions, increasing the likelihood that PM challenges will be tackled as if they were technical challenges. Thus, Federal and industry corrective actions (more training, process refinement, contract type change, et al) in response to program failures invariably yield marginal improvements because such actions are based on misidentification of the root causes

### The Best Mode (Conditions) for Transparency Scoring

The best mode for Transparency scoring is where a novel, linked metaphorical construct creates unique actionable information for a program manager that would not otherwise be available through normal management system process outputs. Previously, the recurring design problem in management systems and the resultant self-limiting information outputs is discussed. In the next section, the application of Transparency scoring is addressed. This section will clarify the best mode for Transparency scoring in terms of linked metaphorical constructs and actionable information:

### Linked Metaphorical Constructs:

The following models are not considered germane to either the discipline of program management or any of the CREST elements previously noted. Transparency links these models together and applies them metaphorically to performance measurement, creating unique frameworks for analysis and synthesis of program management artifacts and associated management system information. In other words, linking metaphors allows revisions to typical views of management systems and thus allows for the generation of different questions. Changed questions produce different answers. The four models used to explain the underlying critical Transparency metaphors are Air Defense Radar Operations, the Clausewitzian “Remarkable Trinity,” Boyd's Observe, Orient, Decide, Act (OODA) loop and Klein's Recognition Primed Decision Model.

### Air Defense Radar Operations

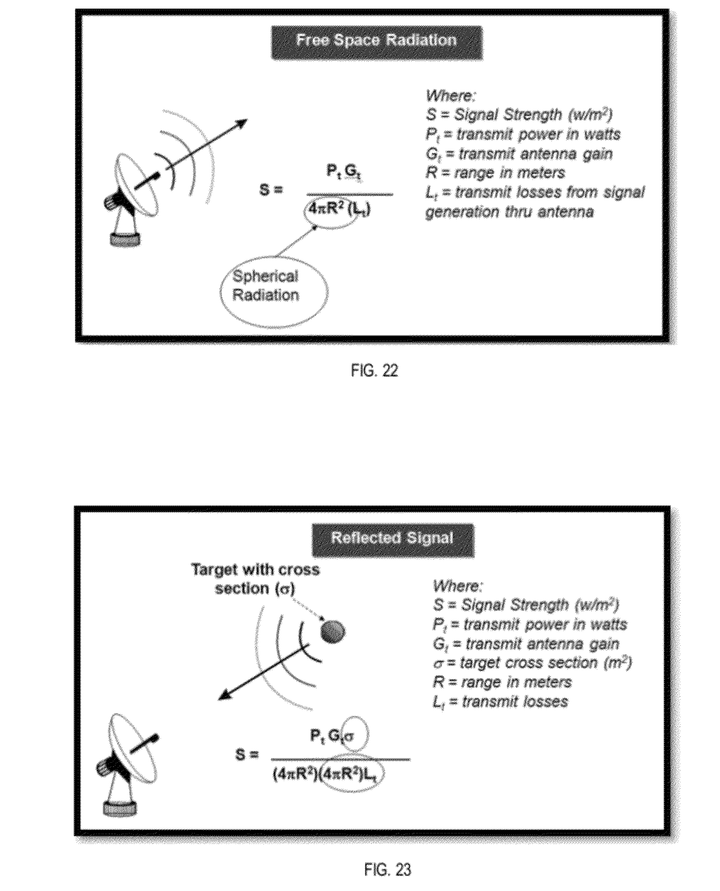

Description of model: The operation of air defense radars, described in terms of the “radar-range equation” commonly appears in textbooks covering radar design and application. The radar range equation governs key aspects of pulsed radar design and can be expressed in the following fashion, as depicted in the FIGS. 22-24.

FIG. 22 depicts free space radiation, a signal generated within the radar, focused and directed by the antenna, and emitted into the atmosphere in order to detect potential airborne threats.

FIG. 23 shows at a specific elapsed time, the emitted signal, traveling at the speed of light, impacts a hostile airborne target (shown in FIG. 22). This signal is reflected, or bounces back away from the target (at the speed of light) in a way uniquely determined by the material, size, shape and orientation of the target.

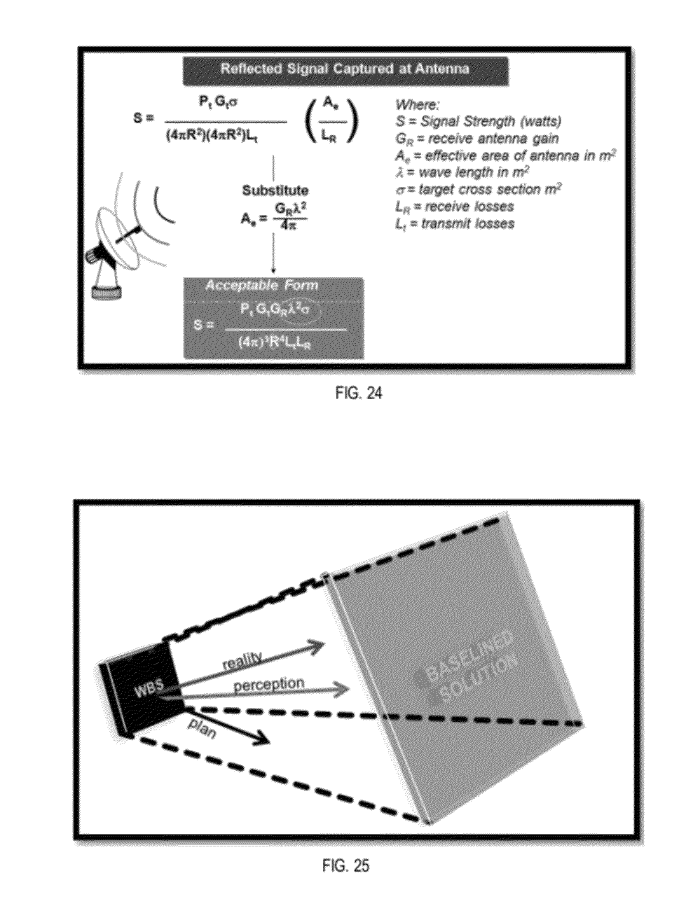

FIG. 24 shows a minute portion of the reflected signal actually makes it back to the radar. FIG. 24 indicates that unique characteristics of the reflected signal, radar sensitivity and processing capability of the radar, among other factors, when combined together, allow extraction of information (speed, range, type, et al) unique to the target. As a general rule, the greater the intensity or amount of “signal” reaching the antenna as compared to the electronic “noise” and other interference internal and external to the radar, the greater the probability of timely and accurate detection, subsequent tracking, and precision direction of defense weapons to the target

Applicability to program management disciplines: All other things being equal, two key target characteristics that determine whether or not the target is detected are the target's radar cross-section and distance from the radar. Within a program management environment, indicators of potential long-term risk impact tend to be subtle, less noticeable and often considered a low priority and of undetermined while the risk remains unidentified or its impact vague and not quantified.

A far-term risk is not unlike a long-range hostile target from the perspective of the radar. Early detection is prudent in order to facilitate appropriate action. The same is true in terms of risk management.
Outgoing radar signal strength attenuates at an exponential rate as the distance to target increases. Similarly, program office staff typically focuses on near-term issues using crisis management; long-term planning and analysis routinely receives low priority.
Maximizing signal-to-noise ratio is critical for detection, tracking and target engagement, thus placing premium importance on transmitted power (volume of energy) and antenna gain (intensity, focus). A PM who explicitly makes risk management a priority within a program office provides the requisite power. Risk management process discipline and inherent robustness of risk analysis serve a similar role as antenna gain.
Undesired performance in radar electronic components generates electronic noise, or interference, which degrade radar operation. Large volumes of management system information exchanged in verbal, written and electronic form, on a recurring basis, tend to create “noise” that contributes greatly to uncertainty because, for a given potential risk identification situation, relatively unimportant or less-relevant information will tend to obscure or drown information that would otherwise enable early and prudent identification of risk.

LCAA transparency scoring characterizes, among other things, the relative capabilities of management systems to proactively identify risk and minimize the probability of a “surprise” catastrophic cost, schedule and/or performance impact. The two main mechanisms of transparency scoring, summarized as discipline and linkage, correspond to radar antenna gain and transmitted power, respectively. Both are significant drivers to the management system “signal strength” thus enabling a mechanism for sustained, long-term awareness. This in turn, enables greater inherent capability for early risk and opportunity identification. The table below characterizes the direct relationship discipline and linkage have to management system “signal strength” since Transparency is measured in two primary dimensions.

| | COST | RISK | EVM | SCHED | TECH | WBS | TOTAL |
|---|---|---|---|---|---|---|---|
| ORGANI- | 2 | 1 | 1 | 0 | 2 | | 6 |
| ZATION | | | | | | | |
| COMPLI- | 2 | 0 | 0 | 2 | 2 | | |
| ANCE | | | | | | | |
| SURVEIL- | 1 | 0 | 0 | 0 | 2 | | |
| LANCE | | | | | | | |
| ANALYSIS | 0 | 1 | 1 | 1 | 2 | | 5 |
| FORE- | 1 | 0 | 1 | 0 | 1 | | |
| CASTING | | | | | | | |
| TOTAL | 6 | | | | | | 21 |
| DIS- | | | | | | | |
| CIPLINE | | | | | | | |
| LINKAGE | 2 | 4 | 4 | 4 | 9 | 7 | 30 |
| PLANNING | | | | | | | |
| LINKAGE | 2 | 7 | 3 | 3 | 5 | 7 | |
| EXE- | | | | | | | |
| CUTION | | | | | | | |
| TOTAL | | 11 | | | 13 | 14 | 56 |
| LINKAGE | | | | | | | |

| | |
|---|---|
| NORMALIZED TOTAL | NORMALIZED TOTAL LINKAGE SCORE |
| DISCIPLINE SCORE | 56/24 = 2.3 |
| 21/10 = 2.1 | |

### Remarkable Trinity

Description of model: Writing almost 200 years ago, Prussian military theorist Carl von Clausewitz grappled with the nature of war and postulated that it was “a conflict of great interests,” and was different from other pursuits only because of the obvious association with violence and bloodshed. He recognized that in war one side did not act upon an inanimate object; he pointed out to the reader that “war is an act of will aimed at a living entity that reacts.” (Clausewitz, On War (translated by Paret and Howard)). Historian Alan Beyerschen adeptly characterized Clausewitz's inherently non-linear framework, particularly with respect to Clausewitz's use of metaphor (motion of a metal pendulum across three evenly spaced magnets) to describe his “remarkable trinity” of primordial violence, chance and passion.

Applicability to program management disciplines: The theory and discipline of program management traces its heritage in the recent past to the rise of complex system developments (space programs for example), but in the distant past to a distinctly mechanistic, linear frame of reference tracing back to the 16^{th} century (Descartes: All science is certain, evident knowledge. We reject all knowledge which is merely probable and judge that only those things be believed which are perfectly known and about which there can be no doubts). However, the reality of the program management environment is decidedly non-linear. One outcome of this mismatch in framework versus environment was described earlier in terms of linkage and leadership capacity, both of which are more closely associated with non-linear frames of reference.

Clausewitz's “remarkable trinity” directly shapes our three-dimensional characterization of the zone of uncertainty which gets to the heart of the inherent leadership challenge that PM's will often face when LCAA Gate 4 results in identification of significant risks relative to discipline and linkage within his or her management system. This is further explained using FIG. 25.

The program architecture, constrained by the acquisition program baseline and defined by the integrated master plan (IMP), can be viewed as a three-dimensional space. The starting point for the program is always clearly defined (zero cost, zero energy at the instant of a clearly-defined calendar start date) but from that point forward, the program is defined at any discrete time in dimensions of cost, time and energy (scope), with a vector (velocity) unique to conditions internal and external to the program at that instant. However, there are three unique positions, and correspondingly different vectors, that would potentially characterize the program depending on the frame of reference:
The position based on exact interpretation of the baselined program plan (e.g. “what the plan says”)
The position based on the program manager's interpretation of the management system's reported position relative to the baselined program plan (e.g. “what the PM thinks”)
The position based on program reality and conditions present at that instant in time, which is rarely exactly the same as either what the management system reports or what the PM perceives.
The Transparency results from Gate 2 directly shape the final quantified product (risk-adjusted estimate to complete) delivered in Gate 4. Upon receipt of the LCAA forecast, risk identifications, root cause analyses and recommended corrective actions (all of which will clearly articulate the degree of uncertainty associated with each vector, the PM is faced with one of three fundamental questions:
Am I willing to struggle to challenge myself and those I lead to gather the actual data and filter the noise (i.e. drive significant changes to the management system design and implementation).
Am I willing to challenge my assumptions that led to the creation of the original plan? (i.e. change or significantly modify the program baseline).
And even if I challenge my assumptions and create a new understanding, am I willing and able to adapt to changed circumstances and manage uncertainty?

### OODA Loop

Description of model: The Observe, Orient, Decide, Act (OODA) loop originally developed by the late John Boyd (Colonel, USAF Retired, for theoretical studies of air combat and energy-based maneuvering) and anchored in studies of human behavior, mathematics, physics and thermodynamics. The fundamental assumption underlying the OODA loop is humans develop mental patterns or concepts of meaning in order to understand and adapt to the surrounding environment, as laid out in Boyd's original unpublished 1975 paper “Destruction and Creation.” We endeavor to achieve survival on our own terms, argued Boyd, through unique means, specifically by continually destroying and creating these mental patterns a way that enables us to both shape and be shaped by a changing environment: “The activity is dialectic in nature generating both disorder and order that emerges as a changing and expanding universe of mental concepts matched to a changing and expanding universe of observed reality.” Successful individual loops are characterized by a distinctive, outward-focused orientation which may quickly adapt to mismatches between concept and reality. By contrast, inward-oriented loops bring the unhappy result that continued effort to improve the match-up of concept with observed reality will only increase the degree of mismatch. Left uncorrected, uncertainty and disorder (entropy) will increase; unexplained and disturbing ambiguities, uncertainties, anomalies, or apparent inconsistencies to emerge more and more often until disorder approaches chaos, or in other words, death. The loop of an individual PM is characterized in the FIG. 3B.

Applicability to program management disciplines: The PM's direct interface with the external environment occurs in Observation when information is “pushed” to or “pulled” by the PM. Management system design and the quality and relevance of information it produces drives the push of information, whereas the PM's own behavior and responses dictates what is pulled. The Orientation step is shaped by numerous factors, including the program manager's personal, professional and cultural background, past experiences and the existence of new information. It is this step where the PM, through analysis and synthesis, breaks down and recombines patterns to comprehend changes since the completion of the previous loop. Said another way and in light of the previous section, this is where the PM establishes the starting point of his own vector in terms of time, cost and energy. Transparency scoring examines the Observation step of the OODA loop by assessing the quality of artifacts collected during Gate 1 in terms of the expectations of the program management support discipline that produced them. It determines whether or not artifacts comply with the guidance governing their construction and includes an assessment of the relevant discipline(s) charged with producing the artifact. Transparency also examines the Orientation step by assessing the program performance planning and execution functions in terms of linkage among the key PM support disciplines, CREST in particular.

Another way OODA loops apply to program management emerges in terms of comparing competing loops, a simple example of which involves comparing the loop of a Government program manager heading the PMO with the loop of the prime contractor PM. Transparency helps gauge the relative ability of a management system to influence a program manager's OODA loop openness and speed. As the loop becomes more outwardly focused, or open, the more readily a PM accepts pushed and proactively pulls information from various sources, analyzes the aggregate picture and recombines it via synthesis. Openness, in other words enables the PM to recognize change. By extension, the speed through which a PM progresses through a complete loop reflects, as a minimum, adaptability to change but can also shape relative ability to anticipate change. This dynamic is summarized and explained in the table below.

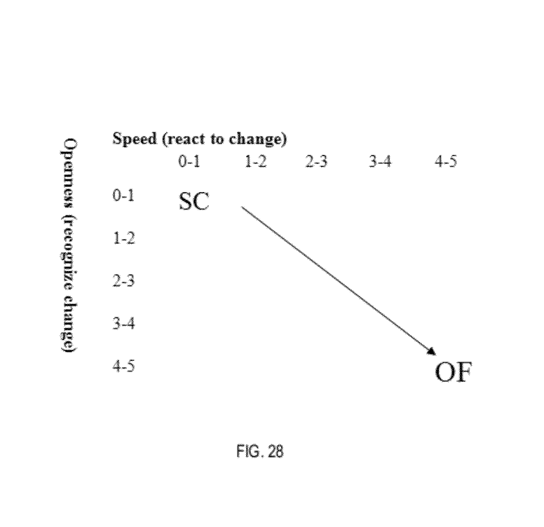

The concept and two-dimensional depiction of Transparency Scores is based on the measurement of relative openness and speed of the PM's decision loop in a way that enables reasonably accurate inferences to be drawn as to the design and implementation of the management system. Discipline and Linkage are scored and then subsequently mapped to a 2-dimensional plane. The vertical axis corresponds to the Discipline (aka OODA Loop Openness) score. This score is a measure of organization, compliance, surveillance, data visibility, analysis and forecasting. Discipline is scored on a scale of 0-5. Scores approximating 0-1 reflect poor (low) discipline and scores of 4-5 reflect superior (high) discipline. The horizontal axis corresponds to the Linkage (aka OODA Loop Speed) score. This is a measure of how program artifacts in one program management area reflect a fusing of relevant data from other program management areas. In a similar fashion to Discipline, Linkage is scored on a scale of 1-5. 1 reflects poor (low) linkage and 5 reflects superior (high) linkage. A program that reflects a closed and slow loop is represented as SC in FIG. 28. A program with an open and fast loop is shown in the lower right corner as OF. A program attempting to move from SC to OF will undergo significant change in process, which implies the need to overcome personal and organizational obstacles to change. Within the context of a program management organization, the PM is the critical enabler of any significant changes required to move in the general direction towards OF.

Recognition-Primed Decision Model (RPDM)

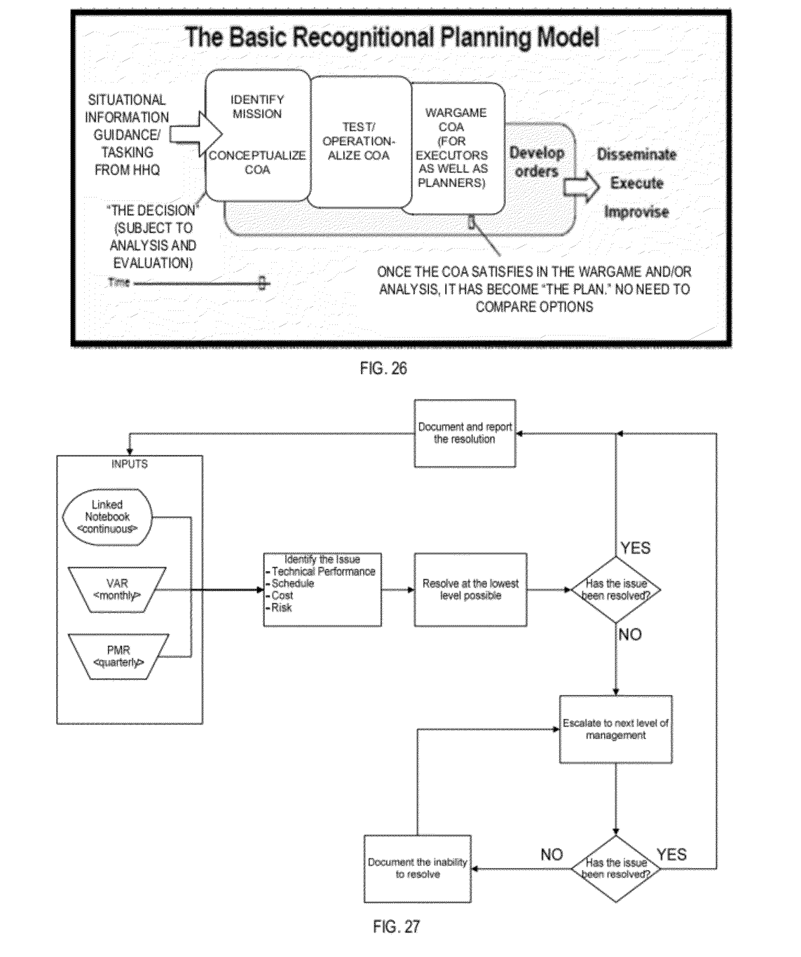

Description of model: This model of intuition-based recognition decision-making (as contrasted to traditional analytical decision-making), was developed in 1989 by Dr. Gary Klein and based on extensive studies of decision-making in senior leaders in various professions ranging from US Marines to firefighters to neo-natal nurses various groups. The RPDM depicts how decision-makers, especially highly experienced ones, make decisions by first choosing and mentally simulating a single, plausible course of action based entirely on knowledge, training, and experience. This stands in stark contrast to traditional analytical decision models, where the decision-maker is assumed to take adequate time to deliberately and methodically contrast several possible decisions with alternatives using a common set of abstract evaluation dimensions. In the RPDM, the first course of action chosen usually suffices. An example of the RPDM adapted for the USMC is shown in FIG. 26.

Applicability to program management disciplines: As relatively senior professionals, program managers can be assumed to have the requisite experience to enable understanding of most acquisition management-related situations in terms of plausible goals, relevant cues, expectations and typical actions. Experienced program managers can therefore use their experience to avoid painstaking deliberations and try to find a satisfactory course of action, rather than the best one. PM's can be assumed to be capable of identifying an acceptable course of action as the first one they consider, rarely having to generate another course of action. Furthermore they can evaluate a single course of action through mental simulation. They don't have to compare several options.

Klein's work enables a realistic appreciation of the uncertainty present in the program management environment. According to Klein there are 5 sources of uncertainty:

Missing Information

Unreliable Information

Conflicting Information

Noisy Information

Confusing Information

Faced with these sources and a given level of uncertainty, PM's can respond in a variety of ways, all of which can be directly anticipated by those performing decision support tasks such as development of white papers, trade studies, program performance analyses and the like. Analysts' results are usually accompanied by recommendations, and Klein's framework offers ways to articulate possible courses of action. These include:

Delaying (Example: Does the email from the acquisition executive really require a response this very second?)

Increasing Attention (Examples: More frequent updates, lower level WBS reporting)

Filling Gaps With Assumptions (Example: The CPR is missing this month but I will assume the same trends are continuing)

Building an Interpretation (Example: Painting a Holistic Picture of a Situation)

Pressing on despite uncertainty (Example: not waiting for the report results coming tomorrow)

Shaking the Tree (Example: Forcing subordinate teams/projects to take on budget “challenges” before they “officially” hit)

Designing Decision Scenarios (Examples: “What if” played out a few different ways)

Simplifying the Plan (Example: Modularizing)

Using Incremental Decisions (Example: Piloting a new process or procedure)

Embracing It (Example: Swim in it like a fish)

Within the context of LCAA Transparency, the RPDM is superimposed onto the OODA loop structure in order to clarify the nature of PM decision-making in the wake of the “Observe” and “Orient” steps. The detailed characterization of uncertainty that forms the context for the RPDM enables greater appreciation for the dynamics in place within the three-dimensional program architecture described in an earlier section. Klein's work also significantly influences the nature of actionable information provided to the PM at the end of LCAA Gate 4 to include, among other things, tailoring the nature of recommended corrective actions to include suggestions for clarification of the leader's intent and the use of a “pre-mortem” exercise.

Actionable Information

Description: Actionable information is information that a leader, such as a PM, can immediately apply in order to achieve a desired outcome. Actionable information promotes independence of the PM's subordinates, enables improvisation, results in positive action and achieves a tangible result.

Actionable information contributes to LCAA via a “pre-mortem” framework and accomplishment of executive intent.

A “pre-mortem” framework is not unlike a firefighter investigating the causes of an accidental fire amid the charred wreckage of a house that just burned to the ground. It differs from the example of the firefighter in that the fire investigation itself does not prevent the house from burning; it only explains why. A pre-mortem is a way of conducting the investigation ahead of time, assuming the fire will suddenly break out. Applied to a house, such an exercise might uncover faulty wiring. Applied to a program, it helps uncover vulnerabilities in plans, flaws in assumptions, and risks in execution. LCAA Gate 4 findings create a framework for one or more post-mortem exercises accompanied with a rich set of inputs based on identified risks and other findings. This enables the PM and team to work together and brainstorm plausible fiascos based on LCAA results. Rather than a “what-if” exercise, the pre-mortem is designed to elicit rigorous analysis of the program plan and corresponding alternatives going forward with the purpose of uncovering reasons for failure and describing not only what failure looks like, but also the likely conditions that precede it. This serves to improve individual and collective pattern-recognition capabilities within the context on the program.

The LCAA Gate 4 output includes executive intent tailored for the unique conditions, risks and forecasts associated with the LCAA completion. Thoughtful construction of executive intent as an accompaniment to LCAA Gate 4 enables a forward-focused, outcome-oriented dialogue with the PM and program team. Unlike a typical “recommendation for corrective action” included almost as an afterthought to results of typical performance analysis or forecasting, executive intent is deliberately constructed to assist the PM in effective delegation of tasks resulting from LCAA Gate 4 outputs. When combined with a robust pre-mortem framework, executive intent reduces uncertainty in communication between superior and one or more subordinates

The Application of Transparency Scoring

Effective Transparency Scoring requires an interdisciplinary mindset. The evaluator should be able to move comfortably across the CREST disciplines. If that is not possible, then multiple personnel should be used to execute a Transparency Score who, across the team, combine to possess the requisite knowledge to recognize patterns and anomalies in each CREST discipline. The most effective approach occurs when the senior PM, assisted by the program management team, uses the scoring as a self assessment.

The wording of specific Transparency Score questions could, if desired, be adjusted based on context and conditions. The 0, 1 or 2 scoring, based on an “all or nothing” approach (if all the conditions are met, the full score is given) can be adjusted so that receiving a 1.5 or a 0.25 is possible based on “degrees” of compliance. Regardless, consistency needs to be maintained across the various assessment of a program or when assessments are being compared across projects. The authors have selected a simple scoring schema, so the focus of the process is not the scoring itself but rather an understanding of the management processes.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for performance management comprising:
receiving performance data for a project;
receiving risk data for the project;
developing an estimate to complete (ETC) based on the performance data;
adjusting the ETC based on the risk data; and
developing an estimate at completion (EAC) based on the adjusted ETC.

2. The method for performance management of claim 1, wherein at least one of:
the ETC comprises an ETC probability distribution; or
the EAC comprises an EAC probability distribution.

3. The method for performance management of claim 1, wherein the project comprises at least two work breakdown structures (WBS), developing an ETC comprises developing an ETC for each WBS, adjusting the ETC comprises adjusting each ETC, and developing an EAC comprises summing the adjusted ETCs together.

4. The method for performance management of claim 1, wherein developing the EAC comprises:
calculating the EAC based on a Actual Cost of Work Performed (ACWP) and the ETC.

5. The method for performance management of claim 1, wherein adjusting the ETC based on the risk data comprises:
expanding ranges based on the received risk data

6. The method for performance manage of claim 5, wherein expanding ranges comprises:
mapping the received risk data to corresponding work breakdown structures (WBS);
calculating probabilities of a plurality of risk states for the WBS based on the mapped risk data;
determining a mean of a distribution of the probabilities of the plurality of risk states; and
determining a standard deviation of the distribution of the probabilities of the plurality of risk states.

7. A computer program product embodied on a computer accessible storage medium, which when executed on a computer processor performs a method for enhanced performance management comprising:
receiving performance data for a project;
receiving risk data for the project;
developing an estimate to complete (ETC) based on the performance data;
adjusting the ETC based on the risk data; and
developing an estimate at completion (EAC) based on the adjusted ETC.

8. A system for performance management comprising:
at least one device comprising at least one computer processor adapted to receive performance data and risk data for a project; and
said processor adapted to:
develop an estimate to complete (ETC) based on the performance data;
adjust the ETC based on the risk data; and
develop an estimate at completion (EAC) based on the adjusted ETC.
